(19) United States
(12) Patent Application Publication
(10) Pub. No.: US 2024/0131789 A1
(43) Pub. Date: Apr. 25, 2024

(54) THREE-DIMENSIONAL PRINTING

(71) Applicant: Velo3D, Inc., Campbell, CA (US)

(72) Inventors: Benyamin Buller, Cupertino, CA (US); Kimon Symeonidis, Easton, PA (US); Erel Milshtein, Cupertino, CA (US); Thai Cheng Chua, Cupertino, CA (US)

(21) Appl. No.: 18/197,158

(22) Filed: May 15, 2023

Related U.S. Application Data
(63) Continuation of application No. 18/094,432, filed on Jan. 9, 2023, now abandoned.
Application No. 18/094,432 is a continuation of application No. 17/952,502, filed on Sep. 26, 2022, now abandoned.
Application No. 17/952,502 is a continuation of application No. 17/836,057, filed on Jun. 9, 2022, now abandoned.
Application No. 17/836,057 is a continuation of application No. 17/685,805, filed on Mar. 3, 2022, now abandoned.
Application No. 17/685,805 is a continuation of application No. 17/530,665, filed on Nov. 19, 2021, now abandoned.
Application No. 17/530,665 is a continuation of application No. 17/394,496, filed on Aug. 5, 2021, now abandoned.
Application No. 17/394,496 is a continuation of application No. 17/241,595, filed on Apr. 27, 2021, now abandoned.
Application No. 17/241,595 is a continuation of application No. 17/124,057, filed on Dec. 16, 2020, now abandoned.
Application No. 17/124,057 is a continuation of application No. 17/009,608, filed on Sep. 1, 2020, now abandoned.
Application No. 17/009,608 is a continuation of application No. 16/876,608, filed on May 18, 2020, now abandoned.
Application No. 16/876,608 is a continuation of application No. 15/808,434, filed on Nov. 9, 2017, now abandoned.
Application No. 15/808,434 is a continuation-in-part of application No. 15/490,219, filed on Apr. 18, 2017, now Pat. No. 10,357,957.
Application No. 15/490,219 is a continuation of application No. 15/339,759, filed on Oct. 31, 2016, now Pat. No. 9,662,840.
Application No. 15/808,434 is a continuation-in-part of application No. PCT/US16/34454, filed on May 26, 2016.
(60) Provisional application No. 62/252,330, filed on Nov. 6, 2015.
(60) Provisional application No. 62/396,584, filed on Sep. 19, 2016.
(60) Provisional application No. 62/168,689, filed on May 29, 2015.
(60) Provisional application No. 62/307,254, filed on Mar. 11, 2016.

(51) Int. Cl. B29C 64/282; B22F 10/28; B22F 10/32; B22F 10/36; B28B 1/00; B28B 17/00; B29C 64/153; B29C 64/159; B29C 64/20; B29C 64/264; B29C 64/371; B29C 64/386; B29C 64/40; B33Y 50/02

(52) U.S. Cl. CPC B29C 64/282; B22F 10/28; B22F 10/32; B22F 10/36; B28B 1/001; B28B 17/0081; B29C 64/153; B29C 64/159; B29C 64/20; B29C 64/264; B29C 64/371; B29C 64/386; B29C 64/40; B33Y 50/02; B33Y 10/00

(57) ABSTRACT

The present disclosure provides various three-dimensional (3D) objects, some of which comprise a wire or 3D plane. Disclosed herein are methods, apparatus, software, and systems for their generation that may reduce or eliminate the need for auxiliary support during the formation of the 3D objects. The methods, apparatuses, software, and systems of the present disclosure may allow the formation of objects with short, diminished number, and/or spaced apart auxiliary support structures. These 3D objects may be objects with adjacent surfaces such as hanging structures and planar hollow 3D objects.

### CROSS-REFERENCE

This application is a continuation of U.S. patent application Ser. No. 18/094,432 filed Jan. 9, 2023, which is a continuation of U.S. patent application Ser. No. 17/952,502 filed Sep. 26, 2022, which is a continuation of U.S. patent application Ser. No. 17/836,057 filed Jun. 9, 2022, which is a continuation of U.S. patent application Ser. No. 17/685,805 filed Mar. 3, 2022, which is a continuation of U.S. patent application Ser. No. 17/530,665 filed Nov. 19, 2021, which is a continuation of U.S. patent application Ser. No. 17/394,496 filed Aug. 5, 2021, which is a continuation of U.S. patent application Ser. No. 17/241,595 filed Apr. 27, 2021, which is a continuation of U.S. patent application Ser. No. 17/124,057 filed Dec. 16, 2020, which is a continuation of U.S. patent application Ser. No. 17/009,605 filed Sep. 1, 2020, which is a continuation of U.S. patent application Ser. No. 16/876,608 filed May 18, 2020, which is a continuation of U.S. patent application Ser. No. 15/808,434 filed Nov. 9, 2017, which is a continuation-in-part of U.S. patent application Ser. No. 15/490,219, filed Apr. 18, 2017, now U.S. Pat. No. 10,357,957 issued on Jul. 23, 2019, which is a continuation of U.S. patent application Ser. No. 15/339,759 filed Oct. 31, 2016 and issued as U.S. Pat. No. 9,662,840 on May 30, 2017, which claims priority to U.S. Provisional Application Ser. No. 62/252,330 filed Nov. 6, 2015, and U.S. Provisional Application Ser. No. 62/396,584 filed Sep. 19, 2016; U.S. patent application Ser. No. 15/808,434 filed Nov. 9, 2017 is also a continuation-in-part of national stage of PCT Patent Application Serial No. PCT/US16/34454, filed May 26, 2016 which claims priority to U.S. Provisional Application Ser. No. 62/168,689 filed May 29, 2015, and to U.S. Provisional Application Ser. No. 62/307,254 filed Mar. 11, 2016, each of which is entirely incorporated herein by reference.

### BACKGROUND

Three-dimensional (3D) printing (or additive manufacturing) is a process for making a three-dimensional object of any shape from a design. The design may be in the form of a data source such as an electronic data source, or may be in the form of a hard copy. The hard copy may be a two dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

Some 3D printing methods require the use of auxiliary supports to maintain the desired shape of the 3D printed 3D object during and/or subsequent to the printing process. The auxiliary support structures (herein auxiliary supports) are prevalent, for example, in non-polymeric 3D printing (e.g., using metal and/or metal alloy). The auxiliary support structure(s) are typically removed subsequent to the 3D printing process. The presence of auxiliary supports may hinder the generation of hanging structures and/or various types of adjacent surfaces when they are difficult or impossible to remove (e.g., in a post processing procedure). The presence of auxiliary supports may hinder design and/or materialization of a desired 3D object.

### SUMMARY

In some embodiments, the present disclosure delineates modeling of 3D objects with reduced design constraints (e.g., no design constraints). The present disclosure delineates methods, systems, apparatuses, and software that allow materialization of these 3D object models having a reduced amount of design constraints. The present invention may allow an extended degree of freedom in designing and materialization of 3D objects. For example, the present invention may allow actual materialization in the real world of (e.g., substantially) freely designed 3D object.

Disclosed herein in some embodiments is the printing of various 3D objects such as comprising a 3D plane (referred to herein also as “3D plane”) or a wire using a 3D printing process, 3D object (or a portion thereof) is devoid of auxiliary supports, incorporates spaced apart auxiliary supports, or has a reduced number of auxiliary supports. The 3D plane or wire may be part of a 3D structure prepared by any of the above-mentioned 3D printing methods (e.g., an additive manufacturing process). Disclosed herein is printing of a bilayer 3D structure comprising two layers of hardened material that constitutes a second transformation operation (e.g., re-melting) of a previously formed layer of hardened material.

At times, it is difficult to form extended planar structures that float anchorlessly in the material bed. At times, it is difficult to form extended planar structures that consist of (e.g., substantially) homogenous material properties and float anchorlessly in the material bed. In some embodiments, present disclosure describes formation of such structures. A desired 3D object may comprise a sacrificial 3D structure that is connected to it. The joint object comprising the desired and sacrificial 3D structures may float anchorlessly in the material bed. The sacrificial 3D structure may be removed in a post processing procedure. The formation of the joint 3D structure may allow fabrication of a closed 3D structure that reside and/or constitute a plane (e.g., a ring). The closed 3D structure may thus have homogenous material properties (e.g., across the plane). The closed 3D structure may have (e.g., substantially) similar porosity, microstructure, strength, strain, stress, and/or other material properties across the closed 3D structure (e.g., across the plane).

In an aspect, a method for forming a three-dimensional (3D) object, comprises: (a) transforming at least a first portion of a powder bed to form a first transformed material that is suspended anchorlessly in the powder bed during its formation, wherein the first transformed material hardens to a first layer of hardened material, wherein the powder bed is formed of a first particulate material selected from the group consisting of elemental metal, metal alloy, ceramic, and an allotrope of elemental carbon; (b) depositing a layer of powder on an exposed surface of the powder bed, wherein the layer of powder comprises a second particulate material selected from the group consisting of elemental metal, metal alloy, ceramic, and an allotrope of elemental carbon; and (c) transforming (i) a portion of the layer of powder to form a second transformed material and (ii) at least a portion of (e.g., entire) first layer of hardened material to form a third transformed material, wherein the second transformed material and the third transformed material form at least a portion of the 3D object, wherein the 3D object is suspended anchorlessly in the powder bed during its formation. The first particulate material may be the same or different from the second particulate material. Transforming the first layer of hardened material to form the third transformed material can include completely transforming the first layer of hardened material to form the third transformed material, Transforming the first layer of hardened material to form the third transformed material can include completely transforming the entire first layer of hardened material to form the third transformed material. Transforming the first layer of hardened material to form the third transformed material can include (e.g., completely) altering the microstructure of the first layer of hardened material at least in part (e.g., entirely) to form the third transformed material. Transforming in operations (a) or (c) can be melting. Melting can be complete melting. The second transformed material and the third transformed material may harden into at least a portion of a hardened 3D object. The powder bed can be disposed on a platform, wherein a surface of the first layer of hardened material that faces the platform has an Ra value (a measure of surface roughness) from about 500 micrometers to about 100 micrometers. The powder bed can be disposed on a platform, wherein a surface of the first layer of hardened material that faces away from the platform has an Ra value from about 100 micrometers to about 1 micrometer. The powder bed can be disposed on a platform, wherein a surface of the hardened 3D object that faces the platform has an Ra value from about 100 micrometers to about 1 micrometer. The powder bed can be disposed on a platform, wherein a surface of the hardened 3D object that faces the platform has an Ra value from about 100 micrometers to about 1 micrometer. During formation, the 3D object may not contact the platform. Upon hardening, a density of the 3D object can be from about 80 percent to a fully dense material. The density of the hardened 3D object can be from about 90 percent to a fully dense material. The density of the hardened 3D object can be from about 95 percent to a fully dense material. The density of the hardened 3D object can be from about 98 percent to a fully dense material. The first particulate material can be (e.g., substantially) the same as the second particulate material. The wherein the first particulate material can be different from the same as the second particulate material. The transforming can comprise using a first energy beam and a second energy beam. The first energy beam can be focused and the second energy beam can be non-focused. The first energy beam can be faster than the second energy beam. The first energy beam may have a greater power per unit area than the second energy beam. Greater can be by at least half an order of magnitude. Greater can be by at least an order of magnitude. Transforming can comprise using a first energy beam having a power per unit area of at least about 100 watts per millimeter square. Transforming can comprise using a second energy beam having a power per unit area from at least about 0.1 watt per millimeter square to about 100 watts per millimeter square. The transforming in operation (a) or (c) may comprise using a second energy beam separate from the first energy beam. The second energy beam may have a power per unit area that is different from the first energy beam. The second energy beam may have a power per unit area from at least about 0.1 watt per millimeter square to about 100 watts per millimeter square. The operation (c) may comprise transforming an entirety of the first layer of hardened material to the third transformed material. The transforming in operation (a) or (b) may be in the absence of sintering.

In another aspect, a system for forming a 3D object comprises: (a) a powder bed formed of a first particulate material selected from the group consisting of elemental metal, metal alloy, ceramic, and an allotrope of elemental carbon; (b) a layer dispensing mechanism that dispenses a layer of powder material on an exposed surface of the powder bed; (c) a first energy source that generates a first energy beam, which first energy beam transforms at least a first portion of the powder bed to form a transformed material as part of the 3D object; and (d) a controller operatively coupled to the powder bed, layer dispensing mechanism, and first energy source and is programmed to: (i) direct the first energy beam to transform a first portion of the powder bed to form a first transformed material that is suspended anchorlessly in the powder bed during its formation, wherein the first transformed material hardens to a first layer of hardened material; (ii) direct the layer dispensing mechanism to dispense the layer of powder material on the exposed surface of the powder bed; (iii) direct the first energy beam to transform (i) a portion of the layer of powder to form a second transformed material and (ii) at least a portion of the (e.g., the entire) first layer of hardened material to form a third transformed material, wherein the second transformed material and the third transformed material form at least a portion of the 3D object, wherein the 3D object is suspended anchorlessly in the powder bed during its formation. The layer dispensing mechanism can comprise a powder dispenser. The layer dispensing mechanism can comprise a recoater. The layer dispensing mechanism can comprise an opening port. The layer dispensing mechanism can comprise an electrical connection. The layer dispensing mechanism can comprise an electrical socket. The layer dispensing mechanism can comprise an exit and/or entry port. The first energy source may further generate a second energy beam, which second energy beam transforms at least a second portion of the powder bed to form a transformed material as part of the 3D object. The system may further comprise a second energy source that generates a second energy beam, which second energy beam transforms at least a second portion of the powder bed to form a transformed material as part of the 3D object. The controller may further operatively couple to the second energy beam. Transforming the first layer of hardened material to form the third transformed material can include completely transforming the first layer of hardened material to form the third transformed material. Transforming the first layer of hardened material to form the third transformed material can include completely transforming the entire first layer of hardened material to form the third transformed material. Transforming the first layer of hardened material to form the third transformed material can include (e.g., completely) altering the microstructure of the first layer of hardened material at least in part (e.g., entirely) to form the third transformed material. Transforming can be melting. Melting can be complete melting.

In another aspect, an apparatus for forming a 3D object comprises: a controller that is programmed to (a) direct a first energy beam to transform at least a portion of a powder bed to form a first transformed material that is suspended anchorlessly in the powder bed during its formation, wherein the first transformed material hardens to a first layer of hardened material, wherein the powder bed is formed of a first particulate material selected from the group consisting of elemental metal, metal alloy, ceramic, and an allotrope of elemental carbon; (b) direct a layer dispensing mechanism to dispense a layer of powder material on an exposed surface of the powder bed; and (c) direct the first energy beam to transform (i) a portion of the layer of powder to form a second transformed material and (ii) at least a portion of the (e.g., entire) first layer of hardened material to form a third transformed material, wherein the second transformed material and the third transformed material form at least a portion of the 3D object, wherein the 3D object is suspended anchorlessly in the powder bed during its formation, and wherein the controller is operatively coupled to the first energy beam, the layer dispensing mechanism, and the powder bed. The layer dispensing mechanism may comprise a powder dispenser. The layer dispensing mechanism may comprise a recoater. The layer dispensing mechanism may comprise an opening port. The layer dispensing mechanism may comprise an electrical connection. The layer dispensing mechanism may comprise an electrical socket. The layer dispensing mechanism can comprise an exit and/or entry port. The energy source may further generate a second energy beam, which second energy beam transforms at least a second portion of the powder bed to form a transformed material as part of the 3D object. The controller may further be operatively coupled to the second energy beam. Transforming the first layer of hardened material to form the third transformed material can include completely transforming the first layer of hardened material to form the third transformed material. Transforming the first layer of hardened material to form the third transformed material can include completely transforming the entire first layer of hardened material to form the third transformed material. Transforming the first layer of hardened material to form the third transformed material can include (e.g., completely) altering the microstructure of the first layer of hardened material at least in part (e.g., entirely) to form the third transformed material. Transforming can be melting. Melting can be completely melting.

In another aspect, a method for forming a desired closed 3D structure comprises: (a) transforming at least a first portion of a powder bed to subsequently form a first closed 3D structure in a first (e.g., substantially) horizontal plain, which first closed 3D structure has a first hollow interior; (b) depositing a layer of powder material on an exposed surface of the powder bed; and (c) transforming at least a second portion of the layer of powder material to (e.g., substantially) form a second closed 3D structure in a second horizontal plane, which second closed 3D structure has a second hollow interior, which second closed 3D structure is the desired closed 3D structure, which second closed 3D structure is separated from the first closed 3D structure by a gap, wherein the gap is bridged at one or more positions to form a third closed 3D structure comprising a third hollow interior, wherein the third closed 3D structure floats anchorlessly in the powder bed, and wherein the powder bed is formed of a first particulate material selected from the group consisting of elemental metal, metal alloy, ceramic, and an allotrope of elemental carbon. The power bed can be disposed on a platform. The second closed 3D structure can comprise a bottom surface. Bottom can be in the direction towards the platform. The one or more positions may constitute at most about 50% of the surface of the bottom surface. The one or more positions may constitute at most about 10% of the surface of the bottom surface. The one or more positions may constitute at most about 1% of the surface of the bottom surface. Transforming can comprise fusing. Fusing can comprise sintering or melting. The first closed 3D structure and the second closed 3D structure may be concentric. The second closed 3D structure can comprise a rotational symmetry axis that is (e.g., substantially) parallel to the direction of the gravitational field. The second closed 3D structure can comprise an inversion point situated at the second plane. The second closed 3D structure can comprise mirror symmetry line situated at the second plane. The first closed 3D structure and the second closed 3D structure may be rings. The rings may be concentric. The material bed can be disposed on a platform. The first closed 3D structure may float (e.g., be suspended) anchorlessly in the material bed. The first closed 3D structure may float anchorlessly in the material bed during its formation. The first closed 3D structure may float anchorlessly in the material bed during the formation of the second closed 3D structure. The first closed 3D structure can comprise a protrusion. The protrusion may be directed towards the second closed 3D structure. The protrusion may contact the second closed 3D structure. The first closed 3D structure may be sacrificial. The second closed 3D structure may be a desired closed 3D structure.

In another aspect, an apparatus for forming a 3D object comprises: a controller that is programmed to (i) direct a first energy beam to transform at least a first portion of a powder bed to subsequently form a first closed 3D structure having a first hollow interior, wherein the first closed 3D structure forms a first average plane that is substantially perpendicular to the direction of the gravitational field, wherein the powder bed is formed of a first particulate material selected from the group consisting of elemental metal, metal alloy, ceramic, and an allotrope of elemental carbon; (ii) direct a layer dispensing mechanism to deposit a layer of powder material on an exposed surface of the powder bed, and (iii) direct the first energy beam to transform at least a second portion of the layer of powder material to subsequently form a second closed 3D structure in a second horizontal plane, which second closed 3D structure has a second hollow interior, which second closed 3D structure is the desired closed 3D structure, which second closed 3D structure is separated from the first closed 3D structure by a gap, wherein the gap is bridged at one or more positions to form a third closed 3D structure comprising a third hollow interior, wherein the third closed 3D structure floats anchorlessly in the powder bed. The layer dispensing mechanism can comprise a material dispenser. The layer dispensing mechanism can comprise a recoater. The layer dispensing mechanism can comprise an opening port. The layer dispensing mechanism can comprise an electrical connection. The layer dispensing mechanism can comprise an electrical socket. The layer dispensing mechanism can comprise an exit and/or entry port. The first energy source further generates a second energy beam. The second energy beam may transform at least a second portion of the material bed to form a transformed material as part of the 3D object. The apparatus may further comprise a second energy source that generates a second energy beam. The second energy beam can transform at least a second portion of the material bed to form a transformed material as part of the 3D object. The controller may be further operatively coupled to the second energy beam.

In another aspect, a system for forming a closed 3D structure comprises: (a) a powder bed; (b) a layer dispensing mechanism that dispenses a layer of powder material on an exposed surface of the powder bed; (b) a first energy source that generates a first energy beam, which energy beam transforms at least a first portion of the powder bed to form a transformed material as part of the closed 3D structure; and (c) a controller operatively coupled to the powder bed, layer dispensing mechanism, and first energy source and is programmed to: (i) direct the first energy beam to transform at least a first portion of the powder bed to subsequently form a first closed 3D structure having a first hollow interior, wherein the first closed 3D structure forms a first average plane that is substantially perpendicular to the direction of the gravitational field, (ii) direct the layer dispensing mechanism to deposit a layer of powder material on an exposed surface of the powder bed, and (iii) direct the first energy beam to transform at least a second portion of the layer of powder material to subsequently form a second closed 3D structure in a second horizontal plane, which second closed 3D structure has a second hollow interior, which second closed 3D structure is the desired closed 3D structure, which second closed 3D structure is separated from the first closed 3D structure by a gap, wherein the gap is bridged at one or more positions to form a third closed 3D structure comprising a third hollow interior, wherein the third closed 3D structure floats anchorlessly in the powder bed. The layer dispensing mechanism can comprise a material dispenser. The layer dispensing mechanism can comprise a recoater. The layer dispensing mechanism can comprise an opening port. The layer dispensing mechanism can comprise an electrical connection. The layer dispensing mechanism can comprise an electrical socket. The layer dispensing mechanism can comprise an exit and/or entry port. The first energy source further generates a second energy beam, which second energy beam transforms at least a second portion of the material bed to form a transformed material as part of the 3D object. The system may further comprise a second energy source that generates a second energy beam, which second energy beam transforms at least a second portion of the material bed to form a transformed material as part of the 3D object. The controller is further operatively coupled to the second energy beam.

In another aspect, a method for forming a 3D object comprises: (a) transforming a first portion of a powder bed disposed on a platform to a first transformed material that forms a first portion of the 3D object, which first portion comprises a first surface; and (b) transforming a second portion of the powder bed to a second transformed material that forms a second portion of the 3D object, which second portion comprises a second surface, wherein the powder bed is formed of a particulate material selected from the group consisting of elemental metal, metal alloy, ceramic, and an allotrope of elemental carbon, wherein the second surface is above the first surface along a direction away from the platform, and wherein, with (i) point A being on the first surface, (ii) point B being on the second surface, and (iii) point C being any point on the second surface within a shortest distance of at most about 2 millimeters from point A: (1) point B is directly above point A and is separated from point A by a gap that is devoid of a transformed material, wherein a spacing of the gap is from about 10 micrometers to about 50 centimeters, (2) a first angle between a first normal to the second surface at point B and the gravitational acceleration vector is at most about 30 degrees, and (3) a second angle between a second normal to the second surface at point C and the gravitational acceleration vector is at most about 30 degrees. The first portion of the 3D object may be a hanging structure. The second portion of the 3D object may be a hanging structure. The hanging structure may be a wire. The hanging structure may be a 3D plane. The gap may be within a cavity. Transforming can comprise a first energy beam. Transforming can comprise a first energy beam and a second energy beam. The first energy beam may be focused and the second energy beam may be non-focused. The first energy beam may be faster than the second energy beam. The first energy beam may have a greater power per unit area than the second energy beam. Greater is by at least about half an order of magnitude. Greater is by at least about an order of magnitude. Transforming can comprise using a first energy beam having a power per unit area of at least about 100 watts per millimeter square. Transforming can comprise using a second energy beam having a power per unit area from at least about 0.1 watt per millimeter square to about 100 watts per millimeter square. The closely situated 3D planes may deviate from a model thereof by at most about 50 micrometers. The closely situated 3D planes may deviate from the model by at most about the sum of 25 micrometers and 1/1000 of a fundamental length scale (abbreviated herein as “FLS”) of the 3D object. The closely situated 3D planes may deviate from the requested 3D object by at most about the sum of 25 micrometers and 1/2500 times the FLS of the requested 3D object. The first portion of a powder bed and the second portion of the powder bed may be transformed simultaneously. The first portion of a powder bed and the second portion of the powder bed may be transformed sequentially.

In another aspect, a method for forming a 3D object comprises: transforming a first portion of a powder bed disposed on a platform to form first transformed material that forms a first portion of the 3D object comprising a first surface; and transforming a second portion of the powder bed to form a second transformed material that forms a second portion of the 3D object comprising a second surface, wherein the second surface is above the first surface, wherein above is a direction away from the platform, wherein point A is on the first surface, and point B is on the second surface, wherein point B is directly above point A and is separated from point A by a gap devoid of a transformed material that hardens into a hardened material, wherein a gap AB is from about 10 micrometers to about 50 centimeters, wherein a first angle between normal to the surface at point B and the direction of the gravitational field is at most about 30 degrees, wherein point C is any point on the second surface within a shortest distance of at most about 2 millimeters from point A, wherein a second angle between normal to the surface at point C and the direction of the gravitational field is at most about 30 degrees, and wherein the powder bed is formed of a particulate material selected from the group consisting of elemental metal, metal alloy, ceramic, and an allotrope of elemental carbon. The first portion of the 3D object can be a hanging structure. The second portion of the 3D object can be a hanging structure. The hanging structure can be a wire. The hanging structure can be a 3D plane. The gap can be within a cavity. Transforming can comprise a first energy beam. Transforming can comprise a first energy beam and a second energy beam. The first energy beam may be focused and the second energy beam may be non-focused. The first energy beam may be faster than the second energy beam. The first energy beam may have a greater power per unit area than the second energy beam. Greater is by at least about half an order of magnitude. Greater is by at least about an order of magnitude. Transforming can comprise using a first energy beam having a power per unit area of at least about 100 watts per millimeter square. Transforming can comprise using a second energy beam having a power per unit area from at least about 0.1 watt per millimeter square to about 100 watts per millimeter square. The closely situated 3D planes may deviate from a model thereof by at most about 50 micrometers. The closely situated 3D planes may deviate from the model by at most about the sum of 25 micrometers and 1/1000 of a fundamental length scale (abbreviated herein as “FLS”) of the 3D object. The closely situated 3D planes may deviate from the requested 3D object by at most about the sum of 25 micrometers and 1/2500 times the FLS of the requested 3D object. The first portion of a powder bed and the second portion of the powder bed may be transformed simultaneously. The first portion of a powder bed and the second portion of the powder bed may be transformed sequentially.

In another aspect, an apparatus for forming a 3D object comprises: a controller that is programmed to direct a first energy beam to (a) transform a first portion of a powder bed disposed on a platform to form first transformed material that forms a first portion of the 3D object comprising a first surface; and (b) transform a second portion of the powder bed to form a second transformed material that forms a second portion of the 3D object comprising a second surface, wherein the second surface is above the first surface, wherein above is a direction away from the platform, wherein point A is on the first surface, and point B is on the second surface, wherein point B is directly above point A and is separated from point A by a gap AB devoid of a transformed material that hardens into a hardened material, wherein a gap AB is from 10 micrometers to 50 centimeters, wherein a first angle between normal to the surface at point B and the direction of the gravitational field is at most about 30 degrees, wherein point C is any point on the second surface within a shortest distance of at most about 2 millimeters from point A, wherein a second angle between normal to the surface at point C and the direction of the gravitational field is at most about 30 degrees, and wherein the powder bed is formed of a particulate material selected from the group consisting of elemental metal, metal alloy, ceramic, and an allotrope of elemental carbon. The first energy source further generates a second energy beam, which second energy beam transforms at least a second portion of the powder bed to form a transformed material as part of the 3D object. The apparatus may further comprise a second energy source that generates a second energy beam. The second energy beam may transform at least a second portion of the powder bed to form a transformed material as part of the 3D object. The controller may be further operatively coupled to the second energy beam. The first portion of a powder bed and the second portion of the powder bed may be transformed simultaneously. The first portion of a powder bed and the second portion of the powder bed may be transformed sequentially.

In another aspect, a system for forming a closed 3D structure comprises: (a) a powder bed formed of a first particulate material selected from the group consisting of elemental metal, metal alloy, ceramic, and an allotrope of elemental carbon; (b) a first energy source that generates a first energy beam, which energy beam transforms at least a first portion of the powder bed to form a transformed material as part of the closed 3D structure; and (c) a controller operatively coupled to the powder bed, and first energy source and is programmed to direct the first energy beam to (i) transform a first portion of a powder bed disposed on a platform to form first transformed material that forms a first portion of the 3D object comprising a first surface; and (ii) transform a second portion of the powder bed to form a second transformed material that forms a second portion of the 3D object comprising a second surface, wherein the second surface is above the first surface, wherein above is a direction away from the platform, wherein point A is on the first surface, and point B is on the second surface, wherein point B is directly above point A and is separated from point A by a gap AB that is devoid of a transformed material that hardens into a hardened material, wherein a gap AB is from about 10 micrometers to about 50 centimeters, wherein a first angle between normal to the surface at point B and the direction of the gravitational field is at most about 30 degrees, wherein point C is any point on the second surface within a shortest distance of at most about 2 millimeters from point A, and wherein a second angle between normal to the surface at point C and the direction of the gravitational field is at most 30 degrees. The first energy source further generates a second energy beam, which second energy beam transforms at least a second portion of the powder bed to form a transformed material as part of the 3D object. The system may further comprise a second energy source that generates a second energy beam, which second energy beam transforms at least a second portion of the powder bed to form a transformed material as part of the 3D object. The controller is further operatively coupled to the second energy beam. The first portion of a powder bed and the second portion of the powder bed may be transformed simultaneously. The first portion of a powder bed and the second portion of the powder bed may be transformed sequentially.

In another aspect, an apparatus for forming a 3D object comprises: a controller that is programmed to direct a first energy beam to transform at least a first portion of a powder bed to form a first 3D object and a second portion of a material bed to form a second 3D object, wherein the second 3D object is enclosed within the first 3D object, wherein the second 3D object is devoid of auxiliary support and is anchorlessly suspended in the material bed during its formation, wherein the controller is operatively coupled to the first energy beam and powder bed, and wherein the powder bed is formed of a particulate material selected from the group consisting of elemental metal, metal alloy, ceramic, and an allotrope of elemental carbon.

Another aspect of the present disclosure provides a method for forming a wire comprising depositing a layer of pre-transformed (e.g., powder) material in a container to form a material bed; transforming the pre-transformed material to form a wire from the pre-transformed material; wherein the wire is suspended in the material bed; wherein during the operation of transforming, the wire forms an average acute angle relative to the direction normal to the gravitational field that is at most about 45 degrees, 35 degrees, 30 degrees, or 25 degrees. The radius of curvature of the wire can be at least one meter or more. In some instances, the wire is at least about 1.7 millimeters long. In some instances, the wire is at least about 2 millimeters long. The method can further comprise broadening the wire to form a 3D plane (e.g., a planar object). The radius of curvature of the 3D plane can be at least about one meter or more. The wire and/or the 3D plane may be suspended anchorlessly in the layer of material. In some instances, the operation of transforming the pre-transformed material can comprise fusing the material. Fusing can comprise melting or sintering. The pre-transformed material can be a powder material. The pre-transformed material can comprise elemental metal, metal alloy, ceramic, or elemental carbon. The method may further comprise heating the wire to a temperature below the transforming temperature.

Another aspect of the present disclosure provides a method for forming a 3D plane comprising: depositing a layer of pre-transformed material above a substrate to form a material bed; transforming the pre-transformed material to form a wire from the pre-transformed material; wherein the wire is suspended in the layer of material; and broadening the wire to form a 3D plane that is suspended in the material bed; wherein during the transforming operation, the wire forms an average acute angle with the field of gravity that is at least about 45 degrees, 35 degrees, 30 degrees, or 25 degrees. The radius of curvature of the 3D plane can be at least one meter. In some instances, the longer of a length and width of the 3D plane is at least about 1.7 millimeters long. In some instances, the shorter of a length and width of the 3D plane is at least about 12 millimeters long. In some instances, the wire is at least about 2 millimeters long. In some instances, the operation of transforming the pre-transformed material can comprise fusing at least a portion of the pre-transformed material. Fusing can comprise melting or sintering. The pre-transformed material can be a powder material. The pre-transformed material can comprise elemental metal, metal alloy, ceramic, or elemental carbon. The method may further comprise heating the wire to a temperature below the transforming temperature. The method may further comprise heating the broadened wire to a temperature below the transforming temperature. The heating may be prior to or during the broadening.

Another aspect of the present disclosure provides a method for forming a 3D plane comprising depositing a layer of pre-transformed material above a base to form a material bed (e.g., powder bed); and forming a wire comprising transformed material from the pre-transformed material; wherein the wire is suspended (e.g., floating anchorlessly) in the material bed; and wherein the pre-transformed material is elemental metal, metal alloy, ceramic, or elemental carbon. The suspended (e.g., floating) wire may not connect to the enclosure. The suspended wire may contact or not contact the enclosure (e.g., the platform).

Another aspect of the present disclosure provides a method for forming a 3D plane comprising: depositing a layer of pre-transformed material to form a material bed above a platform (e.g., base), which platform has a surface that points towards the layer of pre-transformed material, wherein the surface is non-planar (e.g., not flat, not smooth, or not leveled); and forming a wire comprising the pre-transformed material that has been transformed (e.g., powder material that has been fused); wherein the wire is suspended in the material bed. In some instances, transformed can be fused. The transformed material can be a pre-transformed material that was deposited and is subsequently transformed. The pre-transformed material can comprise elemental metal, metal alloy, ceramic, or elemental carbon. The wire can comprise a planar or compound angle. In some embodiments, the non-planar surface is not a mold. The methods described herein can further comprise broadening the wire to form a 3D plane. The 3D plane can be suspended (e.g., float) in the material bed. The broadening may include transforming the pre-transformed material to form a transformed material. The methods may further include hardening the transformed material into a hardened material. Hardened may be solidified. The methods described herein can further comprise depositing an additional layer of pre-transformed material, transforming at least a portion of the pre-transformed material in the additional layer to form a transformed material, and thus connecting the transformed material to the 3D plane to form at least a portion of a 3D object. The at least a portion of a 3D object can be suspended anchorlessly in the material bed. The pre-transformed material may comprise elemental metal, alloy, ceramic, or elemental carbon. The transforming operation may comprise fusing (e.g., melting). The fusing may comprise melting or sintering. The melting may be a complete melting or a partial melting of the pre-transformed material.

Another aspect of the present disclosure provides a method for forming a 3D plane comprising: depositing a layer of pre-transformed material in a container to form a material bed; forming a wire comprising transformed material from the pre-transformed material (e.g., deposited layer of material); wherein the wire is suspended anchorlessly in the material bed; and broadening the wire to form a 3D plane that is suspended anchorlessly in the material bed (e.g., layer of pre-transformed material) using a first energy beam and/or a second energy beam. The 3D plane can be suspended in a portion of the pre-transformed material that is not used to form the wire. The portion of pre-transformed material that is not used to form the wire may be a remainder. In some instances, the remainder does not form a rigid structure over at least about 1 millimeter. The rigid structure may comprise fused material. In some instances, the remainder does not comprise a continuous structure extending over at least about 1 millimeter. The remainder may not comprise a scaffold enclosing the 3D object. The continuous structure may comprise (e.g., lightly) fused material. The pre-transformed material can comprise elemental metal, metal alloy, ceramic, or elemental carbon. In some example, the method does not comprise forming a rigid structure from the pre-transformed material before the formation of the wire, 3D plane, or broadened 3D object. In some examples, the methods described herein do not comprise forming a continuous structure from the pre-transformed material before the formation of the wire, 3D plane, or broadened 3D object. In some examples, the method does not comprise (e.g., excludes) fusing, caking or sintering the pre-transformed material before the formation of the wire, the 3D plane, or the broadened 3D object. The method may not comprise forming a scaffold that encloses the 3D object (e.g., fully encloses). The forming operation may comprise transforming the pre-transformed material. The broadening may comprise transforming at least a portion of the pre-transformed material. Transforming may comprise fusing the material. Fusing may comprise melting (e.g., completely melting) or sintering. In some examples, the first energy beam can translate at a first velocity and the second energy beam can translate at a second velocity. The first velocity may be smaller than the second velocity. The first energy beam may have a power per unit area greater than the power per unit area of the second energy. The first energy beam may have a power per unit area smaller than the power per unit area of the second energy. The first energy beam and the second energy may be of the same frequency and/or power per unit area. The energy beam can comprise a pulsed, a quasi-continuous wave, or a continuous wave energy beam. The energy beam can comprise a quasi-continuous wave energy beam. The methods described herein can further comprise maintaining an edge of the wire in a liquid state before the broadening. The methods described herein can further comprise maintaining a portion of the wire in a liquid state before the broadening. The methods described herein can further comprise maintaining a portion of the wire in a heated (e.g., not molten) state before the broadening. The methods described herein can further comprise maintaining a portion of the wire in a heated state before the broadening, which heated state is below the melting temperature of the material forming the wire. Maintaining can comprise heating the material with a second energy beam.

Another aspect of the present disclosure provides a method for forming an object comprising depositing a layer of pre-transformed material in a container to form a material bed; wherein the pre-transformed material is maintained at an average temperature that is substantially “room temperature”; and forming a wire comprising transformed material from the material in the container; wherein the wire is suspended (e.g., floats anchorlessly) in the material bed. The wire can comprise a compound angle.

Another aspect of the present disclosure provides a method for forming an object comprising depositing a layer of pre-transformed (e.g., powder) material in a container to form a material bed; wherein the pre-transformed material is maintained at an average cryogenic temperature; and forming a wire comprising transformed (e.g., fused) material from the pre-transformed material in the container; wherein the wire is suspended in the material bed (e.g., powder bed).

Another aspect of the present disclosure provides a method for forming a 3D plane comprising depositing a layer of pre-transformed material in a container to form a material bed; and forming a wire comprising transformed (e.g., fused) material from the pre-transformed material; wherein the wire is suspended in a portion of the material that is not used to form the wire (e.g., in the powder bed). The portion of material that is not used to form the wire may be a remainder. In some instances, the remainder does not form a rigid structure over at least about 1 millimeter. The rigid structure may comprise fused material. In some instances, the remainder does not include a scaffold that encloses the wire.

The pre-transformed material may be a powder material. The pre-transformed material can comprise elemental metal, metal alloy, ceramic, or elemental carbon. The forming can comprise transforming the material. The methods described herein can further comprising broadening the wire to form a 3D plane. Broadening may comprise transforming the material. Transforming the material can comprise fusing the material. Fusing can comprise melting (e.g., complete melting) or sintering. For example, broadening may comprise fusing the pre-transformed material. The method can further comprise depositing an additional layer of pre-transformed material, transforming (e.g., fusing) the pre-transformed material in the additional layer to form a transformed material, and thereby connecting the transformed material to the 3D plane to form at least a part of a 3D object. The at least a part of the 3D object can be suspended anchorlessly in the material bed. The 3D plane can be suspended anchorlessly in the material bed. The average temperature can be an average temperature during the formation of the wire. The average temperature can be an average temperature during the formation of the 3D plane.

The methods can further comprise depositing an additional layer of pre-transformed material, transforming (e.g., fusing) the pre-transformed material in the additional layer to form a transformed material, and (e.g., thereby) connecting the transformed material to the 3D plane to form at least a part of a 3D object. The radius of curvature of the 3D plane can be at least about one meter. The largest of a length and a width of the 3D plane can be at least about 1.7 millimeters. The largest of a length and a width of the 3D plane can be at least about 2 millimeters. The smaller of a length and a width of the 3D plane can be at least about 1.7 millimeters. The smaller of a length and a width of the 3D plane can be at least about 2 millimeters. The pre-transformed material can comprise a powder particle. The transformed (e.g., fused) material may have a mean diameter that is at least about two times larger than the mean diameter of the powder material. The transformed material can have a median diameter that is at least about two times larger than the median diameter of the powder material. The powder material can be of a mean particle size that is at most about 300 micrometers. The powder material can be of a median particle size that is at most about 300 micrometers.

Another aspect of the present disclosure provides a method for forming a 3D plane comprising depositing a layer of powder material in a container; wherein the powder material comprises metal, metal alloy, ceramic, or elemental carbon; fusing the powder material to form a wire; wherein the wire is suspended anchorlessly in the layer of powder material; and broadening the wire to form a 3D plane that is suspended in the layer of powder material, wherein during the broadening the 3D plane forms an average acute angle relative to the direction normal to the field of gravity that is at most about 45 degrees, or 30 degrees.

In some examples, the 3D plane can be devoid of auxiliary support. The 3D plane can comprise an auxiliary support that is suspended in the layer of powder material. The 3D plane can comprise two auxiliary supports suspended in the layer of powder material. The distance (e.g., shortest distance) between the two auxiliary supports can be at least about 1.7 millimeters or at least about 2 millimeters. The radius of curvature of the 3D plane can be at least about one meter. The angle alpha may be (e.g., substantially) zero. The powder material can comprise steel alloy, titanium alloy, aluminum alloy, or nickel alloy. The powder material can be stainless steel powder material. The stainless steel can be 316L stainless steel. The stainless steel can be 360L stainless steel. The container may comprise a substrate. The powder material may be disposed above the substrate. In some examples, the wire can be a predetermined wire. Predetermined can comprise a predetermined shape or a predetermined size. Predetermined can be according to a design (e.g., model design). Predetermined can comprise a predetermined material. The fusing can be according to a model. The model can be of a 3D object. The wire can comprise a discontinuous wire. The wire can comprise a continuous wire. The wire can be a continuous or a discontinuous wire. The wire can comprise a straight wire or a curved wire. The wire can comprise a dotted wire.

In some instances, the fusing utilizes an energy beam. The energy beam can comprise laser, electron beam, plasma beam, or ion beam. The energy beam can comprise a pulsed, a quasi-continuous wave, or a continuous wave energy beam. The energy beam can comprise a quasi-continuous wave energy beam. The energy beam can comprise a continuous wave energy beam. At times, the broadening can be performed when at least part of the wire is in a liquefied state. The fusing can comprise utilizing a first and a second energy beam. The first energy beam and the second energy can be of the same frequency. The first energy beam and the second energy beam can originate from the same energy source. The first energy beam and the second energy beam may originate from different energy sources.

In some examples, utilizing the first energy beam can comprise fusing the powder material. Utilizing the second energy beam can comprise maintaining part of the wire in a liquid state, or in a heated but not liquefied state. Utilizing the second energy beam can comprise maintaining part of an edge of the wire in a liquid state. Utilizing the second energy beam can comprise liquefying part of the fused material. Utilizing the second energy beam can comprise liquefying part of the edge of the fused material. In some embodiments, the broadening can be performed when at least a part of the wire is in a liquid state.

In some instances, at least one path followed by the second energy beam can track the wire. At least one path followed by the first energy beam can track the wire. At least one path followed by both the first and the second energy beams can track the wire. The at least one path can comprise parallel path sections. The parallel path sections (e.g., hatch lines) can be included within a path. At times, at least two parallel path sections are each included within a different path. Occasionally, all the parallel path sections are each included within a different path respectively. The path can comprise path sections that cross at least once. The path followed by the first and/or second energy beam can track the wire one, two or more times. In some examples, the second energy beam can precede the first energy beam during the broadening operation. In some instances, the first energy beam can follow the second energy beam during the broadening operation. At times, during the broadening operation, a path tracked by the second energy beam can succeed a path tracked by the first energy beam. At times, during the broadening operation, a path tracked by the second energy beam overlaps a path tracked by the first energy beam. The broadening can comprise an energy beam tracking a path. The path can comprise a U shaped turn (herein “U turn”). The path may be devoid of U turns.

In some embodiments, a first and second energy beam participate in the 3D object generation (e.g., 3D printing process). In some instances, the first energy beam has a first power per unit area and the second energy beam has a second power per unit area. The first power per unit area can be different or (e.g., substantially) be identical as compared to the second power per unit area. The first power per unit area can be smaller or larger as compared to the second power per unit area. The first power per unit area can be smaller as compared to the second power per unit area. The first power per unit area can be larger as compared to the second power per unit area. The first energy beam can translate at a first velocity and the second energy beam can translate at a second velocity. The first velocity can be slower, faster, or (e.g., substantially) identical as compared to the second velocity. The first velocity can be slower as compared to the second velocity. The first velocity can be faster as compared to the second velocity.

In some examples, depositing a layer of powder material can comprise depositing the powder material adjacent to (e.g., on) a platform (e.g., base). The base may be above the substrate. The base may be (e.g., substantially) horizontal. The platform (e.g., base) can be non-planar. The platform (e.g., base) may be planar (e.g., flat). The platform (e.g., base) can comprise a protrusion or an indentation. The platform (e.g., base) can comprise a wave. The platform (e.g., base) can comprise a mesh.

In some instances, the layer of powder material is at least about 50 micrometers thick. The layer of powder material can be at least about 500 millimeters thick. The methods described herein may be performed in an enclosure (e.g., container). The methods can be performed in a vacuum, ambient pressure, or pressurized environment (e.g., positive pressure). The pressure within the container may be an ambient pressure. The pressure within the container may be below ambient pressure. The pressure within the container may be above ambient pressure. The container may comprise an atmosphere. The container may comprise a regulated or controlled atmosphere (e.g., using a controller). The container can comprise an inert atmosphere. The container can comprise an oxygen-depleted atmosphere. The container can comprise a water-depleted atmosphere. The container can comprise a sulfur-depleted atmosphere. The container can comprise a nitrogen-depleted atmosphere. The container can comprise an argon or a nitrogen atmosphere. The container can comprise air.

In some examples, the average temperature of the powder material is an ambient temperature. The average temperature of the powder material can be below the fusion temperature of the powder material. The average temperature of the powder material can be just below the fusion temperature of the powder material. The average temperature of the powder material can be a cryogenic temperature. The average temperature of the powder material can be below the fusion temperature of the powder material. The material can be heated to a temperature below the fusion temperature of the material prior to at least one of the (i) fusing of the material to form a wire and (ii) broadening of the wire.

In another aspect, an apparatus for forming a 3D plane by additive manufacturing comprises: a container capable of containing a pre-transformed material (e.g., a material bed); wherein the pre-transformed material is transformable into a 3D object by a process comprising an application of a stimulus; wherein the container comprises a surface situated below the pre-transformed material; wherein the surface comprises a non-planar feature that does not directly support the 3D plane. The stimulus may comprise an energy beam. Directly support may comprise connecting to the 3D plane. Directly support may comprise contacting the 3D plane. Directly support may comprise providing an anchor to the 3D plane.

In another aspect, a system for forming a 3D plane comprises: a container comprising a pre-transformed material, wherein the pre-transformed material forms a material bed that is contained within the container; wherein the container further comprises a surface situated below the material bed, wherein the surface can comprise a non-planar feature that does not directly support the 3D plane; a first energy beam capable of transforming the pre-transformed material; and a control system that is in communication with the first energy beam, wherein the control system regulates the energy supplied from the first energy beam to the material bed.

The non-planar feature may not contact the 3D plane. In some instances, the non-planar feature can comprise a protrusion or an indentation. The container can comprise a platform (e.g., building platform). The surface can be of the platform. The platform may comprise a substrate or a base. The surface may point towards the material bed situated in the container. The pre-transformed material can comprise a powder material. The material can comprise elemental metal, metal alloy, ceramic, or elemental carbon. The systems or the apparatus described herein can further comprise a second energy beam. The power per unit area of the first energy beam may be smaller than the power per unit area of the second energy beam. The power per unit area of the first energy beam may be greater than the power per unit area of the second energy beam.

In an aspect disclosed herein is a wire comprising successive regions of hardened material indicative of an additive manufacturing process; wherein the successive regions of hardened material are situated along the wire; wherein the hardened material can comprise elemental metal, metal alloy, ceramic, or elemental carbon; wherein the length of the wire is at least two millimeters; wherein a shortest distance between points X and Y on the wire is devoid of (e.g., any) auxiliary support and auxiliary support mark; wherein the shortest distance between points X and Y on the wire is at least about 2 millimeters; wherein a material structure of the areas of hardened material indicate that the wire has been formed at an acute angle of 45 degrees or more from the gravitational field. The acute angle can be substantially perpendicular to the gravitational field. Hardened can comprise solidified.

In another aspect, a 3D object comprises successive regions of hardened material indicative of an additive manufacturing process; wherein the successive regions of hardened material are situated within the 3D plane in rows; wherein the hardened material can comprise elemental metal, metal alloy, ceramic, or elemental carbon; wherein the largest of a length and a width of the 3D plane is at least about two millimeters; wherein a shortest distance between points X and Y on the 3D plane is devoid of (e.g., any) auxiliary support and auxiliary support mark; wherein the shortest distance between points X and Y on the 3D plane is at least about 2 millimeters; wherein the radius of curvature of the 3D plane is at least about one meter; and wherein a material structure of the areas of hardened material indicate that the 3D plane has been formed at an acute angle of 45 degrees or less from a normal to the gravitational field. The acute angle can be (e.g., substantially) zero. Hardened can comprise solidified.

In some embodiments, a first layer of hardened material can remain in the 3D object. Sometimes, the object does not undergo further treatment. At times, the 3D object undergoes further treatment. The further treatment may preserve a first layer of hardened material within the 3D object. The further treatment may comprise scraping, machining, polishing, grinding, blasting, annealing, or chemical treatment.

In another aspect, a 3D object comprises successive regions of hardened material indicative of at least one additive manufacturing process; wherein the hardened material comprises melt pools; and wherein the average fundamental length scale (herein designated as “FLS”) of the melt pools in a surface of the 3D object is larger than the average FLS of the melt pools in the interior of the 3D object.

In some instances, the surface comprises a first layer of hardened material. The first layer of hardened material can be a first hardened layer in the 3D object (e.g., the bottom skin layer). The first layer of hardened material may be a first hardened layer in the object (e.g., bottom skin layer) as indicated by the spatial orientation of the melt pools (e.g., elongated melt pools, dripping melt pools, and/or stalactite-like melt pools). The average FLS of the melt pools in the surface can be larger than the average FLS of the melt pools in the interior by a factor of two or more.

In another aspect, a 3D object comprises successive regions of hardened material indicative of at least one additive manufacturing process; wherein the successive regions of hardened material comprise a first plane of hardened material and a second plane of hardened material; wherein the hardened material comprises melt pools; and wherein the average FLS of the melt pools in the first plane of hardened material is larger than the average FLS of the melt pools in the second plane of hardened material. At times, the average FLS of the melt pools in the first plane of hardened material is larger than the average FLS of the melt pools in the second plane of hardened material by a factor of about two or more.

In another aspect, a 3D object comprises successive regions of hardened material indicative of at least one additive manufacturing process; wherein the successive regions of hardened material comprise a first plane of hardened material and a second plane of hardened material; wherein the hardened material comprises material grains; and wherein the average FLS of the material grains in the first plane of hardened material is larger than the average FLS of the material grains in the second plane of hardened material. In some embodiments, the average FLS of the material grains in the first plane of hardened material can be larger than the average FLS of the material grains in the second plane of hardened material by a factor of about two or more.

In another aspect, a 3D object comprises successive regions of hardened material indicative of an additive manufacturing process; wherein the successive regions of hardened material comprise a first plane of hardened material and a second plane of hardened material; wherein the hardened material comprises a material morphology type (e.g., dendrites or cells); and wherein the average length of the material morphology type in the first plane of hardened material are larger than the average length of the material morphology type in the second plane of hardened material. The average length of the dendrites in the first plane of hardened material can be larger than the average length of the material morphology type in the second plane of hardened material by a factor of two or more. The material morphology type can be dendrite. The material morphology type can be cell.

In another aspect, a 3D object comprises successive regions of hardened material indicative of an additive manufacturing process; wherein the successive regions of hardened material comprise a first plane of hardened material and a second plane of hardened material; wherein the hardened material comprises a material morphology type (e.g., dendrite); and wherein the average width of the material morphology type in the first plane of hardened material are larger than the average width of the material morphology type in the second plane of hardened material. The average width of the material morphology type in the first plane of hardened material can be larger than the average width of the material morphology type in the second plane of hardened material by a factor of about two or more. The material morphology type can be dendrite or cell.

In another aspect, a 3D object comprises successive regions of hardened material indicative of an additive manufacturing process; wherein the successive regions of hardened material comprise a first plane of hardened material and a second plane of hardened material; wherein the hardened material comprises crystals; and wherein the average length of the crystals in the first plane of hardened material are larger than the average length of the crystals in the second plane of hardened material. The average length of the crystals in the first plane of hardened material can be larger than the average length of the crystals in the second plane of hardened material by a factor of about two or more. The crystals can be single crystals. The crystals can be elongated crystals. The crystals can form dendrites. The crystals can form cells.

In another aspect, a 3D object comprises successive regions of hardened material indicative of an additive manufacturing process; wherein the successive regions of hardened material comprise a first plane of hardened material and a second plane of hardened material; wherein the hardened material comprises crystals; and wherein the average width of the crystals in the first plane of hardened material are larger than the average width of the crystals in the second plane of hardened material. The average width of the crystals in the first plane of hardened material can be larger than the average width of the crystals in the second plane of hardened material by a factor of about two or more. The crystals can be single crystals. The crystals can be elongated crystals. The crystals can form cells.

In some embodiments, the successive regions of hardened material can be situated within the 3D plane in rows. The hardened material can comprise elemental metal, metal alloy, ceramic, or elemental carbon. The first plane of hardened material can be a first constructed plane of hardened material of the 3D object (e.g., bottom skin layer). The first plane of hardened material can be an initially constructed plane of hardened material of the 3D object. The first plane of hardened material can be the base plane of hardened material of the 3D object (e.g., bottom skin plane), on top of which all other planes are situated. The first plane of hardened material can be a first plane of hardened material in the 3D object as indicated by the spatial orientation of the melt pools. The first plane of hardened material can remain in the 3D object. In some examples, the 3D object did not undergo further treatment after completion of the at least one additive manufacturing method. Sometimes, the 3D object did undergo further treatment after completion of the at least one additive manufacturing method. The further treatment can preserve the first constructed plane of hardened material (e.g., the base plane, the plane of the bottom skin layer) within the 3D object. The further treatment can preserve at least a part of a first plane of hardened material (e.g., the base plane) within the 3D object. The longest of a length and a width of the 3D plane can be at least about two millimeters. A shortest distance between points X and Y on the 3D plane (line XY) can be devoid of auxiliary support and auxiliary support mark. A circle with a radius of length XY on the surface of the 3D object can be devoid of auxiliary support and auxiliary support mark. XY can be at least about 2 millimeters long. A sphere with a radius of length XY intersecting the surface of the 3D plane can be devoid of auxiliary support marks. XY can be at least about 2 millimeters long. A radius of curvature of the 3D plane can be at least about 50 centimeters, or one meter. A material structure of the hardened material may indicate that the 3D plane has been formed (e.g., constructed) at an acute angle of 45 degrees or less from a normal to the gravitational field.

In another aspect, a method for forming a 3D plane comprises: depositing a first layer of pre-transformed material (e.g. powder material) adjacent to (e.g., above) a substrate to form a material bed; transforming at least a first portion of the pre-transformed material of the first layer to form at least two spaced apart wires made of the pre-transformed material that has been transformed (e.g., and subsequently hardened); wherein the spaced apart wires are suspended anchorlessly in the material bed; broadening each of the spaced apart wires to each form a 3D plane that is suspended in the material bed, thus forming at least two spaced apart 3D planes; depositing a second layer of pre-transformed material adjacent to (e.g., above) the at least two 3D planes; and transforming at least a second portion of the pre-transformed material of the second layer to connect the at least two 3D planes, thus forming an enlarged 3D plane; wherein during the forming operation, the enlarged 3D plane forms an average acute angle relative to the direction normal to the field of gravity that is at most about 45 degrees, 35 degrees, 30 degrees, or 20 degrees.

In some examples, the enlarged 3D plane can be suspended anchorlessly in the material bed. The wire, 3D plane or enlarged 3D plane may comprise auxiliary support that is suspended anchorlessly in the material bed. The spaced apart distance may be the shortest distance between the wires.

The shortest distance between two auxiliary supports or auxiliary support marks can be at least about 2 millimeters. During the process of transforming of the at least a portion of the pre-transformed material to form at least two spaced apart wires, at least one of the at least two spaced apart wires may form an average acute angle with the gravitational field that is at least 45 degrees, 55 degrees, 60 degrees, or 70 degrees. Suspended in the pre-transformed material (e.g., powder material) can comprise suspended (e.g., float anchorlessly) in the first layer of pre-transformed material. Transforming the pre-transformed material in the second layer to connect the at least two 3D planes may comprise transforming the pre-transformed material along a path. The path may overlap the at least two 3D planes. The path may overlap the at least one of the at least two 3D planes. At times, the path may not overlap the at least one of the at least two 3D planes. The path may not overlap the at least two 3D planes. The broadening operation may comprise transforming the pre-transformed material into a transformed material. The transforming operation may comprise fusing. The fusing operation may comprise melting or sintering. The pre-transformed material can comprise a powder material. The material can comprise elemental metal, metal alloy, ceramic, or elemental carbon. The average acute angle between the 3D plane as it forms and the direction normal to the field of gravity may be at most 45 degrees. The average acute angle between at least one of the at least two spaced apart wires (e.g., as they are forming), and the direction normal to the field of gravity, may be at most about 45 degrees, 35 degrees, 30 degrees, or 20 degrees. The average acute angle between the at least two spaced apart wires (e.g., as they are forming), and the direction normal to the field of gravity, may be at most about 45 degrees, 35 degrees, 30 degrees, or 20 degrees. The length of at least one of the at least two spaced apart wires may be at least about 2 millimeters. The largest of a length and a width of the 3D plane may be at least about 2 millimeters. The at least two spaced apart wires may be spaced at least about 2 millimeters apart. The spaced apart 3D planes may be spaced at least about 2 millimeters apart. The spaced apart distance may be the shortest distance between the wires.

In another aspect, a method for forming a suspended (e.g., floating anchorlessly) 3D object comprises: depositing a first layer of pre-transformed material (e.g., powder material) adjacent to (e.g., above) a substrate to form a material bed; transforming at least part of the pre-transformed material of the first layer to form at least two spaced apart objects; wherein the spaced apart objects are suspended in the material bed; depositing a second layer of pre-transformed material adjacent to (e.g., above) the at least two spaced apart 3D objects; and transforming at least part of the pre-transformed material of the second layer to connect the at least two space apart objects, thus forming an enlarged object; wherein during the forming the enlarged 3D plane forms an average acute angle relative to the direction normal to the field of gravity that is at most about 45 degrees.

The 3D objects can comprise wires. The 3D objects can be wires. The objects can comprise 3D planes. The objects can be 3D planes. The enlarged object can comprise a 3D plane. The enlarged 3D object can be a 3D plane. The methods described herein can further comprise before the depositing operation, broadening at least one of the spaced apart wires to form a 3D plane that is suspended anchorlessly in the material bed, thus forming at least two spaced apart 3D objects (e.g., a wire and a 3D plane). The methods described herein can further comprise before the depositing operation, broadening each of the spaced apart wires to each form a 3D plane that is suspended anchorlessly in the material bed, thus forming at least two spaced apart 3D planes.

In another aspect, a 3D object comprises a first layer of material (e.g., transformed material, hardened material, or solid material) comprising spaced apart sections of material formed by at least one additive manufacturing method; and a second layer of material adjacent to the first layer of material; wherein the second layer connects the spaced apart sections to form at least a part of an object; wherein the average plane between the second layer and the spaced apart sections of the first layer is an average layering plane; wherein the average acute angle between the direction normal to the field of gravity and the average layering plane, is at most about 45 degrees, 35 degrees, 30 degrees, or 20 degrees; wherein a shortest distance between points X and Y on the surface of the at least a part of an object are devoid of auxiliary support and auxiliary support mark; wherein the shortest distance between points X and Y is at least about 1.7 millimeters. The average plane may have a radius of curvature of at least about one meter.

Another aspect of the present disclosure provides a 3D object comprising a first layer of hardened material comprising spaced apart sections of hardened material formed by at least one additive manufacturing method; wherein the first layer comprises first successive regions of hardened material indicative of an additive manufacturing process conducted in a first average plane; and a second layer of hardened material adjacent to the first layer of hardened material; wherein the second layer comprises second successive regions of hardened material indicative of an additive manufacturing process conducted in a second average plane; wherein the second layer connects the spaced apart sections to form at least a part of the 3D object; wherein a material structure of the first or of the second successive regions of hardened material indicate that the first or the second average plane respectively has been formed at an acute angle of 45 degrees, 35 degrees, 30 degrees, 20 degrees, or less from a normal to the gravitational field; wherein a shortest distance between points X and Y on the surface of the at least a part of an object are devoid of auxiliary support and auxiliary support mark; wherein the shortest distance between points X and Y is at least about 1.7 millimeters.

The second average plane may have a radius of curvature of at least about one meter. The shortest distance can be at least 2 about millimeters. The hardened material can comprise solidified material. The material can comprise elemental metal, metal alloy, ceramic, or elemental carbon. The first layer can comprise a wire. The first layer may comprise a disconnected wire. The first layer may comprise a 3D plane. The first layer can comprise a disconnected 3D plane. The 3D object can be a 3D plane. The 3D object can comprise a 3D plane. The second layer of material adjacent to the first layer of material can be above the first layer. Adjacent can be above.

Another aspect of the present disclosure provides a method for forming a 3D plane comprising depositing a first layer of pre-transformed material (e.g., powder material) in a container to form a material bed; transforming at least a first portion of the pre-transformed material to form at least two spaced apart wire objects; depositing a second layer of pre-transformed material; and transforming at least a second portion of pre-transformed material in the second layer to connect the at least two spaced apart wire objects, thus forming an enlarged 3D plane. The methods may further comprise broadening at least one of the of the spaced apart wire objects to form one or more 3D planes. The enlarged 3D plane may comprise a wire and a 3D plane. The enlarged 3D plane may comprise two wires. The enlarged 3D plane may comprise two 3D planes.

In another aspect, a method for forming a 3D plane comprises depositing a layer of pre-transformed material in a container to form a material bed; transforming the pre-transformed material to form at least two spaced apart wires; wherein the spaced apart wires are suspended anchorlessly in the material bed; broadening each of the spaced apart wires to each form a 3D plane that is suspended anchorlessly in the material bed, thus forming at least two spaced apart 3D planes; depositing an additional layer of pre-transformed material adjacent to (e.g., above) the at least two 3D planes; and transforming the pre-transformed material in the additional layer to connect the at least two 3D planes, thus forming an enlarged 3D plane.

During the operation of forming an enlarged 3D plane, the average acute angle between the enlarged 3D plane and the direction normal to the field of gravity can be at most about 45 degrees, 35 degrees, 30 degrees, or 20 degrees. During the operation of transforming the pre-transformed material to form at least two spaced apart wires, the average acute angle between the at least two spaced apart wires and the direction normal to the field of gravity can be at most about 45 degrees, 35 degrees, 30 degrees, or 20 degrees. During broadening of each of the spaced apart wires to each form a 3D plane, the average acute angle between the 3D plane and the direction normal to the field of gravity can be at most about 45 degrees, 35 degrees, 30 degrees, or 20 degrees. The enlarged 3D plane may have a material structure indicating that it has been formed in an average acute angle of at most about 45 degrees, 35 degrees, 30 degrees, or 20 degrees relative to the direction normal to the field of gravity. The at least two spaced apart wires may have a material structure indicating that the wires have been formed at an average acute angle of at most about 45 degrees, 35 degrees, 30 degrees, or 20 degrees relative to the direction normal to the field of gravity. The 3D plane may have a material structure indicating that the 3D plane has been formed at an average acute angle of at most about 45 degrees, 35 degrees, 30 degrees, or 20 degrees relative to the direction normal to the field of gravity. The broadening operation can comprise transforming the material. The transforming operation can comprise fusing. The fusing operation can comprise melting or sintering. The material may be a powder material. The material can comprise elemental metal, metal alloy, ceramic or elemental carbon. The average acute angle between the 3D plane and the direction normal to the field of gravity can be at most about 45 degrees. The average acute angle between at least one of the at least two spaced apart wires, and the direction normal to the field of gravity, can be at most about 45 degrees. The length of at least one of the at least two spaced apart wires can be at least 2 millimeters. The largest of a length and a width of the 3D plane can be at least about 2 millimeters. The smaller of a length and a width of the 3D plane can be at least about 2 millimeters. The at least two spaced apart wires can be spaced at least 1.5 millimeters apart. The spaced apart 3D planes are spaced at least about 1.5 millimeters apart. The spaced apart value may be the shortest distance between the 3D planes.

In another aspect, a surface cleaning method comprises directing an energy beam to a part of a 3D object printed by at least one added manufacturing method; wherein the 3D object comprises a material; and breaking down or evaporating a substance on the surface of the 3D object that is different from the material that is disposed at the interior of the 3D object. The at least one added manufacturing method may comprise selective laser melting. The material can comprise an elemental metal, metal alloy, ceramic or elemental carbon. The material can comprise a metal alloy. The substrate can be chemically different from the material. The substrate can be chemically related to the material. The substrate can be an oxide of the material. The substrate can be a product of a reaction between a material and a gas. The gas may comprise oxygen or water. The gas may comprise the elements oxygen, sulfur, nitrogen, phosphorous, or hydrogen. The gas may comprise a halogen. The substance can comprise an oxide, a sulfide, a nitride, or a carbide of the material. The material can comprise an alloy of iron, titanium, nickel, or aluminum. The material can comprise stainless steel. The stainless steel can be surgical steel. The stainless steel can be 316L stainless steel. The stainless steel can be 360L stainless steel.

In some examples, the energy beam can comprise an electromagnetic beam, an electron beam, a plasma beam, or an ionic beam. The energy beam can comprise an electromagnetic beam or a laser beam. The energy beam can comprise energy per unit area that is insufficient to transform the material. “Transform” may be fuse, bond, or connect the pre-transformed material. The process of transforming may comprise fusing, bonding, or connecting the material (e.g. layer of material, deposited material, liquid material, or powder material). The process of fusing can comprise melting (e.g., complete melting), or sintering. The energy beam may have energy per unit area of at least about 0.1 Joule per Millimeter Square (J/mm²). The energy beam can have energy per unit area of at least about 0.3 J/mm². The energy beam can have energy per unit area of at most about 2 J/mm². The energy beam may have energy per unit area of at most about 1.2 J/mm².

In some instances, the methods may be performed in an inert atmosphere. The methods may be performed in an oxygen-depleted atmosphere. The methods may be performed in a water-depleted atmosphere. The methods may be performed in a nitrogen-depleted atmosphere. The methods can be performed in a carbon dioxide depleted atmosphere. The methods may be performed in an atmosphere comprising hydrogen. The methods may be performed in an atmosphere comprising a safe concentration of hydrogen. The methods may be performed in an atmosphere comprising at least about 0.1% (volume by volume) hydrogen at ambient pressure. The methods may be performed in an atmosphere comprising at least about 0.1% (volume by volume) hydrogen at ambient pressure and temperature. The methods may be performed in an atmosphere comprising at most about 4% (volume by volume) hydrogen at ambient pressure (e.g., and ambient temperature). The breaking down can comprise breaking of chemical bonds. The breaking down can comprise breaking of covalent bonds. The breaking down can comprise breaking of metallic bonds. The breaking down can comprise breaking of ionic bonds.

In some embodiments, the 3D object printed by at least one added manufacturing methodology is devoid of auxiliary support and auxiliary support mark. The 3D object printed by at least one added manufacturing methodology can comprise a layering plane N; wherein X and Y are points residing on the surface of the object, wherein X is spaced apart from Y by at least about 2 millimeters; wherein the sphere of radius XY that is centered at Y lacks auxiliary support and auxiliary support mark, wherein the acute angle between the straight line XY and the direction of normal to N is from about 45 degrees to about 90 degrees. The object may have a material structure indicating that it has been formed at an average plane that at an average angle of at most about 45 degrees normal to the field of gravity. The at least one added manufacturing method may comprise selective laser melting.

In another aspect, a 3D object comprises a first layer of hardened material (e.g., transformed material and/or solid material) comprising spaced-apart sections; wherein the spaced apart sections comprise first successive regions of hardened material indicative of an additive manufacturing process; a second layer of hardened material adjacent (e.g., above) to the first layer of material; wherein the second layer of hardened material comprise second successive regions of hardened material indicative of an additive manufacturing process; wherein the second layer connects the spaced apart sections to form at least a part of a 3D object; wherein a shortest distance between points X and Y on the surface of the at least a part of an object are devoid of auxiliary support and auxiliary support mark; wherein the shortest distance between points X and Y is at least about 1.7 millimeters; and wherein a material structure of the first or of the second successive regions of hardened material indicate that the successive regions of hardened material have been formed at an acute angle of about 45 degrees or less from a normal to the gravitational field.

In another aspect a 3D object comprises: a first layer of hardened material (e.g., solid material. E.g., transformed material) comprising spaced apart sections; wherein the spaced apart sections comprise successive regions of hardened material indicative of an additive manufacturing process; wherein a material structure of the successive regions of hardened material indicate that the spaced apart sections have been formed at an acute angle of about 45 degrees or less from a normal to the gravitational field; a second layer of material adjacent to the first layer of material; wherein the second layer connects the spaced apart sections to form at least a part of an object; wherein a shortest distance between points X and Y on the surface of the at least a part of a 3D object are devoid of auxiliary support and auxiliary support mark; and wherein the shortest distance between points X and Y is at least about 1.7 millimeters.

In another aspect, a 3D object comprises a first layer of hardened material comprising spaced apart sections; and a second layer of hardened material adjacent to the first layer of hardened material; wherein the second layer of hardened material comprises successive regions of hardened material indicative of an additive manufacturing process; wherein a material structure of the successive regions of hardened material indicate that the second layer of hardened material has been formed at an acute angle of about 45 degrees or less from a normal to the gravitational field; wherein the second layer connects the spaced apart sections to form at least a part of an object; wherein a shortest distance between points X and Y on the surface of the at least a part of an object are devoid of auxiliary support and auxiliary support mark; and wherein the shortest distance between points X and Y is at least about 1.7 millimeters.

In another aspect, a surface cleaning method comprises transforming a material in a container to form a 3D object by at least one added manufacturing method; directing an energy beam to at least a part of the 3D object; wherein the 3D object comprises a material; and breaking down or evaporating a substance on the surface of the 3D object that is different from the material. The at least one added manufacturing method can comprise selective laser melting.

In another aspect, a surface cleaning method comprises directing an energy beam to a pre-transformed material in a container; breaking down or evaporating a substance on the surface of the pre-transformed material that is different from the pre-transformed material by using the energy beam; and transforming at least a portion of the pre-transformed material to form a 3D object by utilizing at least one added manufacturing method. The at least one added manufacturing method can comprise selective laser melting. The pre-transformed material can comprise a powder material. The pre-transformed material can comprise elemental metal, metal alloy, ceramic, or elemental carbon. The method can further comprise leveling the top surface of the pre-transformed material prior to the transforming. The leveling operation may precede the breaking down. The leveling operation may succeed the breaking down. The leveling operation may be substantially contemporaneous with the breaking down.

In another aspect, an apparatus for cleaning a 3D object comprising: a container comprising a 3D object printed by at least one 3D printing (e.g. added manufacturing) method; and a stimulus capable of breakdown or evaporation of substance on the surface of the 3D object. The stimulus may comprise an energy beam. The energy beam may be directed to the 3D object. The at least one 3D printing method can comprise selective laser melting. The container can include a surface situated below the 3D object. The surface may include a non-planar feature that does not support (e.g., directly support) the 3D object. The surface may include a non-planar feature that does not anchor to (e.g., connect to) the 3D object.

In another aspect, a system for cleaning a 3D object comprises a container comprising a 3D object printed by at least one 3D printing (e.g., added manufacturing) method; an energy beam that is capable of breakdown or evaporation of substance on the surface of the 3D object, a control system that is in communication with the energy beam, wherein the control system regulates the energy supplied from the energy beam to the 3D object. The at least one added manufacturing method can include selective laser melting. The stimulus can be an energy beam. The container can comprise an atmosphere that is at least one of an inert, oxygen depleted, water depleted, nitrogen depleted, and a carbon dioxide depleted atmosphere. The container can comprise hydrogen gas. The at least one added manufacturing method may comprise selective laser melting. In some instances, the control system may further comprise a connection to at least one sensor. The sensor can comprise an optical sensor. The sensor can comprise a temperature sensor. The temperature sensor can comprise a contact temperature sensor or a non-contact temperature sensor. The temperature sensor can comprise an optical sensor. The temperature sensor can comprise an infrared sensor. The sensor can comprise a position sensor. The sensor can comprise a gas sensor. The sensor can comprise a chemical sensor. At times, the gas sensor can sense oxygen, nitrogen, carbon dioxide, water, argon, or hydrogen. In some instances, the chemical sensor can sense oxygen, sulfur, nitrogen, or carbon. The chemical sensor can sense at least breakdown components of the substance. The chemical sensor can sense at least evaporated substance or substance components. The chemical sensor can sense at least breakdown components of compounds comprising oxide, a sulfide, a nitride, or carbide of the material. Sometimes, the chemical sensor can sense evaporation components of compounds comprising oxide, a sulfide, a nitride, or carbide of the material. Regulation of the energy can comprise responding to input from the sensor. Responding can comprise responding manually or automatically. Responding can comprise responding according to a predetermined scheme. The control system can further comprise a processor (e.g., a Central Processing Unit “CPU”). The control system further can comprise a display system. The systems or the apparatus can comprise a valve. The control system further can comprise connection to the valve. The control system can control the valve. For example, the control system can control the opening, closing or the degree of opening and closing of the valve. The systems and/or the apparatus described herein can comprise a pump. The control system can further comprise a connection to the pump. The control system can control the pump. The systems and/or the apparatus described herein can comprise a motor. The control system can further comprise a connection to the motor. The control system can control the motor. The motor can be an electric motor.

In another aspect, a system for printing at least one 3D object, comprises: (a) a platform that accepts a material bed, wherein during use, at least a portion of the material bed is used to generate at least one 3D object (e.g., 3D plane or wire), wherein the material bed is adjacent to the platform; (b) a generation device used to generate the 3D object under at least one formation parameter using 3D printing, wherein the generation device is disposed adjacent to the material bed; and (c) a controller comprising a processing unit that is programed to direct the formation of the 3D object according to any of the methods disclosed herein. The generation device may be the energy source. The generation device can comprise a first energy beam or a material bed. The generation device can comprise a scanner. The generation device can comprise a layer dispensing mechanism or a heat sink. The system may further comprise a second energy beam. The first and second energy beam may differ in at least one energy beam characteristics (e.g., power per unit area, speed, focus, or cross section). The control may comprise feedback control.

In another aspect, an apparatus for printing one or more 3D objects (e.g. 3D plane and/or a wire) comprises a controller that is programmed to direct a mechanism used in a 3D printing methodology to implement (e.g., effectuate) any of the method disclosed herein, wherein the controller is operatively coupled to the mechanism. The control may comprise feedback control.

Another aspect of the present disclosure provides systems, apparatuses, controllers, and/or non-transitory computer-readable medium (e.g., software) that implement any of the methods disclosed herein.

In another aspect, a computer software product, comprising a non-transitory computer-readable medium in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism.

Another aspect of the present disclosure provides a non-transitory computer-readable medium comprising machine-executable code that, upon execution by one or more computer processors, implements any of the methods disclosed herein.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “Figs” herein), of which:

FIGS. 1A-1F illustrate various path configurations for the formation of a wire and a 3D plane of the present disclosure;

FIG. 2 illustrates a schematic of the printing system;

FIG. 3 schematically illustrates a computer control system that is programmed or otherwise configured to facilitate the formation of one or more objects, such as a wire or a 3D plane;

FIGS. 4A-4B schematically illustrate examples of a wire and a 3D plane;

FIGS. 5A-5B schematically illustrate examples of vertical cross sections of an object comprising two layers;

FIG. 6 schematically illustrates an example of a wire;

FIGS. 7A-7C show examples of wires;

FIG. 8 schematically illustrates an example of a 3D plane;

FIGS. 9A-9C show examples of 3D planes;

FIG. 10 shows a 3D plane prior to cleaning, and 3D planes after cleaning;

FIGS. 11A-11B illustrate examples of planer objects;

FIG. 12 shows a vertical cross section of a single-layer in a formed 3D object;

FIG. 13 shows a vertical cross section of a formed 3D object e comprising a first and a second layer;

FIG. 14 illustrates an example of a printed 3D object on which points X and Y are schematically marked, as well as the shortest distance XY and a circle with a radius XY;

FIG. 15A schematically illustrates a plane and line diagram; FIG. 15B shows a formed 3D object comprising multiple planes at various angles;

FIG. 16 shows a vertical cross section of an object printed by 3D printing comprising an auxiliary support;

FIG. 17 Illustrate various vertical cross sections of planes;

FIG. 18 Illustrate various views of rings in a material bed;

FIG. 19 Illustrate various views of rings;

FIG. 20 show various manners of forming an object (e.g., a wire);

FIG. 21 show various manners of forming an object (e.g., a wire);

FIG. 22 shows a schematic graph depicting the temperature as a function of time;

FIGS. 23A-23D show horizontal views of manners of forming an object (e.g., a 3D plane);

FIGS. 24A-24C show various 3D objects;

FIGS. 25A-25D show various 3D objects; and

FIG. 26 schematically shows a cross section in portion of a 3D object.

The figures and components therein may not be drawn to scale. Various components of the figures described herein may not be drawn to scale.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a”, “an” and “the” are not intended to refer to only a singular entity, but include the general class of which a specific example may be used for illustration. The terminology herein is used to describe specific embodiments of the invention, but their usage does not delimit the invention.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2.

The term “adjacent” or “adjacent to,” as used herein, comprises ‘next to’, ‘adjoining’, ‘in contact with’, or ‘in proximity to.’

The term “anchorlessly,” as used herein, generally refers to without or in the absence of an anchor. In some examples, an object is suspended in a powder bed anchorlessly without attachment to a support. For example, the object floats in the powder bed.

Three-dimensional (3D) printing generally refers to a process for forming a 3D object. This process may be used to form the printed 3D object. For example, 3D printing may refer to sequential addition of material or joining of material to form structure, in a controlled manner (e.g., under automated control). In the 3D printing process, the deposited material is fused (e.g., sintered, or melted), bound, or otherwise connected to form at least a part of the desired object (e.g., 3D object). Fusing, welding, binding, or otherwise connecting the material is collectively referred to herein as transforming the material. The pre-transformed material can be a liquid material or a solid material (e.g., powder). The pre-transformed material can be in the form of a powder, wires, sheets, or vesicles. Fusing the material may refer to melting or sintering the material. The bound material can comprise chemical bonding. Chemical bonding can comprise covalent bonding. Examples of 3D printing include additive printing (e.g., layer by layer printing, or additive manufacturing), subtractive printing, or any combination thereof.

Pre-transformed material, as understood herein, is a material before it has been transformed during the 3D printing process. The transformation can be effectuated by utilizing an energy beam and/or flux. The pre-transformed material may be a material that was, or was not, transformed prior to its use in the 3D printing process.

3D printing methodologies can comprise extrusion, wire, granular, laminated, light polymerization, or power bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Power bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

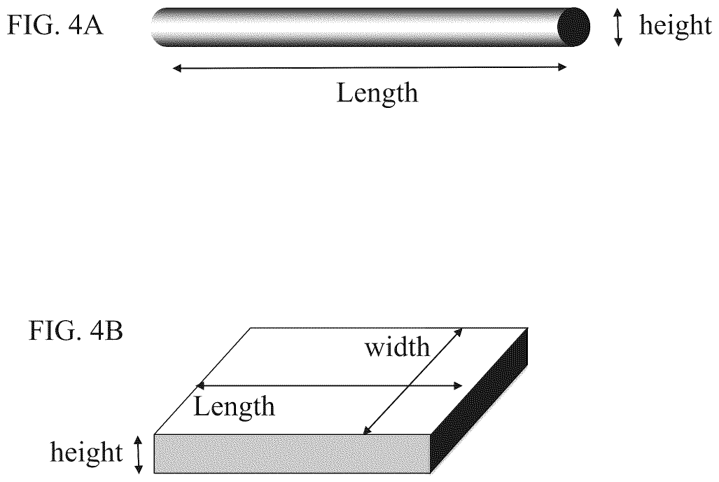

The present disclosure provides apparatuses, systems, methods and/or software for forming a 3D object using and/or effectuating at least one three-dimensional (herein “3D”) printing methodology. 3D printing methodologies may be employed for printing an object that is substantially two-dimensional, such as a wire or a planar object. The 3D object may comprise a plane like structure (referred to herein as “planar object,” “three-dimensional plane,” or “3D plane”). The 3D plane may have a relatively small width as opposed to a relatively large surface area. The 3D plane may have a relatively small height as opposed to a relatively width by length area. For example, the 3D plane may have a small height relative to a large horizontal plane. FIG. 4B shows an example of a 3D plane that is planar (e.g., flat). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface.

The 3D planes may be closely situated. For example, 3D planes may be turbine or impeller blades. The 3D planes may be attached to a common structure (e.g., a pole, column, or wall). The 3D planes may be perpendicular to the common structure. The 3D planes may (e.g., each) be at an angle with respect to the common structure, the direction of the gravitational field, and/or the platform. The angle may be alpha. The angle may be beta. The distance between two adjacent 3D planes within the multiplicity of planes may be at most about 100 cm, 50 cm, 10 cm, 5 cm, 4 cm, 3 cm, 2 cm, 1 cm, 7 mm, 5 mm, 4 mm, 3 mm, 2 mm, 1 mm, 700 μm, 500 μm, 300 μm, 200 μm, 100 μm, 50 μm, 30 μm, 20 μm, or 10 μm. The distance between two adjacent 3D planes may be the vertical distance of the gap (e.g., as disclosed herein. Also referred to herein as “vertical gap distance”). The distance between two adjacent 3D planes within the multiplicity of planes may be any value between the aforementioned values (e.g., from about 100 cm to about 10 μm, from about 100 cm to about 5 cm, from about 5 cm to about 1 mm, from about 1 mm to about 200 μm, from about 300 μm to about 50 μm, or from about 50 μm to about 10 μm). The two adjacent 3D planes may have a gap between then. The gap may be free of transformed (e.g., and subsequently hardened) material. The gap may be free of any portion of a 3D object. The gap may comprise pre-transformed material. The gap may comprise a remainder of the material bed. The gap may be devoid of auxiliary support. At least a portion of the 3D planes may be (e.g., substantially) perpendicular to the direction of the gravitational field. At least a portion of the 3D planes may form an acute angle of at least 45°, 55°, 60°, or 65° with the direction of the gravitational field (e.g., during their generation). At least a portion of the 3D planes may form an acute angle of at most 25°, 30°, 35°, or 45° with the platform and/or a plane perpendicular to the direction of the gravitational field (e.g., during their generation).

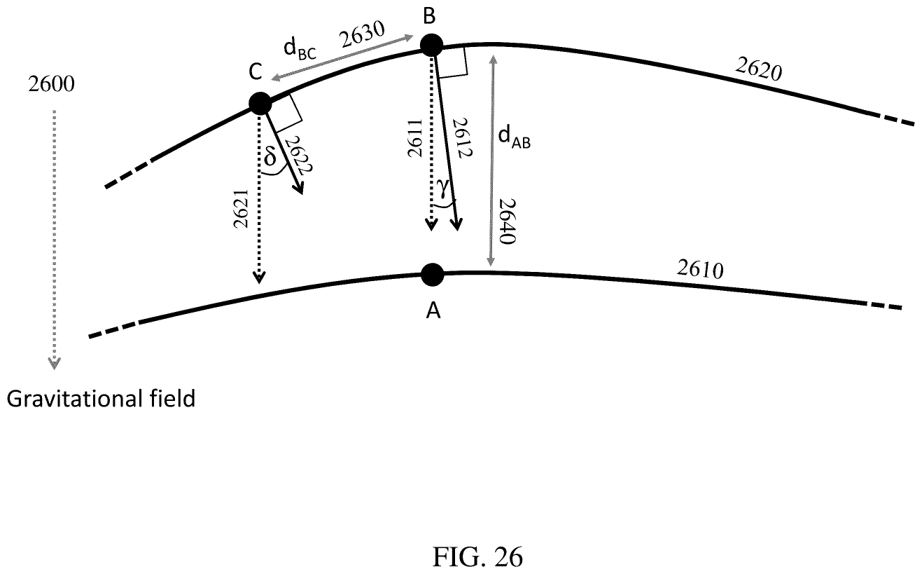

In some embodiments, the 3D object of the present invention comprises a first portion and a second portion. The first portion may be connected to the rest of the 3D object at one, two, or three sides (e.g., as viewed from the top). The second portion may be connected to the rest of the 3D object at one, two, or three sides (e.g., as viewed from the top). For example, the first and second portion may be connected to a (e.g., central) column, post, or wall of the 3D object. For example, the first and second portion may be connected to an external cover that is a part of the 3D object. The first and/or second portion may be a wire or a 3D plane. The first and/or second portion may be different from a wire or 3D plane. The first and/or second portion may be a blade (e.g., turbine or impeller blade). The first portion may comprise a top surface. Top may be in the direction away from the platform and/or opposite to the gravitational field. The second portion may comprise a bottom surface. Bottom may be in the direction towards the platform and/or in the direction of the gravitational field. FIG. 26 shows an example of a first (e.g., top) surface 2610 and a second (e.g., bottom) surface 2620. At least a portion of the first and second surfaces are separated by a gap. At least a portion of the first surface is separated by at least a portion of the second surface (e.g., to constitute a gap). The gap may be filled with pre-transformed or transformed (e.g., and subsequently hardened) material. FIG. 26 shows an example of a vertical gap distance 2640 that separates the first surface 2610 from the second surface 2620. The vertical gap distance may be equal to the distance disclosed herein between two adjacent 3D planes. The vertical gap distance may be equal to the vertical distance of the gap as disclosed herein.

Point A may reside on the top surface of the first portion. Point B may reside on the bottom surface of the second portion. Point B may reside above point A. The gap may be the (e.g., shortest) distance (e.g., vertical distance) between points A and B. FIG. 26 shows an example of the gap 2640 that constitutes the shortest distance d_{AB} between points A and B. There may be a first normal to the bottom surface of the second portion at point B. FIG. 26 shows an example of a first normal 2612 to the surface 2620 at point B. The angle between the first normal 2612 and a direction of the gravitational acceleration vector 2600 (e.g., direction of the gravitational field) may be any angle γ. Point C may reside on the bottom surface of the second portion. There may be a second normal to the bottom surface of the second portion at point C. FIG. 26 shows an example of the second normal 2622 to the surface 2620 at point C. The angle between the second normal 2622 and the direction of the gravitational acceleration vector 2600 may be any angle δ. Vectors 2611, and 2621 are parallel to the gravitational acceleration vector 2600. The angles γ and δ may be the same or different. The angle between the first normal 2612 and/or the second normal 2622 to the direction of the gravitational acceleration vector 2600 may be any angle alpha. The angle between the first normal 2612 and/or the second normal 2622 with respect to the normal to the substrate may be any angle alpha. The angles γ and δ may be any angle alpha. For example, alpha may be at most about 45°, 40°, 30°, 20°, 10°, 5°, 3°, 2°, 1°, or 0.5°. The shortest distance between points B and C may be any value of the spacing-distance mentioned herein. For example, the shortest distance BC (e.g., d_{BC}) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm, 35 mm, 40 mm, 50 mm, 100 mm, 200 mm, 300 mm, 400 mm, or 500 mm. As another example, the shortest distance BC may be at most about 500 mm, 400 mm, 300 mm, 200 mm, 100 mm, 50 mm, 40 mm, 35 mm, 30 mm, 25 mm, 20 mm, 15 mm, 10 mm, 5 mm, 4 mm, 3 mm, 2 mm, 1.5 mm, 1 mm, 0.5 mm, or 0.1 mm. FIG. 26 shows an example of the shortest distance BC (e.g., 2630, d_{BC}).

Some of the apparatuses, methods, systems, and/or software described herein pertain to the formation (e.g., printing) of a wire or a 3D plane using any 3D printing methodology. The wire may be a starting point for the formation of the 3D plane. The 3D plane may be an extension of the wire. The height of the 3D plane may be smaller as compared to the height of the wire. FIG. 4A shows a schematic example of a wire indicating its length and height. FIG. 4B shows a schematic example of a 3D plane indicating its length, width and height.

The FLS of the cross section of the wire (e.g., height of the wire, FIG. 4A) may be larger than the average (or mean) height of the 3D plane that is an extension of that wire. The height of the wire (e.g., average or mean height thereof) may be at least about 5%, 10%, 20%, 30%, 40%, 50%, or 60% larger than the average or mean height of the 3D plane that is an extension of that wire. The height of the wire (e.g., average or mean height thereof) may be at most about 1%, 5%, 10%, 20%, 30%, 40%, 50%, or 60% larger than the average or mean height of the 3D plane that is an extension of that wire. The height of the wire may be any value between the aforementioned values, as compared to the height of the 3D plane (e.g., from about 1% to about 60%, from about 5% to about 30%, from about 1% to about 5%, from about 1% to about 10%, or from about 1% to about 20%). At times, the rim of the 3D plane may be larger than the average (or mean) height of the interior of the 3D plane by any of the aforementioned amount regarding the height of the wire as compared to the 3D plane. The interior of the 3D plane may exclude the rim.

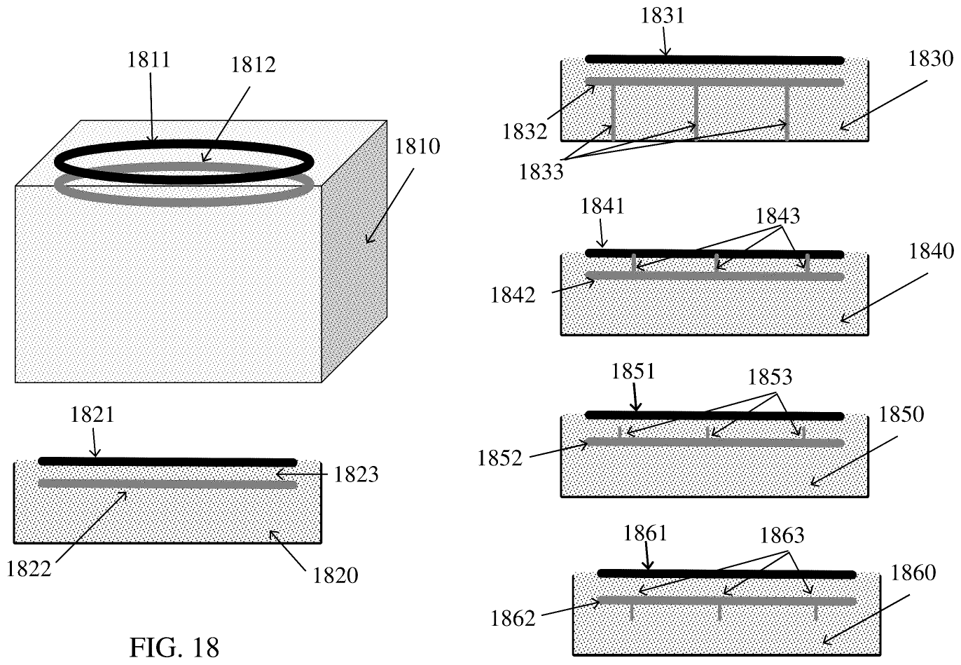

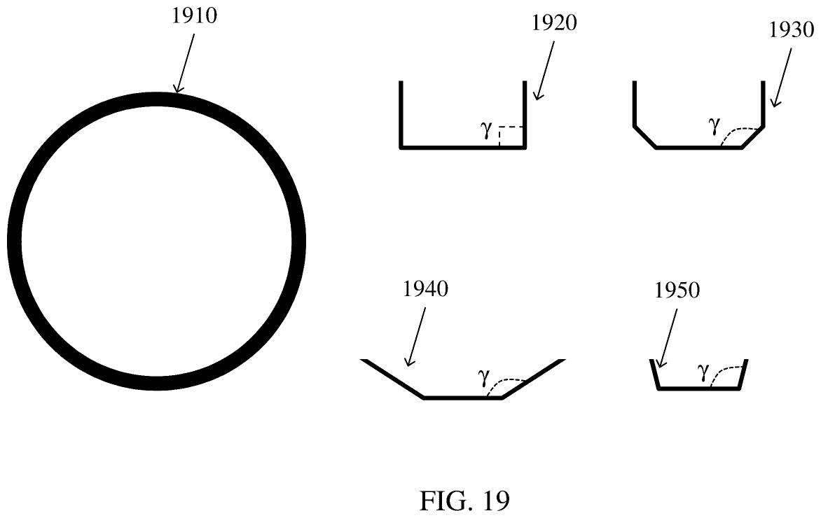

In some embodiments, the wire may form a geometrically closed 3D structure (e.g., a ring). FIG. 19 shows an example of a top view of a ring 1900. In some embodiments, one or more wires may form a closed 3D structure (e.g., a ring). The formed 3D object may be a closed 3D structure (e.g., a ring) that is suspended (e.g., floating anchorlessly) in the material bed (e.g., during its generation). In some instances, a first closed 3D structure and a second closed 3D structure are formed in the material bed. The first closed 3D structure may be the desired closed 3D structure. The second closed 3D structure may an undesired (e.g., sacrificial) closed 3D structure. FIG. 18 shows an example of a first ring 1811 and a second ring 1812 that are both suspended (e.g., floating anchorlessly) in a material bed 1800. Material bed 1820 is an example of a side view of material bed 1800, showing the first ring 1821 and the second ring 1822. The first closed 3D structure may be separated from the second closed 3D structure by one or more layers of pre-transformed material. The shape of the first closed 3D structure may be (e.g., substantially) identical or different from the second closed 3D structure. At least one of the first closed 3D structure and the second closed 3D structure may be formed as suspended object in the material bed. For example, both may be formed as suspended 3D objects in the material bed throughout their formation process (e.g., as shown in the example of the rings in material bed 1820). The average plane of the first closed 3D structure and/or the second closed 3D structure may be parallel to the platform, and/or to a plane normal to the gravitational force. In some instances, the first closed 3D structure is anchored to the enclosure (e.g., platform), while the second closed 3D structure is formed as a floating (e.g., anchorlessly) object that is suspended in the material bed. FIG. 18 shows an example of material bed 1830 having a first ring 1831 floats anchorless in the material bed, while the second ring 1822 is anchored to the enclosure (e.g., platform) with auxiliary supports 1833. In some instances, a first closed 3D structure may be a sacrificial closed 3D structure. The first closed 3D structure may be deformed or substantially non-deformed, as compared to a model (e.g., desired structure). The second closed 3D structure may be substantially non-deformed, as compared to its model (e.g., desired structure). The first and second closed 3D structure may be connected (e.g., with auxiliary supports) to each other and/or to the enclosure (e.g., to a side or to the platform). The first and second closed 3D structure may be connected, and their joint structure may be floating anchorlessly in the material bed throughout their formation process. FIG. 18 shows an example of material bed 1840 having a first ring 1841 is connected to the second ring 1842 with auxiliary supports 1843, while the combined structure of the first ring and the second ring is floating anchorlessly in the material bed 1840. The first closed 3D structure may comprise protrusions that are pointed to the second closed 3D structure, but do not connect to the second closed 3D structure. The first closed 3D structure protrusions can in some instances connect to the second closed 3D structure. The protrusions of the first closed 3D structure can in some instances touch, but not connect to the second closed 3D structure. FIG. 18 shows an example of material bed 1850 having a first ring 1851 floats anchorless in the material bed; while the second ring 1852 comprises protrusions 1833 that point towards the first ring 1851 but do not connect to the first ring. The protrusion of the second closed 3D structure can point downwards (e.g., towards the platform). The protrusions of the second closed structure can constitute auxiliary supports. The protrusion of the first closed 3D structure can constitute weights. The second closed 3D structure may constitute an auxiliary support to the first closed 3D structure. The second closed 3D structure may be removed after the end of the 3D printing process. For example, the second closed 3D structure may be removed by a further treatment process. The protrusions of the second closed 3D structure can constitute auxiliary supports that are not anchored to the platform (e.g., during formation of the 3D structure). The non-anchored auxiliary supports can contact the platform (e.g., but not connect to the platform). FIG. 18 shows an example of material bed 1860 having a first ring 1861 and a second ring 1862, which second ring comprises auxiliary supports 1863 that point towards the bottom of the powder bed, while the combined structure of the first ring and the second ring (comprising the auxiliary supports) is floating anchorlessly in the material bed 1860. The second closed 3D structure may comprise any auxiliary support structure disclosed herein.

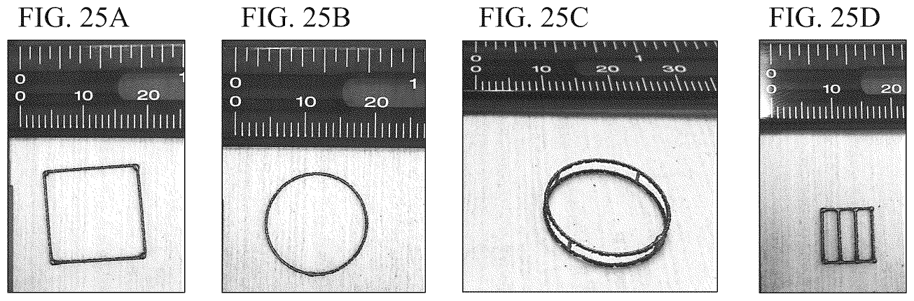

The closed 3D structure (e.g., first and/or second) may have a FLS (e.g., diameter) of at least about 1 cm, 5 cm, 10 cm, 20 cm, 30 cm, 40 cm, 50 cm, 60 cm, 70 cm, 80 cm, 90 cm, 1 m, 1.5 m, 2 m, 2.5 m, or 3 m. The ring (e.g., first and/or second) may have a FLS (e.g., diameter) of at most about 1 cm, 5 cm, 10 cm, 20 cm, 30 cm, 40 cm, 50 cm, 60 cm, 70 cm, 80 cm, 90 cm, 1 m, 1.5 m, 2 m, 2.5 m, or 3 m. The closed 3D structure (e.g., first and/or second) may have a FLS (e.g., diameter) between any of the aforementioned values (e.g., from about 1 cm to about 50 cm, from about 50 cm to about 1 m, from about 1 cm to about 3 m, or from about 1 m to about 3 m). The closed 3D structure may have a surface that is substantially planar (e.g., flat). The closed 3D structure may have at least one edge (e.g., fringe) at an angle gamma “y” relative to the plane of the ring. FIG. 19 shows various examples of the angle gamma in possible vertical cross sections (e.g., 1910, 1920, 1930, and 1940) of the ring 1900 that is represented as a top view. The angle gamma may be at an obtuse angle with the plane of the ring. The edge angle gamma may be at least about 90°, 100°, 110°, 120°, 130°, 140°, 150°, 160°, 170°, or 179°. The edge angle gamma may be at most about 91°, 100°, 110°, 120°, 130°, 140°, 150°, 160°, 170°, or 179°. The edge angle gamma may between the above-mentioned edge angles (e.g., from about 90° to about 180°, from about 90° to about 140°, or from about 130° to about 179°). The first closed 3D structure may be a sacrificial supportive surface for the second closed 3D structure. The closed 3D structure may have a rotational symmetry axis (e.g., C₂ axis) perpendicular to the platform while situated in the material bed (e.g., during its formation). The closed 3D structure may have a rotational symmetry axis (e.g., C₂ axis) parallel to the field of gravity while situated in the material bed (e.g., during its formation). The second closed 3D structure may be the desired closed 3D structure. The aim of printing the first and second closed 3D structures may be to retrieve the second closed 3D structure. The first closed 3D structure may aid in (e.g., facilitate) supporting the second closed 3D structure in the material bed. The second closed 3D structure may be a part of a multiplicity of connected closed 3D structures comprising a hollow interior. The multiplicity of closed 3D structures may or may not be concentric. FIG. 25A shows an example of a second closed 3D structure that is rectangular. FIG. 25B shows an example of a second closed 3D structure that is circular. FIG. 25C shows an example of a second closed 3D structure that comprises two connected rings. FIG. 25C shows an example of a second closed 3D structure that comprises three connected rectangles.

The first 3D structure may be separated from the second 3D structure by a gap. FIG. 18 shows an example of a gap 1823 between the first ring 1821 and the second ring 1822. The vertical distance of the gap from the bottom surface (e.g., average or mean thereof) of the first closed 3D structure to the top surface (e.g., average or mean thereof) of the bottom closed 3D structure may be at least about 10 μm, 11 μm, 12 μm, 13 μm, 14 μm, 15 μm, 16 μm, 17 μm, 18 μm, 19 μm, 20 μm, 25 μm, 30 μm, 35 μm, 40 μm, 45 μm, 50 μm, 60 μm, 70 μm, 80 μm, 90 μm, 100 μm, 200 μm, or 300 μm, 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, or 500 mm. The vertical distance of the gap from the bottom surface (e.g., average or mean thereof) of the first closed 3D structure to the top surface (e.g., average or mean thereof) of the bottom closed 3D structure may be at most about 10 μm, 11 μm, 12 μm, 13 μm, 14 μm, 15 μm, 16 μm, 17 μm, 18 μm, 19 μm, 20 μm, 25 μm, 30 μm, 35 μm, 40 μm, 45 μm, 50 μm, 60 μm, 70 μm, 80 μm, 90 μm, 100 μm, 200 μm, or 300 μm, 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm or 500 mm. The vertical distance of the gap from the bottom surface (e.g., average or mean thereof) of the first closed 3D structure to the top surface (e.g., average or mean thereof) of the bottom closed 3D structure may be any value between the aforementioned values (e.g., from about 10 μm to about 0.5 mm, from about 10 μm to about 50 μm, from about 10 μm to about 100 μm, from about 10 μm to about 500 mm, from about 0.5 mm to about 500 mm, from about 0.5 mm to about 60 mm, or from about 40 mm to about 500 mm). The gap may be bridged at one or more positions to form a third closed 3D structure comprising a third hollow interior. The third closed 3D structure may be suspended (e.g., float anchorlessly) in the material bed. FIG. 18 shows an example of a Material bed 1840 in which a first ring 1841 is separated from the second ring 1842 by a gap that is bridged at a plurality of positions by auxiliary supports 1843, while the combined structure of the first ring and the second ring is floating anchorlessly in the material bed 1840.

The first closed 3D structure may comprise a bottom surface that faces the platform. The auxiliary supports (e.g., gap bridges) may connect to bottom surface of the first closed 3D structure. The second closed 3D structure may comprise a top surface that faces away from the platform. The auxiliary supports (e.g., gap bridges) may connect to top surface of the second closed 3D structure. The total area occupied by the contact positions of the auxiliary supports on the bottom surface of the first closed 3D surface and/or top surface of the second closed 3D surface may constitute at most about 50%, 40%, 30%, 20%, 10%, 5%, 1%, or 0.5% of the total surface area of the bottom surface of the first closed 3D surface and/or top surface of the second closed 3D surface respectively. The total area occupied by the contact positions of the auxiliary supports on the bottom surface of the first closed 3D surface and/or top surface of the second closed 3D surface may constitute any percentages between the abovementioned percentages of the total surface area of the bottom surface of the first closed 3D surface and/or top surface of the second closed 3D surface respectively (e.g., from about 50% to about 0.5%, from about 50% to about 20%, from about 20% to about 0.5%, or from about 10% to about 0.5%).

Pre-transformed material as understood herein is a material before it has been transformed by an energy beam and/or flux during the 3D printing process. The pre-transformed material may be a material that was, or was not, transformed prior to its use in the 3D printing process. The pre-transformed material may be a granular material (e.g., powder). For example, a pre-transformed material may be a powder material that is transformed by an energy beam to a fused (e.g., sintered or molten) material. The powder material may be a type of a pre-transformed material; and the sintered (or molten) material may be the respective transformed material. A pre-transformed material may be a liquid material that is transformed by an energy beam to a hardened material. The liquid material may be a type of a pre-transformed material; and the hardened material (e.g., solid or gel) may be the respective transformed material. The liquid material may be viscous. In an example, the pre-transformed material may be a semi-solid (e.g., gel) material that is transformed by an energy beam to a solid material. In an example, the semi-solid material may be a type of a pre-transformed material, and the solid material may be the respective transformed material. The transformation may be chemical (e.g., crosslinking, or photo-polymerization). The transformation may be physical (e.g., melting).

The pre-transformed material may comprise aged pre-transformed material. The pre-transformed material may comprise recycled pre-transformed material. The pre-transformed material may comprise new pre-transformed material. The pre-transformed material may comprise recycled pre-transformed material and new pre-transformed material. The pre-transformed material (e.g., powder) may undergo a cleaning method to remove material comprising oxides, oxygen, or water. The cleaning method may be performed prior to, contemporaneous, or subsequent to deposition of the pre-transformed material in the enclosure (e.g., container). The cleaning method may be performed prior to, contemporaneous, or subsequent to transformation of the pre-transformed material in the enclosure (e.g., to form the material bed).

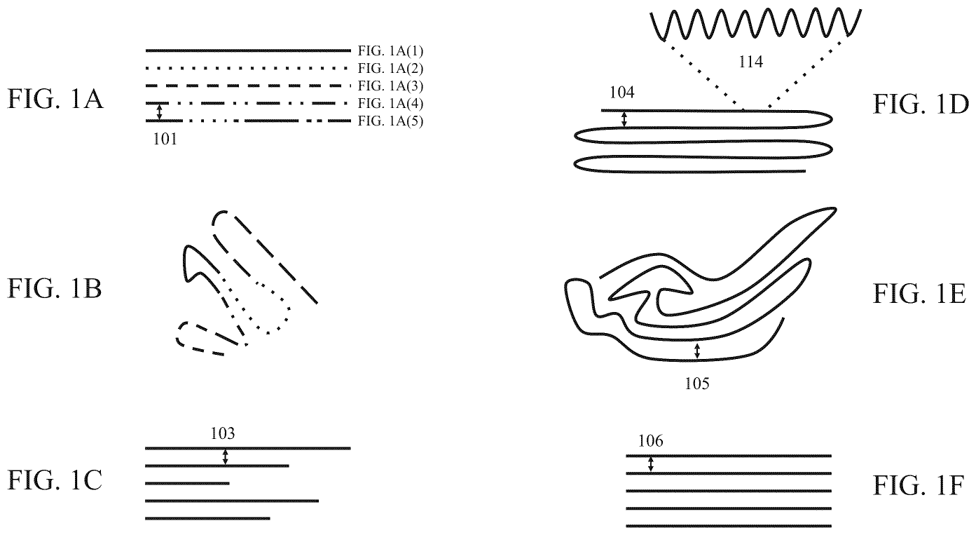

An aspect of the present disclosure provides a method for forming a wire comprising depositing a layer of pre-transformed material in an enclosure (e.g., a container) to form a material bed; forming a wire comprising transformed material (e.g., from the layer of material) according to a path; wherein the wire is suspended in the material bed. Sometimes, the wire may be suspended in the layer of pre-transformed material, and/or in a previously deposited layer of pre-transformed material. Suspended may be anchorlessly floating without attaching itself to the enclosure (e.g., platform). The path may be predetermined. The path may comprise one hatching. The path may comprise a plurality of hatchings. In one embodiment described herein is a method for forming a 3D plane comprising depositing (e.g., spreading) a layer of pre-transformed material in an enclosure (e.g., a container) to form a material bed; forming a wire comprising transformed material according to a path; wherein the wire is suspended in the material bed; and broadening the wire according to a path to form a 3D plane that is suspended in the material bed. The material bed may be a powder bed. The material bed may be a liquid bed. The path may be predetermined. FIGS. 1A-1F show examples of various path schematics for the formation of a wire and/or a 3D plane. The 3D plane can be further broadened to form a broadened 3D plane. The broadened 3D plane may be suspended in the material bed. The pre-transformed material may be a pulverized material. The pre-transformed material may comprise elemental metal, metal alloy, ceramic, or carbon. The printed 3D object (e.g., wire, or 3D plane) can be suspended (e.g., anchorlessly floating) in a portion of the material bed that is not used to form the printed 3D object. The portion of material bed that is not used to form the printed 3D object may be a remainder. In some instances, the remainder does not form a rigid structure over a distance of at least about 0.2 millimeters (mm), 0.5 mm, 0.8 mm, 1 mm, 1.2 mm, 1.5 mm, 1.7 mm, 2 mm, 2.2 mm, 2.5 mm, 2.7 mm, 3 mm, or 5 mm. The remainder may not form a rigid structure over any distance between the afore-mentioned rigid structure distances (e.g., from about 0.2 mm to about 5 mm, from about 0.5 mm to about 2 mm, or from about 2 mm to about 5 mm). The hardened (e.g., rigid) structure may comprise fused (e.g., lightly fused), connected, or caked (e.g., as in powder caking) material. The reminder may be devoid of a scaffold that encloses (e.g., fully or partially encloses) the 3D object. The continuous structure may comprise fused, connected, or caked material. In some instances, the remainder does not comprise a supportive structure. The remainder may be devoid of a supportive structure. The supportive structure may have any characteristics of the rigid structure disclosed herein. The supportive structure (e.g., rigid structure) may be one that is able support the printed 3D object. The rigid (e.g., continuous) structure should may support the printed 3D object.

In some examples, the methods described herein do not comprise forming a supportive structure (e.g., rigid structure) from the pre-transformed (e.g., powder) material before or contemporaneous with the formation of the wire, the 3D plane, or the broadened 3D object. In some examples, the methods described herein do not comprise forming a continuous structure from the pre-transformed material prior to the formation of the wire, the 3D plane, or the broadened 3D object. In some example, the methods described herein do not comprise fusing, caking, or sintering the powder material before the formation of the wire, the 3D plane, or the broadened 3D object.

The transformed material can be a fused, bound, or connected material. The transformed material may be a hardened material. Hardened may be solid, semi-solid, or gel. The transformed material may be at least partially liquid. The transformed material may be entirely liquid. The fused material may be a molten material (e.g., entirely or partially molten). The fused material may be a sintered material. The fused material may be a melted, or sintered material.

The wire and/or 3D plane may be formed according to a model of an object. The model may be of a 3D object or two-dimensional (herein “2D”) object. The 3D plane may correspond to a 3D plane in the model of the object (e.g., desired object). The 3D plane may correspond to a 2D object. The wire may correspond to a part of the 3D, or to a part of the 2D model of a desired object. The 3D plane may be an external plane of the 3D object or an internal plane (e.g., of a cavity) within a 3D object. The 3D plane may be a reef, ridge, shelf, or ledge (e.g., a blade).

Described herein is formation and/or broadening the wire. The formation and/or broadening may comprise projecting energy onto the material and thereby transforming at least a portion of the material bed. The energy may be radiative energy. The energy may be projected by an energy beam. The energy beam may be generated by an energy source. The energy beam may follow a (e.g., predetermined) path. The path may comprise a linear or oscillating pattern (e.g., zigzag pattern). The path may comprise a wave (e.g. sine or cosine wave) pattern. For example, any of the straight lines in FIG. 1C or FIG. 1F may comprise an oscillating (e.g., zigzag) path such that on average, the line may appear as a straight line. Any of the lines in FIG. 1C or FIG. 1F may comprise an oscillating path such that at a lower resolution, the line may appear as a straight line. An example for an oscillating path is schematically illustrated in the blow-up portion of FIG. 1D: 114. Any of the paths in FIGS. 1A-1F may comprise an oscillating path. FIG. 1A shows examples of five different straight paths. Each of the path can be a wire. Each of the path may correspond to a hatching within a 3D plane. FIG. 1B shows an example of a path; FIG. 1C and FIG. 1F show examples of parallel disconnected paths (e.g., for the formation of a 3D plane or a broadened 3D plane); FIG. 1D shows an example of parallel connected paths (e.g., for the formation of a 3D plane or a broadened 3D plane); and FIG. 1D shows an example of connected paths (e.g., for the formation of a 3D plane or a broadened 3D plane).

The wire may comprise an angle. The angle may be a planar angle (e.g., a mitered angle). The angle may be a non-planar angle. The angle may be a three-dimensional angle. The angle may be a compound angle. The wire may comprise a curvature. The wire may comprise a helix.

The 3D plane may be connected at one end. The connection may be to an auxiliary support. The connection may be to a structure that is a portion of the 3D object. The structure may be a vertical structure. The structure may be a column, post, or wall. The vertical structure may be an auxiliary support. The 3D plane may be a portion of a 3D object. The 3D plane may be a blade (e.g., a turbine blade).

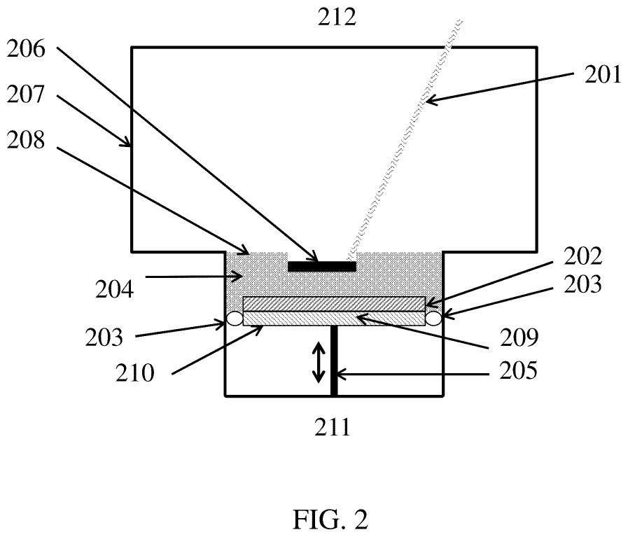

The methods described herein can be performed in an enclosure (e.g., chamber). An example of an enclosure is shown in FIG. 2, 207. The enclosure may have a predetermined and/or controlled pressure. The enclosure may have an ambient pressure (e.g., 1 atmosphere). The enclosure may have a predetermined and/or controlled atmosphere.

Broadening of the wire (e.g., into a 3D plane) may utilize one or more energy beams. The broadening may comprise utilizing a first energy beam and/or a second energy beam. FIG. 2 shows an example of an energy beam 201 projected on to a material 208 contained within a container 204. The broadening may comprise utilizing a plurality of energy beams. The broadening may comprise utilizing an array of energy beams. At least two of the energy beams may have the same characteristics (e.g., substantially the same). At least two of the energy beams may differ in at least one energy beam characteristics. The energy beam characteristics may comprise the energy beam flux, energy density, power per unit area, wavelength, amplitude, power, travel rate, travel time, traveling path, focus, defocus, FLS of the cross-section, or pulsing frequency (if any).

Forming the 3D object may comprise maintaining the material bed at substantially constant temperature throughout the formation of the wire, 3D plane, broadened 3D plane, and/or 3D object (collectively referred to herein as the “formed 3D object” or the “printed 3D object”). Forming the 3D object may comprise maintaining the material bed at an average constant temperature throughout the formation of the formed 3D object. Maintaining the material bed temperature may comprise maintaining the material bed (e.g., remainder of the powder bed that didn't transform to form the 3D object) at a median or mean temperature that is substantially constant throughout the formation of the formed 3D object. The substantially constant temperature can be an ambient temperature, a cryogenic temperature, below ambient temperature, or above ambient temperature. Ambient temperature may be surrounding temperature. Ambient temperature may be room temperature. Ambient temperature may be a temperature at which a human can live. Ambient temperature may be a temperature naturally prevalent on earth (e.g., in habitable areas). The constant temperature can be a temperature below (e.g., just below) a transformation temperature of the pre-transformed material.

Ambient refers to a condition to which people are generally accustomed. For example, ambient pressure may be 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be a typical temperature to which humans are generally accustomed. For example, from about 15° C. to about 30° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a space ship, a ship, a boat, or any other vehicle.

The enclosure (e.g., container) may comprise a platform. The platform may comprise a substrate and/or a base FIG. 2, 209 shows an example of a substrate. The substrate may have a face that points away from the material bed (e.g. towards the bottom of the enclosure 211), and a face that points towards the material bed 204. The enclosure may comprise a base (e.g., FIG. 2, 202). The base may have a face that points away from the material bed, and a face that points towards the material bed. The face may be a plane or a surface. Towards the material bed may be towards the top of the enclosure 212. Away from the material bed may be towards the bottom of the enclosure 211. The base may be situated adjacent to (e.g., above) or on the substrate (e.g., directly on the substrate). The container and/or platform (e.g., base and/or substrate) may be replaceable or non-replaceable. The container and/or platform (e.g., base and/or substrate) may be removable or non-removable. The container and/or platform (e.g., substrate and/or base) may have any geometrical or random shape. For example, the container and/or platform (e.g., substrate and/or base) may have a triangular, elliptical (e.g., circular), rectangular (e.g., square), hexagonal, or a heptagonal shape.

The printed 3D object may be formed on the platform (e.g., base). FIG. 2 shows an example of an object 206 formed above a base 202. The formed 3D object may be generated above the platform. The platform (e.g., base) may be planar or non-planar. The platform (or any part thereof such as the substrate and/or the base) may be detachable, transferrable, removable, or stationary. For example, the base may be detachable from the substrate. The base may be fastened on to the substrate. The base may be removably attached to the substrate. The base may have an upper surface for supporting the printed 3D object. The base may have a layer of pre-transformed material (e.g., powder material) that separates the printed 3D object from the base. The printed 3D object may be suspended (e.g., float anchorlessly in the material bed) adjacent to the platform; for example, suspended above the base.

The pre-transformed (e.g., powder) material may be deposited in an enclosure (e.g., a container). The enclosure can contain the pre-transformed material (e.g., without spillage). The pre-transformed material may be layered (e.g., spread, and/or disposed) in the enclosure to form a material bed. The enclosure may comprise a platform. The material may be layered directly on a side of the enclosure (e.g., the bottom of the enclosure). The material may be layered adjacent to (e.g., above) the bottom of the container. The material may be layered adjacent to (e.g., above) the platform. The substrate may have seals to enclose the material in a selected area within the enclosure. Examples for seals are depicted in FIG. 2, 203. The seals may be flexible or non-flexible. The seals may comprise a polymer or a resin. The seals may comprise a round edge or a flat edge. The seals may be bendable or non-bendable. The seals may be stiff. The container may contact the platform, or may be a part of the platform. The platform may be situated within the enclosure. The platform may be part of the enclosure. The platform may be substantially horizontal, substantially planar or non-planar. The platform (or any part thereof) may have a surface that comprises protrusions or indentations. The platform (or any part thereof) may have a surface that comprises embossing. The platform may have a surface that comprises supporting features. The platform may have a surface that comprises a mold. The platform may have a surface that comprises a wave formation. The surface may point towards the material bed. The wave may have an amplitude (e.g., vertical amplitude, or at an angle) that is outside the average plane of the platform. The platform may comprise a mesh through which the material is able to flow though. The opening of the mesh may be controlled (e.g., by a controller). The platform may comprise a motor. The platform may be fastened to the enclosure (e.g., walls thereof). The base may be fastened to the substrate. The substrate may be fastened to the enclosure. The platform (e.g., base and/or the substrate) may be transportable. The transportation of the platform may be controlled by a controller (e.g., control system). The platform may be transportable horizontally, vertically or at an angle.

The platform (or any portion thereof) may be transferable horizontally, vertically, or at an angle. The substrate may be vertically transferable, for example, using an elevator. FIG. 2, 205 shows an example of an elevation mechanism. The up and down arrow next to the elevation mechanism 205 signify an optional direction of movement of the elevation mechanism, or an optional direction of movement effectuated by the elevation mechanism.

The generated object may be formed substantially horizontally with respect to its natural position.

The natural position may be with respect to gravity (e.g., a stable position), with respect to everyday position of the desired object as intended (e.g., for its use), or with respect to a 3D model of the desired 3D object. The natural position may be with respect to gravity (e.g., a stable position), with respect to everyday position of the desired object as intended (e.g., for its use), or with respect to a 3D model of the desired 3D object. Tilted may be with respect to a model of the desired 3D object. In some instances, instructions may be given to the energy (e.g., energy beam) to transform the material within the material bed according to a path. The instructions may correspond to the desired 3D object that has been tilted from its natural position. The methods disclosed herein comprise printing a desired 3D object that has been tilted from its natural position. The methods disclosed herein comprise printing a tilted desired 3D object with respect to its natural position.

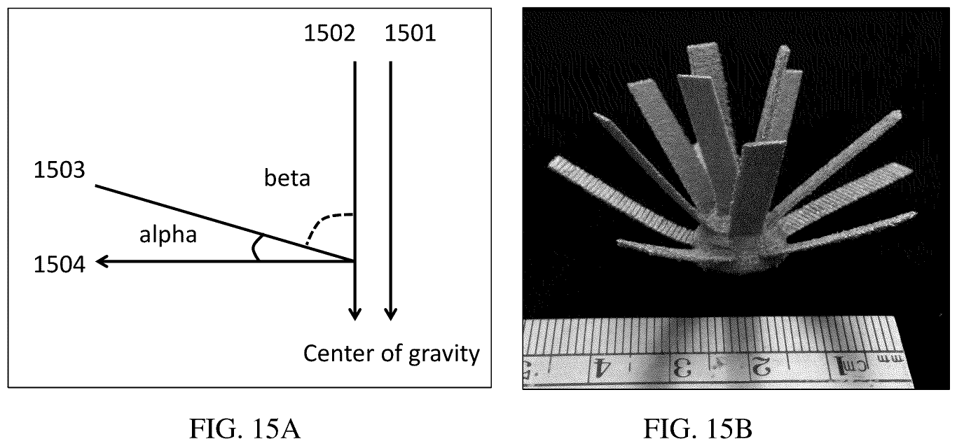

The formed 3D object may be formed as tilted from its natural position. The formed 3D object may be formed with an acute angle of 45 degrees (°), 40°, 35°, 30°, 25°, or less with the horizon, platform, or a plane perpendicular to the direction of the gravitational field. FIG. 15A shows a vertical cross section of the gravitational field (illustrated by the vector 1501), a vector parallel to the gravitational field 1502, a vector perpendicular to the field of gravity 1504, a plane (or a line) at an acute angle alpha relative to the vector perpendicular to the field of gravity 1503, and at an acute angle beta relative to a vector parallel to the field of gravity. Alpha and beta are complementary angles. FIG. 15B shows an example of a 3D object printed using the methods, apparatus, systems, and/or software of the present disclosure, having 3D planes of various alpha angle values, connected to a central post. The formed 3D object may be formed in an acute angle of 45°, 40°, 35°, 30°, 25°, or less; with the direction normal to the field of gravity. The formed 3D object may be created as forming an acute angle of 45°, 40°, 35°, 30°, 25°, or less with the average plane of the platform. The formed 3D object may be created as forming an acute angle of 45°, 40°, 35°, 30°, 25°, or less with the average plane created by the exposed (e.g., top) surface of the material bed (e.g., powder material). The generated 3D object may not require additional processing before it is delivered to a customer.

The formed 3D object may comprise short auxiliary supports. The short auxiliary supports may be of a height that is at most about 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 millimeter (mm), 2 mm, 3 mm, 4 mm, 5 mm, 6 mm, 7 mm, 8 mm, 9 mm, 10 mm, 20 mm, 30 mm, 40 mm, or 50 mm. The short auxiliary supports may be of a height that is any value between the afore-mentioned auxiliary support height values (e.g., from about 10 μm to about 1 mm, from about 1 mm to about 50 mm, or from about 100 μm to about 3 mm).

The fabricated 3D object can be an extensive object. The 3D object can be a large object. The 3D object may comprise a large hanging structure (e.g., wire or 3D plane (e.g., ledge, or shelf)). Large may be an object having a FLS of at least about 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. In some instances, The FLS of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, from about 1 cm to about 100 m, from about 1 cm to about 1 m, from about 1 m to about 100 m, or from about 150 μm to about 10 m). The FLS (e.g., horizontal FLS) of the layer of hardened material may have any value listed herein for the FLS of the 3D object.

The layer of pre-transformed material (e.g., powder material) may be of a predetermined height (thickness). The layer may have an upper (e.g., exposed) surface that is substantially flat, leveled, planar, and/or smooth. The layer may have an upper surface that is not flat, leveled, planar, and/or smooth. The layer may have an upper surface that is corrugated or uneven. The layer may have a predetermined height. The height of the layer of pre-transformed material (e.g., powder material) may be at least about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be at most about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be any number between the afore-mentioned heights (e.g., from about 5 μm to about 100 μm, from about 100 μm to about 300 μm, from about 300 μm to about 1000 μm, or from about 5 μm to about 1000 μm).

The height of the layer of pre-transformed material may at times be referred to as the thickness of the pre-transformed material layer. At times, the first layer of pre-transformed material may be thicker than a subsequent layer. The first layer of pre-transformed material may be at least about 1.1 times, 1.2 times, 1.4 times, 1.5 times, 1.6 times, 1.8 times, 2 times, 4 times, 6 times, 8 times, 10 times, 20 times, 30 times, 50 times, 100 times, 500 times, or 1000 times thicker (higher) than the average thickness of a subsequent layer, the average thickens of an average subsequent layer, or the average thickness of any of the subsequent layers. As compared to the average thickness of a subsequent layer, the average thickens of an average subsequent layer, or the average thickness of any of the subsequent layers; the first layer of pre-transformed material may be thicker between any of the aforementioned values (e.g., from about 1.1 times to about 1000 times, from about 1.1 times to about 20 times, from about 1.1 times, to about 4 times, from about 4 times to about 20 times, or from about 20 times to about 1000 times).

The height of the layer of hardened material may at times be referred to as the thickness of the hardened material layer. At times, the first layer of hardened material (e.g., bottom skin layer) may be thicker than a subsequent layer. The first layer of hardened material may be at least about 1.1 times, 1.2 times, 1.4 times, 1.5 times, 1.6 times, 1.8 times, 2 times, 4 times, 6 times, 8 times, 10 times, 20 times, 30 times, 50 times, 100 times, 500 times, or 1000 times thicker (higher) than the average thickness of a subsequent layer, the average thickens of an average subsequent layer, or the average thickness of any of the subsequent layers. As compared to the average thickness of a subsequent layer, the average thickens of an average subsequent layer, or the average thickness of any of the subsequent layers; the first layer of hardened material may be thicker between any of the aforementioned values (e.g., from about 1.1 times to about 1000 times, from about 1.1 times to about 20 times, from about 1.1 times, to about 4 times, from about 4 times to about 20 times, or from about 20 times to about 1000 times). The first layer of hardened material may be the very first layer of hardened material that is a portion of the 3D object. The very first layer of hardened material formed in the material bed by 3D printing may be referred herein as the “bottom skin” layer.

In some instances, adjacent components in the material bed are separated from one another by one or more intervening layers. For example, the one or more intervening layers can have a thickness of at most about 10 micrometers (“microns”), 1 micron, 500 nanometers (“nm”), 100 nm, 50 nm, 10 nm, 1 nm, or less. For example, the one or more intervening layers can have a thickness of at least about 10 micrometers (“microns”), 1 micron, 500 nanometers (“nm”), 100 nm, 50 nm, 10 nm, 1 nm, or more. In an example, a first layer is adjacent to a second layer when the first layer is in direct contact with the second layer. In an example, a first layer is adjacent to a second layer when the first layer is separated from the second layer by a third layer. In some instances, adjacent to may be ‘above’ or ‘below.’ The layers may comprise transformed or pre-transformed material.

The material (e.g., pre-transformed, transformed, and/or hardened) may comprise an elemental metal, metal alloy, ceramic, or an allotrope of elemental carbon. The material may comprise stainless steel. The material may comprise a super alloy. The material may comprise a titanium alloy, aluminum alloy, or nickel alloy. In some cases, the material can comprise a polymer, a metal (elemental metal), a metal alloy, a ceramic, or an allotrope of elemental carbon. The material may comprise a mixture (e.g., blend) with elemental metal or with metal alloy. The material may comprise a mixture that excludes an elemental metal, and/or includes a metal alloy. In some cases, the material may exclude a polymer.

In some cases, a layer of the 3D object is formed a single type of material. In some examples, a layer of the 3D object may be formed of a single elemental metal type, or a single alloy type. In some examples, a layer of hardened material within the 3D object may comprise a plurality of material types (e.g., an elemental metal and an alloy, an alloy and a ceramic, or an alloy and an elemental carbon). In certain embodiments each type of material comprises only a single member of that type. For example: a single member of elemental metal (e.g., iron), a single member of metal alloy (e.g., stainless steel), a single member of ceramic material (e.g., silicon carbide, or tungsten carbide), or a single member of elemental carbon (e.g., graphite). In some cases, a layer of hardened material within the 3D object comprises more than one type of material. In some cases, a layer of the 3D object comprises more than one member of a certain type of material.

The elemental metal can be an alkali metal, an alkaline earth metal, a transition metal, a rare earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics.

The alloy may include a superalloy. The alloy may include a high-performance alloy. The alloy may include an alloy exhibiting at least one of: excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

The iron alloy may comprise Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Reynolds 531, Silicon steel, Spring steel, Stainless steel, Tool steel, Weathering steel, or Wootz steel. The high-speed steel may comprise Mushet steel. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, super austenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, 17-4PH steel).

The titanium-based alloy may comprise alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy comprises Ti-6Al-4V or Ti-6Al-7Nb.

The Nickel alloy may comprise Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e. g. Talonite), Ultimet, or Vitallium. The chromium alloy may comprise chromium hydroxide, or Nichrome. The cobalt alloy may be a cobalt chrome alloy.

The aluminum alloy may comprise AA-8000, Al—Li (aluminum-lithium), Alnico, Duralumin, Hiduminium, Kryron Magnalium, Nambe, Scandium-aluminum, or Y alloy. The magnesium alloy may comprise Elektron, Magnox, or T-Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze, Arsenical bronze, Bell metal, Florentine bronze, Guanin, Gunmetal, Glucydur, Phosphor bronze, Ormolu, or Speculum metal.

The material may comprise one wherein its constituents (e.g., atoms or molecules) readily lose their outer shell electrons, resulting in a free flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the aforementioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the aforementioned electrical resistivity values (e.g., from about 1×10⁻⁶ Ω*m to about 1×10⁻⁸ Ω*m). The high thermal conductivity may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the aforementioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the aforementioned density values (e.g., from about 1 g/cm³ to about 25 g/cm³).

A metallic material (e.g., elemental metal or metal alloy) can comprise small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (on the basis of weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (on the basis of weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

The powder may comprise a solid having fine particles. Powder may be a granular material. The powder can be composed of individual particles. At least some of the particles can be spherical, oval, prismatic, cubic, or irregularly shaped. The average or mean FLS of the powder particles can be at most about 1000 micrometers (μm), 500 μm, 400 μm, 300 μm, 200 μm, 100 μm, 50 μm, 40 μm, 30 μm, 20 μm, 10 μm, 1 μm, 500 nm, 400 nm, 300 nm, 200 nm, 100 nm, 50 nm, 40 nm, 30 nm, 20 nm, 10 nm, or 5 nm. The average or mean FLS of the powder particles can be of at least about 1000 μm, 500 μm, 400 μm, 300 μm, 200 μm, 100 μm, 50 μm, 40 μm, 30 μm, 20 μm, 10 μm, 1 μm, 500 nm, 400 nm, 300 nm, 200 nm, 100 nm, 50 nm, 40 nm, 30 nm, 20 nm, 10 nm, or 5 nm. The average or mean FLS of the powder particles can be in between any of the aforementioned FLS valued (e.g., from about 1000 μm to about 5 nm, from about 1000 μm to about 100 μm, from about 100 μm to about 50 μm, from about 50 μm to about 1 μm, from about 1 μm to about 5 nm.)

The powder can be composed of a homogenously shaped particle mixture such that all of the particles have substantially the same shape and fundamental length scale magnitude within at most about 1%, 5%, 8%, 10%, 15%, 20%, 25%, 30%, 35%, 40%, 50%, 60%, or 70% distribution of FLS. In some cases, the powder can be a heterogeneous mixture such that the particles have variable shape and/or FLS magnitude. In some examples, at least about 30%, 40%, 50%, 60% or 70% (by weight) of the particles within the powder material have a largest FLS that is smaller than the median largest FLS of the powder material. In some examples, at least about 30%, 40%, 50%, 60% or 70% (by weight) of the particles within the powder material have a largest FLS that is smaller than the mean largest FLS of the powder material.

In some examples, a droplet of transformed material may form in the material bed. The size of the FLS of a transformed material droplet may be greater than the average or mean FLS of the powder material by at least about 1.1 times, 1.2 times, 1.4 times, 1.6 times, 1.8 times, 2 times, 4 times, 6 times, 8 times, or 10 times. The size of the FLS of a transformed material droplet may be greater than the average or mean FLS of the powder material by at least about 1.1 times, 1.2 times, 1.4 times, 1.6 times, 1.8 times, 2 times, 4 times, 6 times, 8 times, or 10 times. The size of the FLS of a transformed material droplet may be greater than the average or mean FLS of the powder material by any value between the aforementioned values (e.g., from about 1.1. times to about 10 times). The droplet may be substantially a ball of transformed (e.g., molten) material.

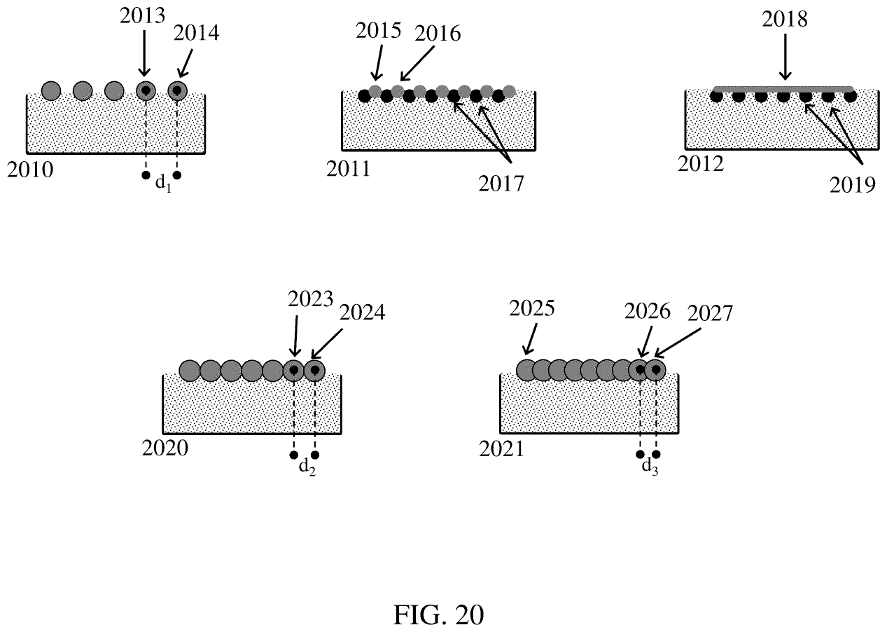

In some instances, a multiplicity of droplets may be formed in the material bed. The multiplicity of droplets may be formed substantially within a layer of pre-transformed material. The multiplicity of droplets may be formed substantially within a plane. FIG. 20 shows an example of a side view of material bed 2010 where droplets (e.g., 2013 and 2014) are formed in the material bed in a plane. The side view of material bed 2010 can be a vertical cross section, showing an example where the droplets (e.g., 2013 and 2014) are formed in a single file. The droplets may be substantially aligned along a line. The droplets may substantially form a single file. The arrangement of the droplets may resemble fluid thread breakup (e.g., Rayleigh-Taylor instability, or Plateau-Rayleigh instability). The line of droplets may be substantially straight. The line of droplets may comprise a curvature. The line of droplets may intersect or not intersect with itself. The line of droplets may or may not overlap with itself. The line of droplets may comprise an angle (e.g., planar angle). The angle may be acute, obtuse, or a right angle. The line of droplets may have an amorphous shape. The amorphous shape may be a substantially planar shape.

In some embodiments, the droplets may touch each other as they form. The droplets may overlap each other as they form. Sometimes, the droplets may not connect. At least some of the droplets may not touch each other. At least some of the droplets may or may not touch each other while in their transformed (e.g., molten) state. At least some of the droplets may or may not touch each other while in their hardened (e.g., solid) state. At least some of the droplets may contact each other as they harden. At least some of the droplets may contact each other as they cool. At least some of the droplets may almost touch each other (e.g., in their transformed state). In some embodiments, the droplets are formed with an average (or mean) distance that is substantially “d” between the centers of the droplets. The average or mean distance between the droplets may be “d.” The distance “d” may be equal to or greater than the mean (or average) of the FLS of the droplets (e.g., in a line of droplets). FIG. 20 shows an example of droplets in a material bed 2010 where the distance d₁ between the droplets (e.g., 2013 and 2014) is greater than the FLS (e.g., diameter) of the droplets. FIG. 20 shows an example of droplets in a material bed 2020 where the distance d₂ between the droplets (e.g., 2023 and 2024) is substantially equal to the FLS (e.g., diameter) of the droplets. The distance “d” may be smaller than the mean or average FLS of the droplets (e.g., in the line of droplets). FIG. 20 shows an example of droplets in a material bed 2021 where the distance d₃ between the droplets (e.g., 2026 and 2027) is smaller than the average or mean FLS (e.g., diameter) of the droplets. When the distance between the droplet is smaller than their average or mean FLS (e.g., diameter), the droplets may overlap as they form. At times, at least one ending of the wire is thicker than its interior length. The first droplet forming the wire may be thicker than the average FLS of the rest of the droplets that form the wire. The average or mean thickness of the wire may be substantially the average or mean FLS of the droplets forming the wire.

The average or mean distance “d” between the centers of the droplets may be at least about 1 micrometer (μm), 2 μm, 3 μm, 4 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The average or mean distance “d” between the centers of the droplets may be at most about 1 micrometer, 2 μm, 3 μm, 4 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The average or mean distance “d” between the centers of the droplets may be between any of the aforementioned values (e.g., from about 1 μm to about 500 μm, from about 1 μm to about 10 μm, from about 10 μm to about 50 μm, from about 50 μm to about 100 μm, or from about 100 μm to about 500 μm). The average or mean distance “d” between the centers of the droplets may be at least about 1/10, ⅕, ¼, ⅓, ½, ⅔, ¾, ⅘, or 9/10 of the average or mean FLS of the droplets. The average or mean distance “d” between the centers of the droplets may be at most about 1/10, ⅕, ¼, ⅓, or ½ of the average or mean FLS of the droplets. The average or mean distance “d” between the centers of the droplets may be between any of the aforementioned values (e.g., from about 1/10 to about 9/10□, from about 1/10 to about ½, from about ½ to about ¾, or from about ¾ to about 9/10) relative to the average or mean FLS of the droplets.

The droplets may harden to form hardened droplets. The hardened droplets may be joined to form a wire. The wire may be generated by an overlap of the droplets (e.g., as they form). The wire may be generated by forming a second layer of transformed material, a second layer of a multiplicity of droplets, or any combination thereof. The at least one ending of the wire may warp up or down as compared to the average plane of the wire. The material bed 2011 of FIG. 20 shows an example of a vertical cross section of a wire, where the first layer is formed of disconnected droplets (e.g., 2017), and the second layer is formed of disconnected droplets (e.g., 2015 and 2016), that connect the droplets in the first layer, thus forming a connected wire. The material bed 2012 of FIG. 20 shows an example of a vertical cross section of a wire, where the first layer is formed of disconnected droplets (e.g., 2019), and the second layer is formed of a line 2018 that connect the droplets in the first layer, thus forming a connected wire.

The second droplet may be formed while the first droplet is in a transformed state. The second droplet may be formed while the first droplet is at least partially hardened. For example, the second droplet may be formed while the first droplet is at least partially in a liquid state (e.g., entirely liquid). The second droplet may be formed while the first droplet is at least partially solid (e.g., completely solid). The second droplet may be formed while the rim (e.g., envelope) of the first droplet is at least partially solid (e.g., completely solid); while the interior of the droplet is solid or liquid. The second droplet may be generated while the first droplet is in a liquidus state. The second droplet may be generated while the first droplet is in a liquefied state. A liquefied state refers to a state in which at least part of a material is in a liquid state. A liquidus state refers to a state in which an entire material is in a liquid state. The wire may comprise identifiable melt pools. The wire may comprise enlarged melt pools. The wire may comprise substantially a single melt pool.

In some examples, the average height of the formed wire (see for example FIG. 4A) is at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 5 μm, 4 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, or 50 mm. The average height of the formed wire can be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 5 μm, 4 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, or 50 mm. The average height of the wire can be any value between the afore-mentioned wire heights (e.g., from about 1.3 μm to about 50 mm, from about 1.3 μm to about 100 μm, from about 100 μm to about 900 μm, or from about 1 mm to about 50 mm). The FLS of the droplet may be substantially the FLS of the wire, within at least about 10%, 20%, or 30% accuracy. The shape of a cross section of the wire may comprise an ellipse, circle, or crescent. FIG. 4A shows an example of a wire cross section that is a circle.

The length of the wire can be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1000 mm, 2000 mm, 5000 mm, 10000 mm, 100000 mm, or 1000000 mm. The average length of the wire can be any value between the afore-mentioned wire lengths (e.g., from about 1.3 μm to about 1000000 mm, from about 1.3 μm to about 100 μm, from about 100 μm to about 900 μm, from about 1 mm to about 1000 mm, or from about 1000 mm to about 1000000 mm).

In some examples, the largest of a length and a width of the 3D plane (e.g., FIG. 4B) is at least about 50 micrometers (μm), 100 μm, 200 μm, 300 μm, 400 μm, 500 μm, 600 μm, 700 μm, 800 μm, 900 μm, 1 mm, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 15 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1000 mm, 2000 mm, 5000 mm, 10000 mm, 100000 mm, or 1000000 mm. The largest of a length and a width of the plane may be at most about 50 μm, 100 μm, 200 μm, 300 μm, 400 μm, 500 μm, 600 μm, 700 μm, 800 μm, 900 μm, 1 mm, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 15 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1000 mm, 2000 mm, 5000 mm, 10000 mm, 100000 mm, or 1000000 mm. The largest of a length and a width of the 3D plane can be any value between the afore-mentioned lengths (e.g., from about 50 μm to about 1000000 mm, from about 50 μm to about 100 μm, from about 100 μm to about 900 μm, from about 1 mm to about 1000 mm, or from about 1000 mm to about 1000000 mm). The smaller of a length and a width of the 3D plane (see for example FIG. 4B) may be at least about 1 millimeter, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 15 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1000 mm, 2000 mm, 5000 mm, 10000 mm, or 100000 mm, 1000000 mm. The smaller of a length and a width of the plane may be at most about 1 millimeter, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 15 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, 1000 mm, 2000 mm, 5000 mm, 10000 mm, 100000 mm, or 1000000 mm. The smaller of a length and a width of the 3D plane can be any value between the afore-mentioned lengths (e.g., from about 1.3 μm to about 1000000 mm, from about 1.3 μm to about 100 μm, from about 100 μm to about 900 μm, from about 1 mm to about 1000 mm, or from about 1000 mm to about 1000000 mm).

The wire may have an aspect ratio of a width to length (i.e., width:length) of at least about 1:10, 1:20, 1:30, 1:40, 1:50, 1:100, 1:500, or 1:1000. The wire may have an aspect ratio of a width to length of at most about 1:5000, 1:1000, 1:500, 1:100, 1:50, 1:40, 1:30, 1:20, or 1:10. The wire may have an aspect ratio of a width to length of any value between the aforementioned values (e.g., from about 1:10 to about 1:5000, from about 1:10 to about 1:500, or from about 1:10 to about 1:1000).

The 3D plane may have an aspect ratio of a width to length (i.e., width:length) of at least about 1:1, 1:2, 1:3, 1:4, 1:5, 1:6, 1:7, 1:8, or 1:9. The plane may have an aspect ratio of a width to length of at most about 1:9, 1:8, 1:7, 1:6, 1:5, 1:4, 1:3, 1:2, or 1:1. The wire may have an aspect ratio of a width to length of any value between the aforementioned values (e.g., from about 1:1 to about 1:9, from about 1:1 to about 1:5, or from about 1:1 to about 1:3).

The wire (e.g., the wire during its formation) may form an angle beta with a plane parallel to the field of gravity. FIG. 15A shows a vertical cross section of an angle beta formed by a wire (or by a 3D plane) 1503 with a vector 1502 that is parallel to the field of gravity (vector 1501). The wire may form an angle beta with the vector parallel to the field of gravity. The wire may form an angle alpha with a plane parallel to the exposed surface (e.g., average or mean thereof) of the material bed. The wire may form an angle alpha relative to a plane parallel to the top surface of the container, and/or the platform that faces the material bed. Alpha can have any of the afore-mentioned values of alpha. Beta may be a dihedral angle. Beta may be a planar angle. The wire may form an angle beta with a plane perpendicular to the horizon (e.g., during the formation of the wire). The wire (or an average line of the wire) may form an angle beta with an average plane perpendicular to the upper (e.g., exposed) surface of the material bed (e.g., during the formation of the wire). The angle beta may be at most about 90°, 80°, 70° 60°, 50°, 45°, 40°, 30°, 20°, 10°, 5°, 3°, 2°, 1°, or 0.5°. The angle beta may be at least about 89°, 80°, 70° 60°, 50°, 45°, 40°, 30°, 20°, 10°, 5°, 3°, 2°, 1°, or 0.5°. The angle beta may larger than 85°. The angle beta may be larger than 45°. Beta may be the acute (sharp) angle. The angle beta may be substantially 90°. The wire (e.g., during its formation) may be substantially parallel to the horizon during its formation. The wire (e.g., during its formation) may reside in a plane that is substantially parallel to the horizon during its formation. The wire (or an average line of the wire) may be substantially parallel to the average plane formed by the exposed surface of the material bed (e.g., during its formation). The wire (e.g., during its formation) may be situated in a plane that is substantially parallel to the average plane formed by the upper surface of the material bed. The wire (e.g., during its formation) may be situated in a plane that is substantially perpendicular to the field of gravity. The wire (e.g., during its formation) may be situated in a plane that forms and angle beta with the field of gravity.

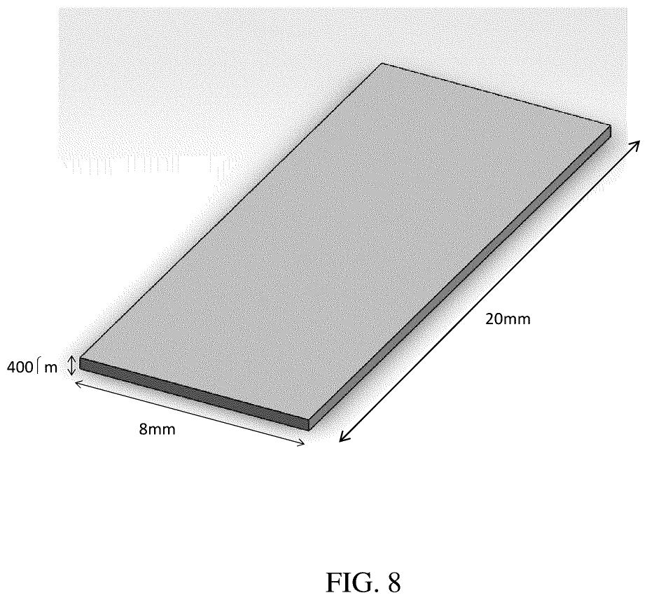

In some examples, the wire may be a predetermined wire. The wire may be formed according to instructions. The instructions can be a set of values or parameters that describe the shape and dimensions of the wire. The wire can be formed according to a part in a model of a 3D object. The wire can be formed according to a part in a cross-section of a model of a 3D object. Models of 2D or of 3D objects (i.e. 2D or 3D models) may be created with a computer aided design package, via 2D or 3D scanner, manually, or by any combination thereof. The manual modeling process of preparing geometric data for 2D or 3D computer graphics may be similar to plastic arts. 3D computer graphics may be similar to sculpting or animating. 3D scanning is a process of analyzing and collecting digital data on the shape and appearance of a real object. Based on this data, 3D models of the scanned object can be produced. In an example, the instructions can come from a 3D modeling program (e.g., AutoCAD, SolidWorks, Google SketchUp, or Solid Edge). In some cases, the model can be generated from a provided sketch, image, or a two dimensional (e.g., “2D”) or 3D object as described herein. FIG. 8 shows an example of a 3D plane that is a planar (e.g., flat) object.

The wire may be continuous or discontinuous. The continuous wire may comprise a continuous wire of transformed and/or hardened material. FIG. 1A (1) shows an example that illustrates a continuous path that can materialize into a continuous wire as an example. FIG. 1A (2)-FIG. 1A (5) show examples that illustrate various discontinuous paths that can materialize into corresponding wires. The discontinuous wire may have wire segments that contain transformed (e.g., fused, connected, or bound) material, and others that do not comprise transformed material but rather pre-transformed material. The wire may comprise a dotted line or a dashed wire. The wire may comprise fused, connected or bound droplets of transformed material, the wire may comprise dashes of fused, connected, or bound material. The wire may be straight or curved. FIG. 1B shows an example of path segments that are straight and curved and can materialize into the corresponding wire. The wire may be amorphous. FIG. 1B shows an example of an amorphous paths that can materialize into a corresponding wire. The wire may comprise straight segments or curved segments. The droplets may be substantially spherical. The droplets may be devoid of edges. The droplets may comprise an elliptical (e.g., round) sphere.

In some embodiments, the formation of the wire includes transforming the pre-transformed material (e.g., powder) using an energy beam. The energy beam may be any energy beam (e.g., scanning energy beam or energy flux) disclosed in patent application No. 62/265,817, which is incorporated herein by reference in its entirety. The energy source may be any energy source disclosed in patent application No. 62/265,817, filed on Dec. 10, 2015, titled “APPARATUSES, SYSTEMS AND METHODS FOR EFFICIENT THREE DIMENSIONAL PRINTING,” which is incorporated herein by reference in its entirety. The energy beam may travel (e.g., scan) along a path. For example, FIG. 2, 201 shows an energy beam. The energy beam may be projected on to a particular area of the material bed, thus causing the pre-transformed material at that location to transform into a transformed material. The energy beam may cause at least part of the pre-transformed material to transform from its present state of matter to a different state of matter. The energy beam may cause at least part of the material to physically and/or chemically transform. For example, the pre-transformed material may transform at least in part (e.g., entirely) from a solid to a liquid state. For example, the energy beam may cause chemical bonds to form and/or break. The chemical transformation may be an isomeric transformation. The energy beam may cause the pre-transformed material to transform. The transformation may include a magnetic transformation and/or an electronic transformation. The transformation may comprise coagulation of the pre-transformed material, cohesion of the pre-transformed material, or accumulation of the pre-transformed material.

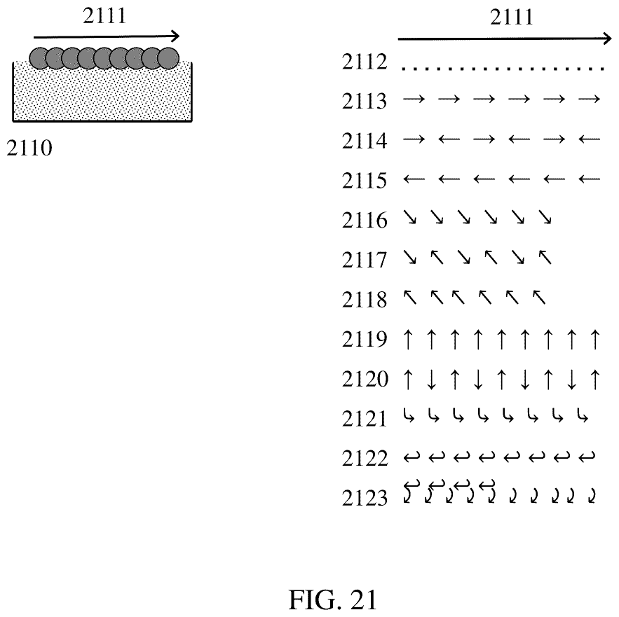

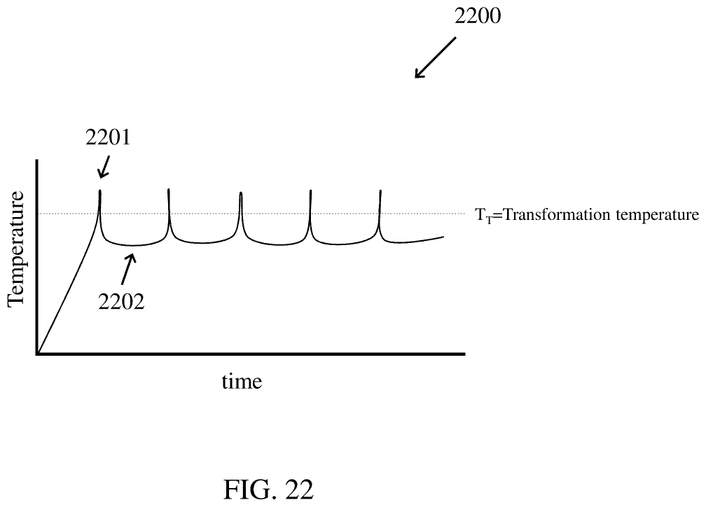

The formation of the wire may comprise formation of droplets of transformed material. The droplets may be formed with a continuous or discontinuous (e.g., pulsing) energy beam having an energy sufficient to transform the pre-transformed material into a transformed material. The droplets may be formed with a pulsing energy beam. The energy beam may irradiate the material bed during a time period (e.g., dwell time) while it travels along a path in the direction of the wire formation. FIG. 21 shows an example of a side view of a wire that is formed from droplets in a material bed 2110, which wire is formed in the direction 2111. The path may comprise straight or curved sections. The path may be amorphous. The path may be a straight line. The path may match one ending (e.g., edge) of a plane. The portion of the irradiated material bed may be a portion of a path according to which the energy beam travels while forming the wire. The path may comprise intermissions in which the path is not irradiated with energy beam having an energy sufficient to transform the material bed. The path may comprise intermissions during which the path is not (e.g., substantially) irradiated with the energy beam (e.g., off time). The pulsing energy beam path may comprise intermission (e.g., off) times at which (e.g., substantially) no energy is irradiated onto the material bed (e.g., along the subject path). At the intermission time, the energy beam may travel elsewhere in the material bed and irradiate a different portion of the material bed than the subject path. The different portion may be distant or adjacent to the subject path. The pulsing energy beam may comprise intermission (e.g., off) times at which the energy irradiated onto the material bed is not sufficient to transform at least a portion of the material bed into a transformed material. The energy beam may dwell in substantially one position during the dwell time within the subject path, and translate during the intermissions (e.g. off time) until it returns to the second dwell (e.g., irradiative) position of the subject path. The subject path may be a path forming a layer of hardened material, which may be at least a portion of the wire and/or 3D plane. FIG. 21, 2112 shows an example of a path in which the dwell time are illustrated as points that form a line. The position of the energy beam during the dwell time may be substantially stationary. The energy beam may translate during the dwell time. A path may comprise one or more hatches. The energy beam may translate along a hatch during the dwell time within the wire path, and also translate during the intermissions (e.g. off time) until it reaches the second dwell (e.g., irradiative) position at the subject path. FIG. 21, 2113 shows an example of a path in which the dwell time are illustrated as arrows that form a line, which energy beam irradiates the material bed with a transforming energy while the energy beam translates along the direction of wire formation 2111. The hatches may be parallel, perpendicular, at an angle, or any combination thereof with respect to the direction of subject path (e.g., the direction of wire formation). FIG. 21, 2113-2123 show various examples of dwell time hatches along the subject path (e.g., direction of wire formation). The hatches may be with and/or against the direction of wire formation. FIGS. 21, 2113 and 2116 show various examples of dwell time hatches that travel with the direction of wire formation path 2111. FIGS. 21, 2115 and 2118 show various examples of dwell time hatches that travel against the direction wire formation 2111. FIGS. 21, 2114, 2117, and 2121-2122 show various examples of dwell time hatches that travel both with and against the direction wire formation 2111. FIGS. 21, 2119 and 2120 show various examples of dwell time hatches that travel perpendicular to the direction wire formation 2111. FIG. 21, 2123 shows an example of dwell time hatches that travel both with, against, and perpendicular to the direction wire formation 2111. The various hatch configurations in FIG. 21 are mere examples, and any combination thereof may form the hatches used to form the droplets in the wire. FIG. 22 shows an example of a temperature profile that depicts the temperature of the material bed during the time in which the energy beam travels along the wire formation path. The temperature of the material beam at a particular position may be at or above the transformation temperature of the material during the exposure time of the energy beam (e.g., dwell time), at which a droplet is formed. The temperature of the material beam at a particular position may be below the transformation temperature of the material during the off time of the energy beam (e.g., intermission), at which no droplet is formed.

The hatch length may be at least about 1 micrometer (μm), 5 μm, 10 μm, 20 μm, 30 μm, 40 μm, 50 μm, 60 μm, 70 μm, 80 μm, 90 μm, 100 μm, 200 μm, or 300 μm. The hatch length may be at most about 1 micrometer (μm), 5 μm, 10 μm, 20 μm, 30 μm, 40 μm, 50 μm, 60 μm, 70 μm, 80 μm, 90 μm, 100 μm, 200 μm, or 300 μm. The hatch length may be between any of the afore-mentioned values (e.g., from about 1 μm to about 300 μm, from about 1 μm to about 30 μm, from about 30 μm to about 50 μm, or from about 50 μm to about 300 μm). The distance that corresponds to the intermissions may be “d” that is measured between the centers of the droplets as described herein.

The dwell time of the energy beam may be of at least about 1 milliseconds (msec), 2 msec, 3 msec, 4 msec, 5 msec, 6 msec, 7 msec, 8 msec, 9 msec, 10 msec, 11 msec, 12 msec, 13 msec, 14 msec, 15 msec, 16 msec, 17 msec, 18 msec, 19 msec, 20 msec, 25 msec, 30 msec, 35 msec, 40 msec, 50 msec, or 100 msec. The dwell time may be of at most about 1 msec, 2 msec, 3 msec, 4 msec, 5 msec, 6 msec, 7 msec, 8 msec, 9 msec, 10 msec, 11 msec, 12 msec, 13 msec, 14 msec, 15 msec, 16 msec, 17 msec, 18 msec, 19 msec, 20 msec, 25 msec, 30 msec, 35 msec, 40 msec, 50 msec, or 100 msec. The dwell time may be of any value between the aforementioned values (e.g., from about 1 msec to about 100 msec, from about 1 msec to about 3 msec, from about 3 msec to about 13 msec, from about 13 msec to about 35 msec, or from about 35 msec to about 100 msec).

The intermission time may be of at least about 1 milliseconds (msec), 2 msec, 3 msec, 4 msec, 5 msec, 6 msec, 7 msec, 8 msec, 9 msec, 10 msec, 11 msec, 12 msec, 13 msec, 14 msec, 15 msec, 16 msec, 17 msec, 18 msec, 19 msec, 20 msec, 25 msec, 30 msec, 35 msec, 40 msec, 50 msec, 70 msec, 90 msec, 100 msec, 150 msec, 200 msec, 250, 300 msec, 400 msec, 500 msec, 600 msec, 700 msec, 800 msec, 900 msec, or 1000 msec. The intermission time may be of at most about 1 milliseconds (msec), 2 msec, 3 msec, 4 msec, 5 msec, 6 msec, 7 msec, 8 msec, 9 msec, 10 msec, 11 msec, 12 msec, 13 msec, 14 msec, 15 msec, 16 msec, 17 msec, 18 msec, 19 msec, 20 msec, 25 msec, 30 msec, 35 msec, 40 msec, 50 msec, 70 msec, 90 msec, 100 msec, 150 msec, 200 msec, 250, 300 msec, 400 msec, 500 msec, 600 msec, 700 msec, 800 msec, 900 msec, or 1000 msec. The intermission time may be of any value between the aforementioned values (e.g., from about 1 msec to about 1000 msec, from about 1 msec to about 50 msec, from about 50 msec to about 90 msec, from about 90 msec to about 150 msec, or from about 150 msec to about 500 msec).

The power per unit area of the energy beam may be any power per unit area of the energy beam mentioned herein. The travel velocity of the energy beam (e.g., scanning velocity) may be any travel velocity of the energy beam mentioned herein. The travel velocity of the energy beam may be high or slow. The travel velocity of the energy beam that travels along the wire forming path may be slower by at least about 1 or 2 orders of magnitude as compared to the travel velocity of the energy beam during the formation of the 3D plane. The travel velocity of the energy beam that travels along the wire forming path may be slower by at least about 2, 3, 4, 5, 5, 6, 7, 8, or 9 times as compared to the travel velocity of the energy beam during the formation of the 3D plane. The intermission time may depend on the power of the energy beam, power per unit area of the energy beam, thickness of desired wire, thickness of the layer of pre-transformed material, dwell time (e.g., exposure time) of the energy beam, velocity of the energy beam (e.g., scanning speed), cross section of the energy beam (e.g., footprint), frequency of the pulsing energy beam, or any combination thereof.

In some instances, formation of the multiplicity of droplets may transform (e.g., weld) the pre-transformed material. The dwell time may allow a droplet that was immediately previously formed (e.g., just formed) to harden, before a new droplet is formed by irradiation of the energy beam onto the powder bed. The method may comprise forming a first droplet by irradiating a first portion of the material bed with an energy beam, and subsequent to hardening the first droplet, forming a second droplet of transformed material by irradiating a second portion of the material bed with the energy beam. Wherein the first portion is adjacent to the second portion.

The 3D plane or broadened 3D plane (e.g., during its formation) may form an angle alpha with a plane normal to the field of gravity. FIG. 15A shows an example of a vertical cross section of an angle alpha formed by a plane (or a wire) 1503 and a vector 1502 that is parallel to the field of gravity (vector 1501). FIG. 15B shows an example of an object printed using the methods, apparatus, systems and/or software of the present disclosure, having 3D planes of various alpha angle values. The 3D plane or broadened 3D plane may form an angle alpha with a plane parallel to the average top surface of the layer of material. The 3D plane or broadened 3D plane may form an angle alpha relative to a plane parallel to the average top leveled surface of the layer of pre-transformed material (e.g., powder material). The 3D plane or broadened 3D plane may form an angle alpha relative to a plane parallel to the average top surface of the enclosure and/or platform facing the deposited pre-transformed material. Alpha may be a dihedral angle. Alpha may be a planar angle. The forming object may form an angle alpha with the horizon. The printed 3D object may form an angle alpha with an average plane parallel to the exposed surface of the material layer (e.g., during its formation). The angle alpha may be at most about 80°, 70° 60°, 50°, 45°, 40°, 30°, 20°, 10°, 5°, 3°, 2°, 1°, or 0.5°. The angle alpha may be at least about 80°, 70° 60°, 50°, 45°, 40°, 30°, 20°, 10°, 5°, 3°, 2°, 1°, or 0.5°. The symbol “°” designates degrees. The acute angle alpha may be from about 0°, 1°, 2°, 3°, 4°, 5°, 8°, 10°, 15°, 20°, 25°, 30°, 35°, 40°, or 43° to about 1°, 2°, 3°, 4°, 5°, 8°, 10°, 15°, 20°, 25°, 30°, 35°, 40°, 43° or 45°. The acute angle alpha may at least about 0°, 1°, 2°, 3°, 4°, 5°, 8°, 10°, 15°, 20°, 25°, 30°, 35°, 40°, or 43°. The acute angle may be at most about 1°, 2°, 3°, 4°, 5°, 8°, 10°, 15°, 20°, 25°, 30°, 35°, 40°, 43° or 45°. The acute angle alpha may be between any of the afore-mentioned values of the acute angle alpha (e.g., from about 0° to about 45°, from about 0° to about 30°, or from about 0° to about 20°). The angle alpha may smaller than about 90°. The angle alpha may be smaller than about 45°. Alpha may be the acute (sharp) angle. The angle alpha may be (e.g., substantially) zero. The printed 3D object (e.g., during its formation) may form an average plane that is substantially parallel to the horizon, during its formation. The printed 3D object (e.g., during its formation) may form an average plane that is substantially parallel to the exposed surface of the material bed. A ledge and/or a wire of the printed 3D object (e.g., during its formation) may form an average plane that is substantially perpendicular to the field of gravity. In some embodiments, the wire, 3D plane, and/or broadened 3D plane may form a closed 3D structure (e.g., a ring). The wire, 3D plane, and/or broadened 3D plane may be part of a closed 3D structure (e.g., a ring).

The travel velocity of the energy beam that travels along the plane forming path may be higher by at least about 1 or 2 orders of magnitude as compared to the travel velocity of the energy beam during the formation of the wire. The travel velocity of the energy beam that travels along the plane forming path may be higher by at least about 2, 3, 4, 5, 5, 6, 7, 8, or 9 times as compared to the travel velocity of the energy beam during the formation of the 3D plane. The plane forming path may be any path disclosed herein (e.g., in FIGS. 1A-1F).

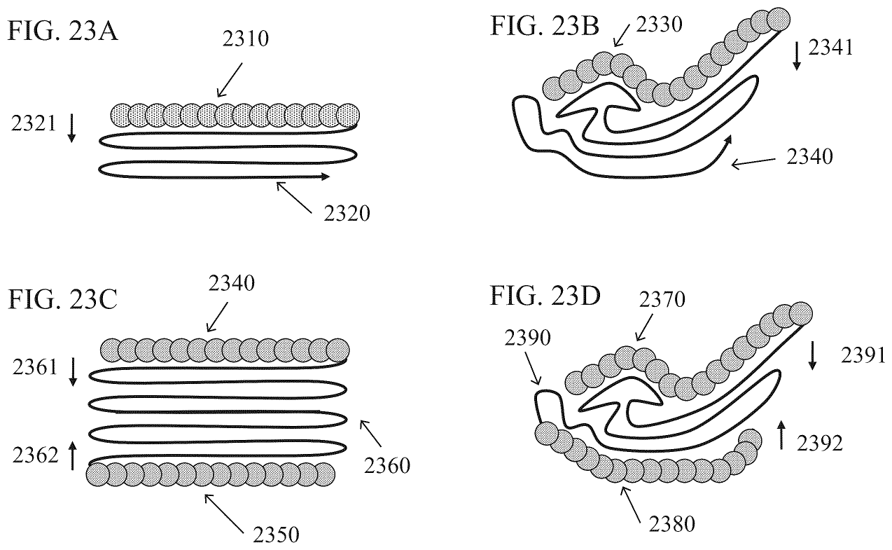

Another aspect of the present disclosure provides a method for forming a 3D plane comprising depositing a first layer of pre-transformed material in an enclosure; transforming the pre-transformed material to form at least two spaced apart wire objects; depositing a second layer of pre-transformed material; and transforming the pre-transformed material in the second layer to connect the at least two spaced apart wire objects, thus forming an enlarged 3D plane. FIGS. 23C-23D shows various examples of plane formation that initiate from two wires. FIG. 23C shows an example of two straight wires 2340 and 2350 respectively, that were formed from the first layer of pre-transformed material. Subsequent (or prior) to disposing the second layer of pre-transformed material, the energy beam may travel along a path 2360 in a first direction 2361, in a second direction, 2362, or both in the first and in the second direction (e.g., intermittently, or by using two energy beams that operate at least in part concurrently or sequentially) to form the 3D plane. FIG. 23D shows two wires comprising a curvature 2370 and 2380 respectively, that were formed from the first layer of pre-transformed material. Subsequent (or prior) to disposing the second layer of pre-transformed material, the energy beam may travel along a path 2390 in a first direction 2391, in a second direction 2392, or both in the first and in the second direction (e.g., intermittently, or using two energy beams) to form the 3D plane according to path 2390. At times, the 3D plane is formed from the material disposed in the first layer of pre-transformed material. At times, the 3D plane is formed from the material disposed in the second layer of pre-transformed material. The methods described herein may further comprise broadening at least one of the of the spaced apart wire objects to form one or more 3D planes. The one or more 3D planes can be suspended (e.g., float anchorlessly) in the material. The formed 3D objects may be spaced apart. For example, the two or more wires may be spaced apart. The 3D plane and the wire may be spaced apart. Two or more 3D planes may be spaced apart. The two or more wires may be suspended (e.g., float anchorlessly) in the first layer of pre-transformed material. The two or more wires may be suspended (e.g., float anchorlessly) in the material bed. The one or more 3D planes may be suspended in the first layer of pre-transformed material. The one or more 3D planes may be suspended in the material bed. The methods described herein may further comprise transforming the pre-transformed material in the second layer to connect the at least two spaced apart objects, thus forming an enlarged 3D plane. The objects may comprise a wire and a 3D plane. The objects may comprise two wires. The objects may comprise two 3D planes.

Another aspect of the present disclosure provides a method for forming a 3D plane comprising depositing a first layer of pre-transformed material in an enclosure to form a material bed; transforming the pre-transformed material to form at least two spaced apart wire objects; broadening at least one of the spaced apart wire objects to form one or more 3D planes, wherein the one or more 3D planes are suspended in the material bed; wherein the objects are spaced apart; depositing a second layer of material; and transforming the material in the second layer to connect at least two of the spaced apart objects, thus forming an enlarged 3D plane.

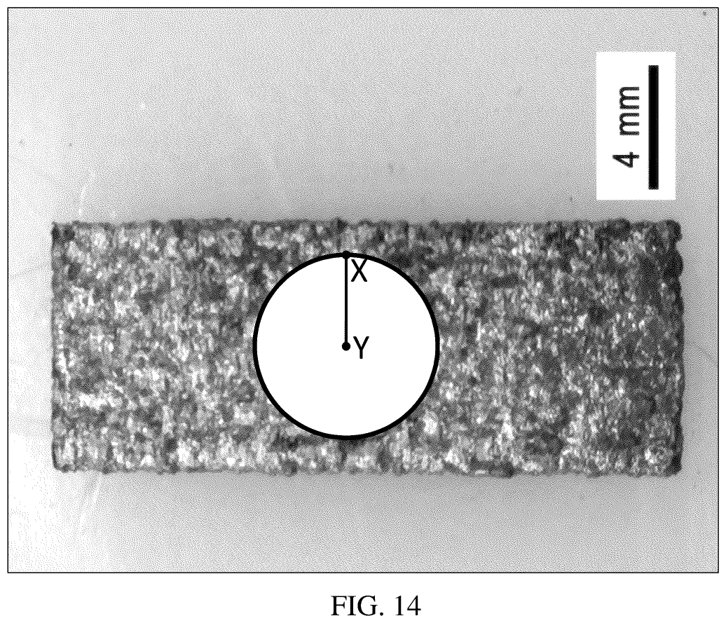

In some examples the average acute angle between the enlarged 3D plane (e.g., during its formation) and the direction normal to the field of gravity is alpha. The enlarged 3D plane may form an angle alpha relative to the plane parallel to the average top leveled surface of the layer of pre-transformed material (e.g., powder material). The enlarged 3D plane may form an angle alpha relative to the plane parallel to the average plane of the top surface of the platform or the bottom of the enclosure facing the deposited pre-transformed material. The 3D plane may be a portion of a 3D object. FIG. 15B shows an example of multiple enlarged 3D plane portions having various alpha angles. Alpha can have any of the alpha values disclosed herein. For example, alpha can be at most about 25°, 30°, or 35°. In some examples the enlarged 3D plane comprises a material structure indicating that the enlarged 3D plane has been formed at an angle alpha relative to the direction normal to the field of gravity. In some examples the enlarged 3D plane comprises a material structure indicating that the enlarged 3D plane has been formed at an angle alpha relative to the plane parallel to the average exposed (e.g., top leveled) surface of the layer of pre-transformed material (e.g., powder). In some examples the enlarged 3D plane comprises a material structure indicating that the enlarged 3D plane has been formed at an angle alpha relative to the plane parallel to the average plane of the top surface of the platform facing the deposited pre-transformed material. In some examples, the shortest distance between points X and Y on the wire is devoid of auxiliary support (e.g., a single auxiliary support or a plurality of auxiliary supports). In some examples, the shortest distance between points X and Y on the 3D plane or wire is devoid of auxiliary support or auxiliary support mark. In some examples, the distance XY designates the radius of a circle or of a sphere that intersects the 3D object, within which the printed 3D object is devoid of auxiliary supports (e.g., FIG. 14). In some examples, the shortest distance between points X and Y on the (enlarged) 3D plane or wire is devoid of auxiliary support. The shortest distance between points X and Y on the (enlarged) 3D plane or wire can have any of the afore mentioned XY values. For example, the shortest distance between points X and Y can be a spacing-distance. The spacing-distance may be by at least about 1.5 millimeters (mm), 2 mm, 3 mm, 4 mm, 5 mm, 10 mm, 15 mm, 20 mm, 25 mm, 30 mm, 35 mm, 100 mm, 200 mm, 300 mm, 400 mm, or 500 mm. The spacing-distance may be at most about 1.5 millimeters (mm), 2 mm, 3 mm, 4 mm, 5 mm, 10 mm, 15 mm, 20 mm, 25 mm, 30 mm, 35 mm, 100 mm, 200 mm, 300 mm, 400 mm, or 500 mm. The spacing-distance may be any value between the aforementioned values (e.g., from about 1.5 mm to about 500 mm, from about 2 mm to about 500 mm, from about 10 mm to about 500 mm, or from about 20 mm to about 500 mm).

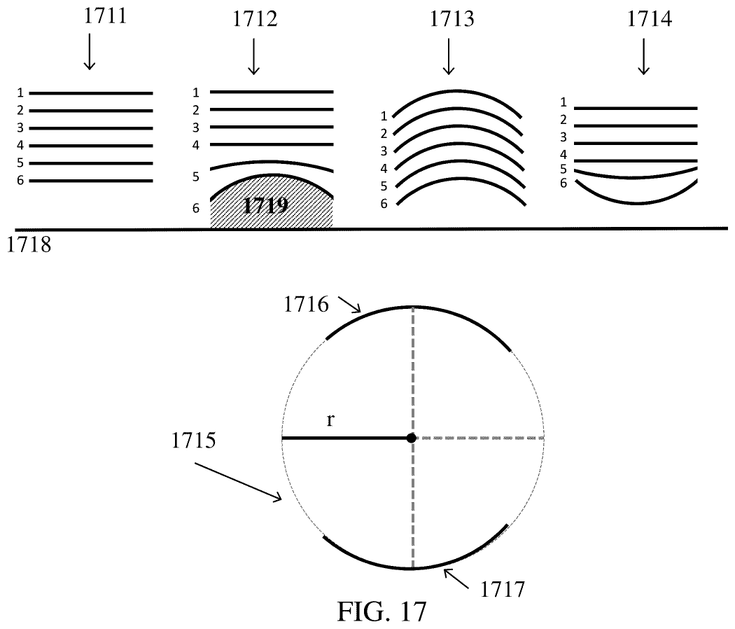

The radius of curvature, “r,” of a curve at a point can be a measure of the radius of the circular arc (e.g., FIG. 17, 1716) which best approximates the curve at that point. The radius of curvature can be the inverse of the curvature. In the case of a 3D curve (also herein a “space curve”), the radius of curvature may be the length of the curvature vector. The curvature vector can comprise of a curvature (e.g., the inverse of the radius of curvature) having a particular direction. For example, the particular direction can be the direction towards the platform (e.g., designated herein as negative curvature), or away from the platform (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line that is not required to be straight. A straight line can be a special case of curved line wherein the curvature is (e.g., substantially) zero. A line of substantially zero curvature has a (e.g., substantially) infinite radius of curvature. A curve can be in two dimensions (e.g., vertical cross section of a plane), or in three-dimension (e.g., curvature of a plane). The curve may represent a cross section of a curved plane. A straight line may represent a cross section of a flat (e.g., planar) plane.

The straight line XY, or the surface having a FLS (e.g., radius) of XY may be (e.g., substantially) flat (e.g., planar). The (e.g., substantially) planar surface may have a large radius of curvature. The straight line XY, or the surface having a FLS of XY may have a radius of curvature of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The straight line XY, or the surface having a FLS of XY may have a radius of curvature of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The straight line XY, or the surface having a FLS of XY may have a radius of curvature between any of the afore-mentioned values of curvature (e.g., from about 0.1 cm to about 100 m, from about 0.1 cm to about 1 m, from about 0.1 cm to about 50 cm, from about 5 cm to about 50 cm, from about 50 cm to about 1.5 m, from about 1 m to about 50 m, or from about 50 m to about 100 m). The radius of curvature of the straight line XY may be normal to the length of the line XY. The curvature of the straight line XY may be the curvature along the length of the line XY.

At least one of the spaced apart wires can be suspended in the material bed. The spaced apart wires can be suspended in the material bed. The spaced apart wires can be suspended in the first layer of pre-transformed material. The spaced apart wires can connect to, anchor to, and/or touch the enclosure. The spaced apart wires can connect to, anchor to, and/or touch the platform. The broadening operation may comprise broadening the wires into 3D planes. The 3D plane can be suspended (e.g., float anchorlessly) in the first layer of pre-transformed material. The at least two spaced apart 3D objects can be at least two spaced apart 3D planes. The at least two spaced apart objects can be at least two spaced apart wires. The at least two spaced apart 3D objects can be at least a wire and a 3D plane that are spaced apart. The broadening operation may utilize one or more energy beams. The 3D objects can be spaced apart by at least 50 micrometers (μm), 100 μm, 200 μm, 300 μm, 400 μm, 500 μm, 600 μm, 700 μm, 800 μm, 900 μm, 1 mm, 1.5 millimeters (mm), 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, or 500 mm. The 3D objects can be spaced apart by at most about 50 μm, 100 μm, 200 μm, 300 μm, 400 μm, 500 μm, 600 μm, 700 μm, 800 μm, 900 μm, 1 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, or 500 mm. The 3D objects can be spaced apart by any value between the above spaced apart values (e.g., from about 50 μm to about 100 cm, from about 50 to about 1 mm, from about 1 mm to about 10 cm, or from about 10 cm to about 100 cm). The spaced apart distance between the 3D objects can be the smallest distance between the spaced apart objects. The broadening operation can comprise transforming the material. The average acute angle between the 3D plane (e.g., during its formation) can about alpha. In some examples the 3D plane comprises a material structure indicating that the 3D plane has been formed at an angle of about alpha. Alpha can be measured relative to the direction normal to the field of gravity or relative to the plane parallel to the average top leveled surface of the layer of material (e.g., powder material). In some examples, alpha can be measured relative to a plane parallel to the average plane of the exposed surface of the material bed, or the surface of the platform facing the material bed. The average acute angle between at least one of the at least two spaced apart wires (e.g., during their formation), can be about beta. Beta can be measured relative to the direction of the field of gravity or relative to a normal to the (i) exposed surface of the material bed, or (ii) platform. In some examples at least one of the at least two spaced apart 3D objects (e.g., wires) comprise a material structure indicating that the at least one of the at least two spaced apart wires have been formed at an angle of about beta. The angle beta can have any of the afore-mentioned values for beta, and measured as delineated herein. For example, beta can be at least about 45 degrees. The FLS (e.g., length) of at least one of the at least two spaced apart 3D objects (e.g., wires) can be at least about 50 micrometers (μm), 100 μm, 200 μm, 300 μm, 400 μm, 500 μm, 600 μm, 700 μm, 800 μm, 900 μm, 1 mm, 1.5 millimeters (mm), 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm 35 mm, 100 mm, 300 mm, 500 mm, 700 mm, or 1000 mm. The FLS (e.g., length) of at least one of the at least two spaced apart 3D objects (e.g., wires) can be at most about 50 μm, 100 μm, 200 μm, 300 μm, 400 μm, 500 μm, 600 μm, 700 μm, 800 μm, 900 μm, 1 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, 500 mm, 700 mm, or 1000 mm. The length of at least one of the at least two spaced apart 3D objects (e.g., wires) can be of any of the aforementioned values (e.g., from about 50 μm to about 1000 mm, from about 50 μm to about 900 μm, or from about 900 μm to about 1000 mm). The largest of a length and a width of the 3D plane can be at least 50 μm, 100 μm, 200 μm, 300 μm, 400 μm, 500 μm, 600 μm, 700 μm, 800 μm, 900 μm, 1 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm 35 mm, 100 mm, 300 mm, 500 mm, 700 mm, or 1000 mm. The largest of a length and a width of the 3D plane can be at most about 50 μm, 100 μm, 200 μm, 300 μm, 400 μm, 500 μm, 600 μm, 700 μm, 800 μm, 900 μm, 1 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, or 500 mm. The largest of a length and a width of the 3D plane can be of any of the aforementioned values (e.g., from about 50 μm to about 500 mm, from about 50 μm to about 900 μm, or from about 900 μm to about 500 mm). The smaller of a length and a width of the 3D plane can be at least about 50 μm, 100 μm, 200 μm, 300 μm, 400 μm, 500 μm, 600 μm, 700 μm, 800 μm, 900 μm, 1 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, 500 mm, 700 mm, or 1000 mm. The smaller of a length and a width of the 3D plane can be at most about 50 μm, 100 μm, 200 μm, 300 μm, 400 μm, 500 μm, 600 μm, 700 μm, 800 μm, 900 μm, 1 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, or 500 mm. The smaller of a length and a width of the 3D plane can be of any value between the values of the largest of a length and a width of the 3D plane (e.g., from about 50 μm to about 1000 mm, from about 50 μm to about 900 μm, or from about 900 μm to about 1000 mm).

The at least two spaced apart wires can be spaced by at least 300 μm, 400 μm, 500 μm, 600 μm, 700 μm, 800 μm, 900 μm, 1 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, 500 mm, 700 mm, or 1000 mm. The at least two spaced apart wires can be spaced by at most about 300 μm, 400 μm, 500 μm, 600 μm, 700 μm, 800 μm, 900 μm, 1 mm, 1.5 m), 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, 500 mm, 700 mm, or 1000 mm. The at least two spaced apart wires can be spaced by any value between the values of the above mentioned space values. The spaced apart 3D planes are spaced by about the afore-mentioned values, which may be the shortest distance between the 3D planes (e.g., from about 300 μm to about 1000 mm, from about 300 μm to about 900 μm, or from about 900 μm to about 1000 mm).

Another aspect of the present disclosure provides a method for forming a 3D plane comprising depositing a layer of pre-transformed material in an enclosure to form a material bed; transforming at least a portion of the material bed to form at least two spaced apart wires; wherein the spaced apart wires are suspended (e.g., float anchorlessly) in the material bed; broadening each of the spaced apart wires to each form a 3D plane that is suspended in the layer of material, thus forming at least two spaced apart 3D planes; depositing an additional layer of material above the at least two 3D planes; and transforming the material in the additional layer to connect the at least two 3D planes, thus forming an enlarged 3D plane.

Another aspect of the present disclosure provides a method for forming a 3D plane comprising depositing a first layer of pre-transformed material adjacent to (e.g., above) a platform to form a material bed; transforming at least a portion of the material bed to form at least two spaced apart wires; wherein the spaced apart wires are suspended (e.g., float anchorlessly) in the material bed; broadening each of the spaced apart wires to each form a 3D plane that is suspended (e.g., float anchorlessly) in the material bed, thus forming at least two spaced apart 3D planes; depositing a second layer of pre-transformed material adjacent to (e.g., above) the at least two 3D planes; and transforming at least a portion of the pre-transformed material in the second layer to connect the at least two 3D planes, thus forming an enlarged 3D plane; wherein the average acute angle between the enlarged 3D plane during its formation is alpha (e.g., 30 degrees or less). Alpha can be measured relative to a plane parallel to the average exposed (e.g., top leveled) surface of the material bed (e.g., powder bed). Alpha can be measured relative to the plane parallel to the average plane of the top surface of the enclosure or the platform facing the deposited material bed. Alpha can be measured relative to a normal to the direction of the field of gravity.

In some examples, the enlarged 3D plane can be suspended (e.g., float anchorlessly) in the material. The enlarged 3D plane can float anchorlessly in the first layer or in the second layer of pre-transformed material. The enlarged 3D plane can float anchorless in the first layer and in the second layer. The wire, 3D plane and/or enlarged 3D plane may comprise auxiliary support (e.g., one or more auxiliary supports) that are suspended anchorlessly in the material bed. The auxiliary support can be suspended (e.g., float anchorlessly) in the first layer or in the second layer of pre-transformed material. The auxiliary support can be suspended in the first layer and in the second layer of pre-transformed material. The shortest distance between two auxiliary supports can be at least about 1 mm, 1.5 millimeters (mm), 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, or 500 mm. The shortest distance between the two auxiliary supports can be at most about 1 mm, 1.5 millimeters (mm), 1.6 mm, 1.7 mm, 1.8 mm, 1.9 mm, 2.0 mm, 2.1 mm, 2.2 mm, 2.3 mm, 2.4 mm, 2.5 mm, 3 mm, 4 mm, 5 mm, 10 mm, 15 mm, 20 mm, 25 mm, 30 mm, 35 mm, 100 mm, 300 mm, or 500 mm. The shortest distance between the two auxiliary supports can be any value between the above shortest distance values between the two auxiliary supports (e.g., from about 1 mm to about 10 mm, from about 10 mm to about 100 mm, from about 100 mm to about 500 mm, from about 1 mm to about 500 mm, or from about 2 mm to about 30 mm). Suspended (e.g., float anchorlessly) in the material bed remainder can comprise suspended in the first layer of pre-transformed material. Transforming the material in the second layer to connect the at least two 3D planes may comprise transforming the material along a path. The path may overlap the at least two 3D planes. The path may overlap the at least one of the at least two 3D planes. The path may be any of the paths mentioned herein. At times, the path may not overlap the at least one of the at least two 3D planes. At times path does not overlap the at least two 3D planes. The broadening operation may comprise transforming at least a portion of the material bed. The average acute angle of the 3D plane (e.g., during its formation) may be about alpha (e.g., at most about 30 degrees). Alpha can have any value mentioned herein, and measured relative to the vectors or planes described herein respectively. In some examples the 3D plane comprises a material structure indicating that the 3D plane has been formed at an acute angle alpha. The average acute angle between at least one of the at least two spaced apart wires (e.g., during their formation) can be beta. Beta can have any value mentioned herein, and measured relative to the vectors or normal to planes as described herein respectively. In some examples the 3D plane comprises a material structure indicating that the at least one of the at least two spaced apart wires were formed at an acute angle beta.

The distance of the spaced apart 3D planes may be the shortest distance between the two 3D planes. The second layer of pre-transformed material can be deposited directly adjacent to (e.g., above) the first layer of pre-transformed material. In some cases, there is no intervening layer of pre-transformed material between the first and the second layers of pre-transformed material. In some cases, there is at least one intervening layer of pre-transformed material between the first and the second layers of material.

Another aspect of the present disclosure provides a method for forming a suspended object comprising depositing a first layer of pre-transformed material adjacent to (e.g., above) a platform to form a material bed; transforming a portion of the pre-transformed material to form at least two spaced apart objects; wherein the spaced apart objects are suspended in the material bed; depositing a second layer of pre-transformed material adjacent to (e.g., above) the at least two spaced apart objects; and transforming at least a portion of the pre-transformed material in the second layer to connect the at least two space apart objects, thus forming an enlarged object. In some instances, the average acute angle of the enlarged 3D plane (e.g., during its formation) is alpha. At times the 3D plane comprises a material structure indicating that it has been formed at an average acute angle relative to the direction normal to the field of gravity, relative to the plane parallel to the average top leveled surface of the layer of material (e.g., powder material), or relative to the plane parallel to the average plane of the top surface of the container, the substrate or the base facing the deposited material. Alpha can be any of the values mentioned supra. For example, alpha can be at most about 30 degrees or less. Suspended may comprise floating anchorlessly in the material bed.

The 3D object can comprise wires. The 3D object can be wires. The 3D object can comprise 3D planes. The 3D object can be 3D planes. The objects can comprise 3D planes and wires. The enlarged 3D object can comprise a 3D plane. The enlarged 3D object can comprise a wire. The enlarged 3D object can be a 3D object. Prior to depositing the second layer of pre-transformed material, the methods described herein may further comprise, depositing a third layer of pre-transformed material. Prior to depositing the second layer of pre-transformed material, and after the operation of transforming a portion of the pre-transformed material to form at least two spaced apart objects, the methods can further comprise, depositing a third layer of material. Prior to depositing the second layer of pre-transformed material, the methods described herein can further comprise, transforming at least a portion of the third layer of pre-transformed material, to broaden the wire. Prior to depositing the second layer of pre-transformed material, the methods can further comprise broadening at least one of the spaced apart wires to form a 3D plane that is suspended (e.g., anchorlessly floating) in the material bed, thus forming at least two spaced apart objects (e.g., a wire and a 3D plane), or a 3D plane (e.g., a plane). Prior or subsequent to depositing the second layer of pre-transformed material, the methods can further comprise broadening at least one of the spaced apart wires to form a 3D plane that is suspended (e.g., anchorless floating) in the material bed, thus forming at least two spaced apart objects (e.g., a wire and a 3D plane), or a 3D plane (e.g., a plane). FIG. 23A shows a straight wire 2310, that was formed from the first layer of pre-transformed material. Prior or subsequent to disposing the second layer of pre-transformed material, the energy beam may travel along a path 2320 in a direction 2321 to form the 3D plane according to path 2320. FIG. 23B shows a wire comprising a curvature 2330, that was formed from the first layer of pre-transformed material. Prior or subsequent to disposing the second layer of pre-transformed material, the energy beam may travel along a path 2340 in a direction 2341 to form the 3D plane according to path 2340. The energy beam may form the 3D plane by transforming at least a portion of the pre-transformed material into a transformed material, while traveling along the designated plane path (e.g., as in the examples of FIG. 1A-1F). Prior to depositing the second layer, the methods described herein can further comprise, broadening each of the spaced apart wires to each form a 3D plane that is suspended (e.g., floating anchorlessly) in the material bed, thus forming at least two spaced apart 3D planes. The material bed may comprise flowable pre-transformed material before, during, and after the 3D printing process. The flowable pre-transformed material may comprise powder material, gel, or liquid material. The flowable pre-transformed material may be drained (e.g., using gravity) from the container at the end of the printing process. The printed 3D object may be retrieved from the flowable pre-transformed material at the end of the printing process. The flowable pre-transformed material may flow off the printed 3D object on retrieval of the printed 3D object from the material bed.

The powder can be configured to provide support to the 3D object as it is formed in the powder bed by the 3D printing process. In some instances, a low flowability powder can be capable of supporting a 3D object better than a high flowability powder. A low flowability powder can be achieved inter alia with a powder composed of relatively small particles, with particles of non-uniform size or with particles that attract each other. The powder may be of low, medium or high flowability. The powder material may have compressibility of at least about 1%, 2%, 3%, 4%, 5%, 6%, 7%, 8%, 9%, or 10% in response to an applied force of 15 kilo Pascals (kPa). The powder may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The powder may have a basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The powder may have a basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The powder may have basic flow energy in between the above listed values of basic flow energy. For example, the powder may have a basic flow energy from about 100 mj to about 1000 mJ, from about 100 mj to about 600 mJ, or from about 500 mj to about 1000 mJ. The powder may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The powder may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The powder may have a specific energy in between any of the above values of specific energy. For example, the powder may have a specific energy from about 1.0 mJ/g to about 5.0 mJ/g, from about 3.0 mJ/g to about 5 mJ/g, or from about 1.0 mJ/g to about 3.5 mJ/g.

Another aspect of the present disclosure provides an object comprising a first layer of hardened material comprising spaced apart sections of transformed material formed by at least one 3D printing (e.g., additive manufacturing) method; and a second layer of hardened material adjacent to the first layer of material; wherein the second layer connects the spaced apart sections to form at least a part of an object; wherein the average plane between the second layer and the spaced apart sections of the first layer is an average layering plane; wherein the average acute angle between the direction normal to the field of gravity and the average layering plane (e.g., during its formation) is alpha; wherein a shortest distance between points X and Y on the surface of the at least a part of an object are devoid of auxiliary support and/or auxiliary support marks. FIG. 14 shows an example of a printed 3D object on which points X and Y are marked, as well as the shortest distance XY and a radius of a circle with a radius XY. The shortest distance can have any of the afore-mentioned values of the distance between X and Y.

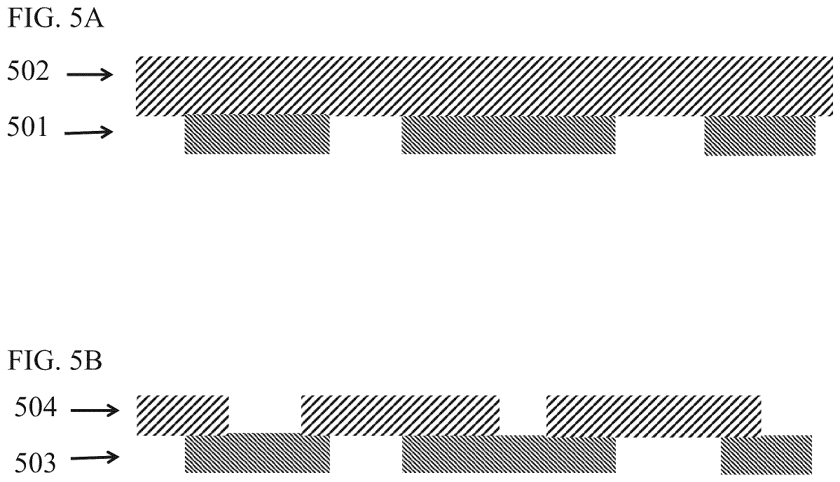

Another aspect of the present disclosure provides a 3D object comprising a first layer of hardened material comprising spaced apart sections of transformed material formed by at least one 3D printing (e.g., additive manufacturing) method; wherein the first layer comprises successive regions of hardened material indicative of a 3D printing process conducted in a first average plane; and a second layer of hardened material adjacent to the first layer of hardened material; wherein the second layer comprises successive regions of hardened material indicative of a 3D printing process conducted in a second average plane; wherein the second layer connects the spaced apart sections to form at least a part of a 3D object. FIGS. 5A-5B depict examples of vertical cross sections of 3D objects. FIG. 5A shows an example of a vertical cross section of a second continuous layer hardened and/or transformed material, and FIG. 5B shows an example of a vertical cross section in a second discontinuous layer of hardened and/or transformed material. Examples of vertical cross sections of spaced apart hardened and/or transformed material (or spaced apart 3D objects) in a first layer are provided in 501 and 503. The spaced apart hardened and/or transformed material may comprise disconnected portions of hardened and/or transformed material. The spaced apart hardened and/or transformed material may comprise porous material that is connected into a porous plane of hardened and/or transformed material. In some examples, the desired 3D plane may have pores. The porous layer of hardened material may contain at least about 99%, 97%, 95%, 903%, %, 85%, 80%. 75%, 70%, or 60% material relative to the total volume of the layer of hardened material (v/v). The porous layer of hardened material may contain an amount of material between the aforementioned percentages relative to the total volume of the layer of hardened material (v/v) (e.g., from about 99% to about 60%, from about 99% to about 95%, from about 95% to about 85%, or from about 85% to about 60%). The second connecting layer of hardened and/or transformed material can be continuous or discontinuous. An example of a vertical cross section of the second connecting layer of hardened and/or transformed material that is continuous is provided in 502. An example of a vertical cross section of the second connecting layer of hardened and/or transformed material that is discontinuous is provided in 504. The spaced apart sections (e.g., in the first or second layer of hardened and/or transformed material) may be spaced by any of the spacing-distance disclosed herein. The spaced apart distance may be the shortest spaced apart distance.

The first layer of hardened material can comprise a wire. The first layer of hardened material may be a disconnected wire. The first layer of hardened material may comprise a 3D plane. The first layer of hardened material may comprise a disconnected 3D plane. The 3D object can be a 3D plane. The 3D object can comprise a 3D plane. The second layer of hardened material adjacent to the first layer of hardened material can be above the first layer. Adjacent can be above.

Another aspect of the present disclosure provides a 3D object comprising a first layer of hardened material comprising spaced apart sections; wherein the spaced apart sections comprise first successive regions of hardened material indicative of a 3D printing (e.g., additive manufacturing) process; a second layer of hardened material adjacent to the first layer of material; wherein the second layer of hardened material comprise second successive regions of hardened material indicative of an additive manufacturing process; wherein the second layer connects the spaced apart sections to form at least a part of an object; wherein a shortest distance between points X and Y on the surface of the at least a part of an object are devoid of auxiliary supports and/or auxiliary support marks; and wherein a material structure of the first or of the second successive regions of hardened material indicates that the successive regions of hardened material have been formed at an acute angle alpha with a normal to the gravitational field.

Another aspect of the present disclosure provides an object comprising a first layer of hardened material comprising spaced apart sections; wherein the spaced apart sections comprise successive regions of hardened material indicative of 3D printing (e.g., additive manufacturing) process; wherein a material structure of the successive regions of hardened material indicate that the layers of hardened material (e.g., comprising the spaced apart sections) have been formed at an acute angle alpha relative to a normal to the gravitational field; a second layer of hardened material adjacent to the first layer of hardened material; wherein the second layer connects the spaced apart sections to form at least a part of a 3D object; wherein a shortest distance between points X and Y on the surface of the at least a part of the 3D object are devoid of at least one auxiliary support mark. The regions can be melt pools.

Another aspect of the present disclosure provides a 3D object comprising a first layer of hardened material comprising spaced apart sections; and a second layer of hardened material adjacent to the first layer of material; wherein the second layer of hardened material comprises successive regions of hardened material indicative of a 3D printing (e.g., additive manufacturing) process; wherein a material structure of the successive regions of hardened material indicates that the second layer of hardened material was formed at an acute angle alpha with the gravitational field; wherein the second layer of hardened material connects the spaced apart sections to form at least a portion of the 3D object; wherein a shortest distance between points X and Y on the surface of the at least a part of the 3D object are devoid of at least one auxiliary support mark. The regions can be melt pools. The shortest distance between points X and Y described herein can be any of the above-mentioned shortest distance XY, or any of the spacing-distance disclosed herein. In some examples, the distance XY designates the radius of a circle or sphere that intersects the printed 3D object, which surface at or within the intersection is devoid of auxiliary support and/or auxiliary support mark. In some examples, the shortest distance between points X and Y on the 3D plane is devoid of auxiliary support marks.

The energy beam may include radiation comprising electromagnetic, electron, positron, proton, plasma, or ionic radiation. The electromagnetic beam may comprise microwave, infrared, ultraviolet, or visible light radiation. The ion beam may include a cation or an anion. The electromagnetic beam may comprise a laser beam. The energy beam may derive from a laser source. The laser may comprise a fiber laser, a solid-state laser, or a diode laser. The laser may be a fiber laser. The laser may be a solid-state laser. The laser can be a diode laser. The energy source may comprise a diode array. The energy source may comprise a diode array laser. The laser may be a laser used for micro laser sintering. The energy beam (e.g., laser) may have a power of at least about 0.5 Watt (W), 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy beam may have a power of at most about 0.5 W, 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy beam may have a power between any of the afore-mentioned laser power values (e.g., from about 0.5 W to about 100 W, from about 1 W to about 10 W, from about 100 W to about 1000 W, from about 50 W to about 120 W, or from about 1000 W to about 4000 W).

The energy beam may travel at a low or high speed. The energy beam may travel at a high speed. The energy beam may travel at a low speed. The scanning speed of the energy beam (e.g., first and/or second energy beam) may be at least about 1 millimeter per second (mm/sec), 2 mm/sec, 3 mm/sec, 4 mm/sec, 5 mm/sec, 6 mm/sec, 7 mm/sec, 8 mm/sec, 9 mm/sec, 10 mm/sec, 12 mm/sec, 14 mm/sec, 15 mm/sec, 16 mm/sec, 18 mm/sec, 20 mm/sec. 25 mm/sec, 30 mm/sec, 40 mm/sec, 50 mm/sec, 100 mm/sec, 500 mm/sec, 1000 mm/sec, 2000 mm/sec, 3000 mm/sec, 4000 mm/sec, or 50000 mm/sec. The scanning speed of the energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the energy beam may any value between the aforementioned values (e.g., from about 1 mm/sec to about 50000 mm/sec, from about 1 mm/sec to about 50 mm/sec, from about 1 mm/sec, to about 4 mm/sec, from about 4 mm/sec to about 20 mm/sec, or from about 20 mm/sec to about 50 mm/sec, from about 50 mm/sec to about 3000 mm/sec, or from about 2000 mm/sec to about 50000 mm/sec). The energy beam may be continuous or non-continuous (e.g., pulsing). The energy beam may be modulated before and/or during the formation of a transformed material as part of the 3D object. The energy beam may be modulated before and/or during the 3D printing process. The energy beam may derive from an electron gun. The velocity of travel may be substantially constant. The velocity of travel may be non-constant. The travel may be on the exposed surface of the material bed (e.g., powder bed), or close to the exposed surface of the material bed. The energy may penetrate to within the material bed.

The first and second energy beam may have the same power. The first and second energy beams may have different powers. The first and second energy beam may have the power of the energy beam mentioned herein. The energy beam may travel at a low speed. The first energy beam and/or the second energy beam may travel at a velocity of at least about 1 millimeter per second (mm/sec), 2 mm/sec, 3 mm/sec, 4 mm/sec, 5 mm/sec, 6 mm/sec, 7 mm/sec, 8 mm/sec, 9 mm/sec, 10 mm/sec, 12 mm/sec, 14 mm/sec, 15 mm/sec, 16 mm/sec, 18 mm/sec, 20 mm/sec. 25 mm/sec, 30 mm/sec, 40 mm/sec, 50 mm/sec or more. The first energy beam and/or the second energy beam may travel at a velocity of at most about 1 millimeter per second (mm/sec), 2 mm/sec, 3 mm/sec, 4 mm/sec, 5 mm/sec, 6 mm/sec, 7 mm/sec, 8 mm/sec, 9 mm/sec, 10 mm/sec, 12 mm/sec, 14 mm/sec, 15 mm/sec, 16 mm/sec, 18 mm/sec, 20 mm/sec, 25 mm/sec, 30 mm/sec, 40 mm/sec, 50 mm/sec or less. The first energy beam and/or the second energy beam may travel at a velocity between any of the afore-mentioned velocity values (e.g., from about 1 mm/sec to about 50 mm/sec, from about 1 mm/sec, to about 4 mm/sec, from about 4 mm/sec to about 20 mm/sec, or from about 20 mm/sec to about 50 mm/sec). The first and second energy beam may travel at substantially the same velocity. The first and second energy beams may travel at different velocities. The velocity of travel may be substantially constant. The velocity of travel may be non-constant. The travel may be on the exposed surface of the material bed (e.g., powder bed), or close to the exposed surface of the material bed. The energy may penetrate to within the material bed.

The energy beam may include a pulsed energy beam, a continuous wave energy beam or a quasi-continuous wave energy beam. The pulse energy beam may have a frequency of at least about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHz, 3 MHz, 4 MHz, or 5 MHz. The pulse energy beam may have a frequency between any of the afore-mentioned repetition frequencies. The apparatus or systems disclosed herein may comprise Q-switching, mode coupling or mode locking to effectuate the pulsing energy beam. The apparatus or systems disclosed herein may comprise an on/off switch, a modulator or a chopper to effectuate the pulsing energy beam. The on/off switch can be manually or automatically controlled. The switch may be controlled by the control system. The switch may alter the “pumping power” of the energy beam.

The energy beam (e.g., laser) may have a FLS (e.g., diameter) of at least about 1 micrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam (e.g., laser) may have a FLS (e.g., diameter) of at most about 1 micrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam (e.g., laser) may have a diameter between any of the afore-mentioned energy beam diameters. (e.g., from about 1 μm to about 500 μm, from about 50 μm to about 250 μm, from about 250 μm to about 400 μm, or from about 400 μm to about 500 μm). The energy beam may be a focused beam. The energy beam may be a de-focused (e.g., blurred) beam. The energy beam may comprise a focused cross section. The energy beam may comprise a de-focused cross section. The energy beam may be an aligned beam. The energy beam may be focused or defocused. The apparatus and/or systems described herein may further comprise a focusing coil, a deflection coil, or an energy beam power supply.

The powder density (e.g., power per unit area) of the energy beam may at least about 10 W/mm², 50 W/mm², 100 W/mm², 120 W/mm², 150 W/mm², 200 W/mm², 500 W/mm², 1000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The powder density of the energy beam may be at most about 20 W/mm², 50 W/mm², 100 W/mm², 120 W/mm², 150 W/mm², 200 W/mm², 500 W/mm², 10000 W/mm², 20000 W/mm², 30000 W/mm², 50000 W/mm², 60000 W/mm², 70000 W/mm², 80000 W/mm², 90000 W/mm², or 100000 W/mm². The powder density of the energy beam may be any value between the aforementioned values (e.g., from about 10 W/mm² to about 100000 W/mm², from about 10 W/mm² to about 100 W/mm², from about 10 W/mm² to about 200 W/mm², from about 50 W/mm² to about 200 W/mm², from about 150 W/mm² to about 1000 W/mm², from about 1000 W/mm² to about 10000 W/mm², from about 10000 W/mm² to about 50000 W/mm², or from about 50000 W/mm² to about 100000 W/mm²).

The systems and/or the apparatus described herein can further comprise at least one energy source. In some cases, the system and/or apparatus can further comprise two, three, four, five or more energy sources. In some cases, the system and/or apparatus can have only a first energy source. An energy source can be a source configured to deliver energy to an area (e.g., a confined area). An energy source can deliver energy to the confined area through radiative heat transfer. The energy beam may include a radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy source may include a laser source. The energy source may include an electron gun or any other energy source capable of delivering energy to a point or to an area. In some embodiments the energy source can be a laser. The energy source may comprise an array of lasers. In an example, a laser can provide light energy at a peak wavelength of at least about 100 nanometer (nm), 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy beam can be incident on the top surface of the material bed. The energy beam can be incident on, or be directed to, a specified area of the material bed (e.g., a portion of the material bed) over a specified time period. The material bed can absorb the energy from the incident energy beam and, as a result, a region (e.g., localized region) of the material in the material bed can increase in temperature. The energy beam and/or source can be moveable such that it can translate relative to the top surface of the material bed. The material bed can be moveable such that it can translate relative to the laser beam. The energy beam, energy source, and/or material bed can be moved via a galvanometer, a polygon a mechanical stage or any combination of thereof. The energy beam, energy source, and/or material bed can be movable with a scanner. The energy beams and/or sources can be translated independently of each other or in concert with each other. In some cases, the energy beams can be translated at different rates such that the movement of the one is faster compared to the movement of at least one other energy beam. In some cases, the energy sources can be translated at different rates such that the movement of the one is faster compared to the movement of at least one other energy source. In some cases, the energy sources can be translated at different paths. In some cases, the energy sources can be translated at (e.g., substantially) similar (e.g., identical) paths. In some cases, the energy sources can follow one another in time and/or space. In some cases, the energy sources translate substantially parallel to each other in time and/or space.

An energy beam from the energy source can be incident on, or be directed to, the exposed surface of the material bed. The energy beam can be directed to a specified area in the material bed for a specified time period. The material in the material bed can absorb the energy from the energy source, and as a result, a localized region of the material can increase in temperature. The energy source and/or beam can be moveable such that it can translate relative to the surface. In some instances, the energy source may be movable such that it can translate across (e.g., laterally) the top surface of the material bed. The energy beam(s) and/or source(s) can be moved via a scanner. The scanner may comprise a galvanometer scanner, a polygon, a mechanical stage (e.g., X-Y stage), a piezoelectric device, gimble, or any combination of thereof. The galvanometer may comprise a mirror. The scanner may comprise a modulator. The scanner may comprise a polygonal mirror. The scanner can be the same scanner for two or more energy sources and/or beams. At least two (e.g., each) energy source and/or beam may have a different scanner. At least two (e.g., each) energy source and/or beam may have the same scanner. The energy sources can be translated independently of each other. In some cases, at least two energy sources and/or beams can be translated at different rates, and/or along different paths. For example, the movement of the first energy source may be faster (e.g., greater rate) as compared to the movement of the second energy source. The systems and/or apparatuses disclosed herein may comprise one or more shutters (e.g., safety shutters). The energy beam(s), energy source(s), and/or the platform can be moved by the scanner. The galvanometer scanner may comprise a two-axis galvanometer scanner. The scanner may comprise a modulator (e.g., as described herein). The energy source(s) can project energy using a DLP modulator, a one-dimensional scanner, a two-dimensional scanner, or any combination thereof. The energy source(s) can be stationary or translatable. The energy source(s) can translate vertically, horizontally, or at an angle (e.g., planar or compound angle). The energy source(s) can be modulated. The scanner can be included in an optical system. The optical system may be configured to direct energy from the energy source to a predetermined position on the target surface (e.g., exposed surface of the material bed). The controller can be programmed to control a trajectory of the energy source(s) with the aid of the optical system. The controller can regulate a supply of energy from the energy source to the material (e.g., at the target surface) to form a transformed material.

The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

The transformation of the pre-transformed material may be to a liquefied state or to a liquidus state. In some examples, the broadening (e.g., of the wire or of the 3D plane) may be performed when at least part of the 3D object to be broadened (e.g., wire) is in a liquefied state. For example, the broadening may be performed when at least the rim of the 3D object to be broadened (e.g., wire) is in a liquefied state. The rim may comprise the outer edge, border, margin, frame or brink of the 3D object to be broadened (e.g., wire). At times, only material in one layer is transformed to at least a liquefied state. At times, hardened material in one layer of the generated 3D object and in at least one adjacent (e.g., lower) layer of hardened material in the generated object is transformed to a liquid state. At times, hardened material in one layer of the generated object and in at least one adjacent (e.g., lower) layer of the generated object is transformed to at least a liquefied state. The one adjacent layer may be the bottom skin layer. At times, pre-transformed material in a layer of pre-transformed material (e.g., in the material bed) is transformed to a liquefied and/or liquidus state. At times, pre-transformed material in a layer of pre-transformed material (e.g., in the material bed) and in at least one adjacent (e.g., lower) layer of hardened material in the generated 3D object is transformed to a liquefied and/or liquidus state. The one adjacent layer of hardened material may be the bottom skin layer.

In some examples, the broadening of the wire comprises utilizing the energy beam. In some examples, an energy beam is utilized to broaden the printed structure (e.g., the wire or the 3D plane). The energy beam may return to (e.g., substantially) the position at which the pre-transformed material was transformed, in order to broadened the structure (e.g., formed 3D object) within at most about 0.1 milliseconds (msec), 0.2 msec, 0.3 msec, 0.4 msec, 0.5 msec, 0.6 msec, 0.7 msec, 0.8 msec, 0.9 msec, 1 msec, 2 msec, 3 msec, 4 msec, 5 msec, 6 msec, 7 msec, 8 msec, 9 msec, 10 msec, 11 msec, 12 msec, 13 msec, 14 msec, 15 msec, 16 msec, 17 msec, 18 msec, 19 msec, 20 msec, 22 msec, 25 msec, 28 msec, 30 msec, 31 msec, 32 msec, 35 msec, 38 msec, or 40 msec. The energy beam may return to (e.g., substantially) the position at which the pre-transformed material was transformed, in order to broadened the structure (e.g., formed 3D object) within any of the afore mentioned return times (e.g., from about 0.1 msec to about 40 msec, from about 0.1 msec to about 15 msec, from about 0.1 msec to about 10 msec, from about 10 msec to about 15 msec, from about 15 msec to about 30 msec, or from about 30 msec to about 40 msec). The energy beam can travel at a speed of at least about 500 mm/sec and have a power of at least about 200 Watt. The energy beam can travel at a speed of at most about 1000 mm/sec and have a power of at most about 400 Watt.

Occasionally, the broadening of the wire comprises using a first and a second energy beam. The first energy beam can form the wire though transforming the pre-transformed material (e.g., powder material). The second energy beam can ensure that at least a part of the 3D object to be broadened remains in at least a liquefied state when the first energy beam returns to that (e.g., approximate) position to broaden the 3D object. The second energy beam can ensure that at least a part of the 3D object to be broadened does not entirely solidify when the first energy beam returns to that (e.g., approximate) position to broaden the 3D object. In some examples, the second energy beam projects energy on to the formed 3D object to be broadened such that at least a portion of the 3D object to be broadened remains in at least a liquefied state (e.g., a liquid state). In some examples, the second energy beam projects energy on to the formed wire such that only a portion of the wire transforms into a hardened (e.g., solid) state. The second energy beam can travel along the 3D object to be broadened (e.g., wire) one or more times. The second energy beam can travel along the 3D object to be broadened at least one time to ensure that at least the rim of the 3D object to be broadened is in at least a liquefied state. The second energy beam can travel along the 3D object to be broadened at least one time to ensure that at least the rim of the 3D object to be broadened does not solidify. The second energy beam can project energy onto the 3D object to be broadened to ensure that a portion of the 3D object to be broadened is in at least a liquefied state until the first energy beam reaches that area; at which point the first energy beam transforms the pre-transformed material (e.g., the powder) in the material bed to broaden the wire. The second energy beam can project energy onto the 3D object to be broadened to ensure that at least a portion of the 3D object to be broadened does not harden (e.g., solidify) until the first energy beam reaches that portion; at which point the first energy beam transforms the pre-transformed material (e.g., powder) in the material bed to broaden the 3D object to be broadened. The second energy beam can project energy onto the 3D object to be broadened to ensure that a portion of the 3D object to be broadened is in at least a liquefied state, until the first energy beam reaches that portion; at which point the first energy beam fuses (e.g., melts or sinters) the powder material to broaden the 3D object to be broadened. The material that is transformed by the first energy beam may merge onto the material that is maintained in at least a liquefied state (e.g., liquid state) by the second energy beam. The material that is transformed by the first energy beam may merge onto the material that is maintained in a non-solid (e.g., liquidus or liquefied) state by the second energy beam.

In some examples, the first and second energy beams have substantially the same wavelength. In some examples, the first and second energy beams have different wavelengths. In some examples, the first energy beam has a wavelength that is smaller than the wavelength of the second energy beam. In some examples, the first energy beam has a wavelength that is larger than the wavelength of the second energy beam. The first and/or second energy beam can provide energy at a peak wavelength of at least about 100 nanometer (nm), 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. The first and/or second energy beam can provide energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, or 100 nm. The first and/or second energy beam can provide energy at a peak wavelength between any of the afore-mentioned peak wavelength values (e.g., from about 100 nm to about 2000 nm, from about 500 nm to about 1500 nm, or from about 1000 nm to about 1100 nm). The first and second energy beams can derive from the same energy source. The first energy beam and the second energy beam can derive from different energy sources. The second energy source may project energy to maintain the 3D object to be broadened in at least a liquefied state (e.g., a liquid state). The second energy source may project energy to maintain the 3D object to be broadened in a non-solid state. The second energy source may project energy to liquefy (e.g., melt) a hardened portion of the 3D object to be broadened and transform at least part of it (e.g., its rim) to at least a liquefied state (e.g., a liquid state). The hardened portion may comprise a solidified portion. The hardened portion may be a solidified portion. The broadening of the 3D object to be broadened may be performed when at least part of the 3D object to be broadened is in a liquid state. The methods described herein may further comprise repeating the broadening operation. In a repeated broadening operation, the wire broadening may be substituted by the broadening of a 3D plane. The 3D plane may have been previously formed by broadening of a wire into the 3D plane. For example, the wire may form an edge of a 3D plane. For example, the rim of the wire may become the rim of the 3D plane. For example, the second energy beam may ensure that at least part of the rim of the 3D object remains in a liquid state. For example, the second energy beam may ensure that at least part of the rim of the 3D plane remains in a non-solid state. The second energy beam may liquefy (e.g., melt) at least a part of the rim of the 3D plane. The methods described herein may further include a third, fourth, fifth, sixth or more energy beams. The energy beams can all derive from a single energy source. In some examples, at least two energy beams may derive from two different energy sources respectively. The rim may be a perimeter, an edge, or a frame of the formed 3D object.

The methods described herein may further comprise repeating the operations of pre-transformed material deposition and material transformation operations to produce a 3D object (or a part thereof) by at least one additive manufacturing method. For example, the methods may further comprise repeating the operations of depositing a layer of pre-transformed material to form a material bed, and transforming at least part of the material bed to connect to the previously formed 3D object, thus forming at least a portion of a desired 3D object. The transforming operation may comprise utilizing an energy beam to transform the material. In some instances, the energy beam is utilized to melt at least part of the material (e.g. powder). The energy beam may follow a path as described herein. The path of the energy beam in a subsequent layer (e.g. in a second, third, and/or forth, etc. layer) may follow the same path of the energy beam in layer one. Layer one may be the first printed layer, or any other layer designated as a “layer one.” The paths of the first and of the subsequent layer may coincide, as viewed from above or below the layering plane. The paths of layer one and of the subsequent layer may be transposed relative to each other, as viewed from above or below the layering plane. The transposition may be a vertical or horizontal transposition. Viewed from above or from below the formed planes of transformed material, the vertical or horizontal path transposition may cause at least a part of a path of the subsequent layer to travel within a gap in the path of layer one. For example, at least a part of the path of the subsequent layer may travel within the distance “ [symbol] ” in FIGS. 1A and 1C-1F; 101, 103, 104, 105 or 106 of layer one, as viewed from above or below the layer plane. Viewed from above or from below the formed planes of transformed material (e.g., top view or bottom view), the path transposition may be an angular transposition. Viewed from above or from below the formed planes of transformed material (e.g., top view or bottom view), the angular transposition may cause the path pertaining to the subsequent layer to cross at least once with the path of the first layer. The path transposition at any successive layer may be substantially the same path transposition. For example, if the path transposition at layer number two is of an angle value relative to a previous layer (e.g., layer number one), then the transposition at a successive layer to layer number two (e.g., layer number three) will be at the same angle value relative to the plane of layer number two. The transposition at any successive layer may be a different path transposition. Some of the layer paths forming the at least a portion of the desired 3D object may not be transposed. At times, only a section of a plane of transformed material within the at least part of the 3D object, may be formed using a transposed path. The path transpositions in the successive layers may follow a pattern. The pattern may be a linear pattern. The pattern may be a non-linear pattern. In comparison with a 3D object generated without transposition of successive paths (e.g. with coinciding paths of each transformed layer in the 3D object), the 3D object formed using any of the path transposition methods described herein may comprise at least one surface that is more leveled, smoother, with a lower degree of roughness, flatter, with a lower degree of warpage, with a lower degree of bending, with a larger radius of curvature, or any combination thereof. In comparison with a 3D object produced without transposition of the successive paths the formation of valleys (e.g., rows of valleys) or ridges (e.g., rows of ridges) in at least one surface are substantially reduced or prevented in the object formed with path transposition. The successive paths may form successive layers of hardened material respectively. The at least one surface may be a top, bottom or side surface with respect to the building direction of the 3D object (e.g., with respect to the building platform). In comparison to a 3D object produced without transposition of the successive paths, the object formed using path transposition may be comprised of at least one surface with a lower degree of roughness, Ra value, with lower degree of deviation from ideal flatness (e.g. molecular or atomic flatness), with smaller number of depressions per unit area, with smaller number of protrusions per unit area, or any combination thereof. In comparison to a 3D object produced without transposition of the successive paths, the 3D object formed using path transposition may be a denser object (3D object or a part thereof), a less brittle object, an object with a lower percentage of holes, or any combination thereof. The path of the energy beam in a subsequent layer (e.g. in a second, third, fourth etc. layer) may follow a different path that the energy-beam in the first layer (e.g., bottom skin layer). The pattern may comprise a vector or raster pattern.

The path of the energy beam may follow the formed wire. The path of the energy beam may comprise repeating a path along the formed wire. The repetition may comprise a repetition of 1, 2, 3, 4, 5, 6, 7, 8, 9, 10 times or more. The energy beam (e.g., first and/or second energy beam) may follow a path comprising parallel lines. For example, FIGS. 1C, 1D and 1F show paths that comprise parallel lines. Examples for the distance between two parallel lines or line portions is schematically illustrated in FIGS. 1, 101, 103, 104, 105, and 106 each by a two head arrow respectively. The distance between each of the parallel lines or line portions (e.g., FIG. 1F) may be at least about 1 micrometer (μm), 5 μm, 10 μm, 20 μm, 30 μm, 40 μm, 50 μm, 60 μm, 70 μm, 80 μm, or 90 μm. The distance between each of the parallel lines or line portions may be at most about 1 micrometer (μm), 5 μm, 10 μm, 20 μm, 30 μm, 40 μm, 50 μm, 60 μm, 70 μm, 80 μm, or 90 μm. The distance between each of the parallel lines or line portions may be any value between any of the afore-mentioned distance values (e.g., from about 1 μm to about 90 μm, from about 1 μm to about 50 μm, or from about 50 μm to about 90 μm). The distance between the parallel line portions may be substantially the same in every layer (e.g., plane) of transformed (e.g., hardened) material. The distance between the parallel line portions in one layer (e.g., plane) of transformed (e.g., hardened) material may be different than the distance between the parallel line portions in another layer of transformed material within one object (e.g., 3D object). The distance between the parallel line portions within a layer of transformed material may be may be (e.g., substantially) constant. The distance between the parallel line portions within a layer of transformed material may be varied. The distance between a first pair of parallel line portions within a layer of transformed material may be different than the distance between a second pair of parallel line portions within the layer of transformed material. The first energy beam may follow a path comprising two lines that cross in at least one point. The lines may be straight or curved. The lines may be winding lines. For example, FIG. 1E shows a winding line path. The first energy beam may follow a path comprising a U shaped turn (e.g., shown in FIG. 1D). The first energy beam may follow a path devoid of U shaped turns (e.g., shown in FIG. 1F).

The second energy beam may (e.g., substantially) follow a path in which the first energy beam previously propagated. The second energy beam may follow a different path from the one in which the first energy beam previously propagated. The paths of the first and second energy beams may cross or not cross. The paths of the first and second energy beams may be parallel to each other. The second energy beam may succeed the first energy beam in time and/or in position. The second energy beam may precede the first energy beam in time and/or in position. At times, the second energy beam may operate simultaneously or sequentially with first energy beam. During the broadening, the path of the second energy beam may overlap the path of the first energy beam in at least one point. The overlapping paths may form an overlap zone of transformed material. The material structure (e.g., the microstructure) in the overlap zone may be altered during the broadening process. In some instances, the material structure in the overlap zone may be substantially unaltered during the broadening process. The overlap may be at least partial overlap. The overlap may be complete overlap. The overlap may be a partial overlap. In some instances, during the broadening, the path of the second energy beam may not overlap the path of the first energy beam. During the broadening, the path of the second energy beam may cross the path of the first energy beam. When multiple energy beams are in operation, the multiple energy beams may follow parallel or non-parallel paths. The multiple energy sources may time-wise follow each other, or operate simultaneously. The multiple energy sources may follow each other paths, or follow different paths. When multiple energy beams are in operation, at least two energy sources may follow the same path, at least two energy sources may follow different paths, at least two energy sources may follow paths that cross at least at one point, or at least two energy sources may follow paths that overlap at least at one point. The path of the energy beam may follow a part of a model. The model may be of a 3D object (e.g., the desired 3D object). The model may be of a 2D model. The path may follow a cross-section of the 2D or the 3D model.

The first energy source may deliver a power per unit area to the material (e.g., powder material). The second energy source may deliver a power per unit area that is greater by at least about 1.1, 1.2, 1.4, 1.5, 1.6, 1.8, 2, 3, 4, 5, 6, 7, 8, 9, 10, 15, 20, 25, 30, 35 or 40 times as compared to the power per unit are of the first energy source. The second energy source may deliver a power per unit area that is smaller by at least about 1.1, 1.2, 1.4, 1.5, 1.6, 1.8, 2, 3, 4, 5, 6, 7, 8, 9, 10, 15, 20, 25, 30, 35 or 40 times as compared to the power per unit are of the first energy source. The second energy source may deliver a power per unit area that is substantially equal to the power per unit are of the first energy source.

The first energy beam may translate at a first velocity during its operation. The second energy beam may translate at a second velocity during its operation. The operation may include forming the line, broadening the line or broadening the plane. The second energy source may translate at a velocity that is greater by at least about 1.5, 2, 3, 4, 5, 6, 7, 8, 9, 10, 15, 20, 25, 30, 35, 40, 50, 60, 70, 80, 90, 100 or 150 times compared to the translation velocity of the first energy source. The second energy source may translate at a velocity that is smaller by at least about 1.5, 2, 3, 4, 5, 6, 7, 8, 9, 10, 15, 20, 25, 30, 35, 40, 50, 60, 70, 80, 90, 100 or 150 times compared to translation velocity of the first energy source. The second energy source may deliver a power per unit area that is substantially equal to the power per unit are of the first energy source.

The height (e.g., thickens, see FIG. 4B) of the 3D plane or of the broadened 3D plane may be at least about 1 micrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, or 900 mm. The height of the plane or of the broadened plane may be at most about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, or 900 mm. The height of the plane or of the broadened plane may be any number between the afore-mentioned heights (e.g., from about 1 μm to about 50 μm, from about 50 μm to about 300 μm, from about 50 μm to about 600 μm, from about 300 μm to about 900 μm, or from about 1 mm to about 900 mm).

The formed 3D object (e.g., wire, or 3D plane) can have various surface roughness profiles, which may be suitable for various applications. The surface roughness may be the deviations in the direction of the normal vector of a real surface from its ideal form. The surface roughness may be measured as the arithmetic average of the roughness profile (hereinafter “Ra”). The formed 3D object (e.g., the 3D plane) can have a Ra value of at least about 400 μm, 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 5 μm, 1 μm, 500 nm, 400 nm, 300 nm, 200 nm, 100 nm, 50 nm, 40 nm, or 30 nm. The formed 3D object can have a Ra value of at most about 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 5 μm, 1 μm, 500 nm, 400 nm, 300 nm, 200 nm, 100 nm, 50 nm, 40 nm, or 30 nm. The formed 3D object can have a Ra value between any of the aforementioned Ra values (e.g., from about 50 μm to about 400 μm, from about 5 μm to about 50 μm, from about 5 μm to about 300 nm, from about 30 nm to about 300 nm, or from about 30 nm to about 300 μm). The Ra values may be measured by a contact or by a non-contact method. The Ra values may be measured by a roughness tester and/or by a microscopy method (e.g., any microscopy method described herein). The measurements may be conducted at ambient temperatures (e.g., R.T.), melting point temperature (e.g., of the pre-transformed material) or cryogenic temperatures. The roughness may be measured by a contact or by a non-contact method. The roughness measurement may comprise one or more sensors (e.g., optical sensors). The roughness measurement may comprise using a metrological measurement device (e.g., using metrological sensor(s)). The roughness may be measured using an electromagnetic beam (e.g., visible or IR).

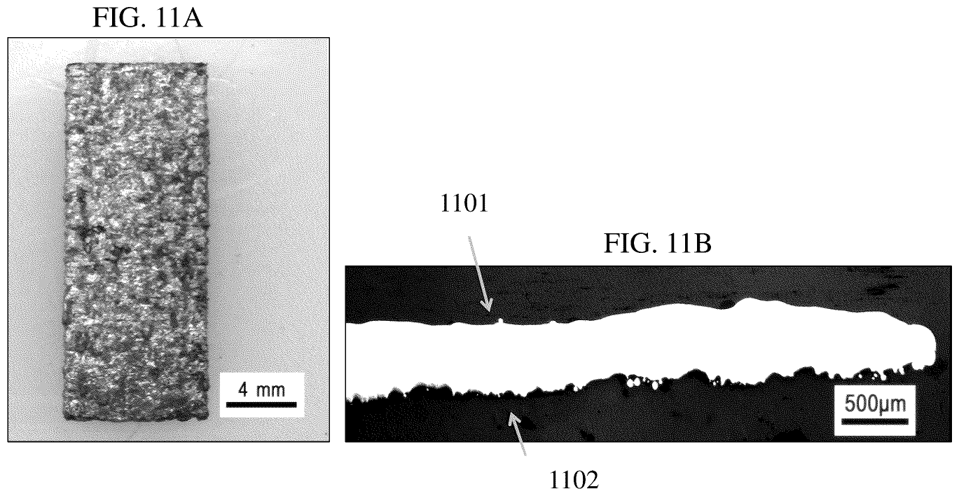

An example of a surface is illustrated in FIG. 11A. At times, the top surface of the formed 3D object may have a different roughness than the bottom surface of the formed 3D object. The top and bottom surfaces may be top and bottom during the formation of the printed (formed) object. For example, FIG. 11B, 1101 illustrates a top surface that is smoother than the bottom surface 1102. FIG. 11A shows an example of a top view of a 3D plane, and FIG. 11B shows an example of a vertical cross section of a 3D plane. The bottom surface may be rougher than the top surface. The top surface may be rougher than the bottom surface. At times, the top and bottom surfaces of the formed 3D object may have a substantially similar roughness. The bottom surface of the printed 3D object may have an Ra value that is 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, or 40 times larger than the Ra value of the top surface. The top surface of the printed 3D object may have an Ra value that is 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, or 40 times larger than the Ra value of the bottom surface.

The formed 3D object may be substantially smooth. The formed 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 5 μm, 4 μm, 5 μm, 10 μm, 15 μm, 20 μm, 25 μm, 30 μm, 35 μm, 100 μm, 300 μm, or 500 μm. The formed 3D object may have a deviation from an ideal planar surface between any of the afore-mentioned deviation values (e.g., from about 1.5 nm to about 500 μm, from about 1.5 nm to about 500 nm, from about 500 nm to about 5 μm, from about 5 μm to about 100 μm, or from about 100 μm to about 500 μm). The formed 3D object (e.g., 3D plane) may comprise a pore. The pores may be of an average FLS of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 5 μm, 4 μm, 5 μm, 10 μm, 15 μm, 20 μm, 25 μm, 30 μm 35 μm, 100 μm, 300 μm, or 500 μm. The pores may be of an average fundamental length scale between any of the afore-mentioned fundamental length scale values (e.g., from about 1.5 nm to about 500 μm, from about 1.5 nm to about 500 nm, from about 500 nm to about 5 μm, from about 5 μm to about 100 μm, or from about 100 μm to about 500 μm).

The 3D plane may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D plane may have a porosity between any of the afore-mentioned porosity percentages (e.g., from about 0.05% to about 80%, from about 0.05% to about 0.5%, from about 0.05% to about 0.2%, from about 0.05% to about 10%, from about 0.05% to about 50%, or from about 50% to about 80%). In some instances, a pore may transverse the formed 3D object. For example, the pore may start at a face of the 3D plane and end at the opposing face of the 3D plane. The pore may comprise a passageway extending from one face of the 3D plane and ending on the opposing face of that 3D plane. In some instances, the pore may not transverse the formed 3D object. The pore may form a cavity in the formed 3D object. The pore may form a cavity on a face of the formed 3D object (e.g., the face of the 3D plane). For example, a pore may start on a face of the plane and not extend to the opposing face of that 3D plane.

The formed 3D object (e.g., 3D plane) may comprise a protrusion. The protrusion can be a grain, a bulge, a bump, a ridge or an elevation. The protrusions may be of an average FLS of at most about 1.5 nm, 2 nm, 3 nm, 4 nm, 5 nm, 10 nm, 15 nm, 20 nm, 25 nm, 30 nm, 35 nm, 100 nm, 300 nm, 500 nm, 1 μm, 1.5 μm, 2 μm, 5 μm, 4 μm, 5 μm, 10 μm, 15 μm, 20 μm, 25 μm, 30 μm 35 μm, 100 μm, 300 μm, or 500 μm. The protrusions may be of an average FLS between any of the afore-mentioned FLS values (e.g., from about 1.5 nm to about 500 μm, from about 1.5 nm to about 500 nm, from about 500 nm to about 5 μm, from about 5 μm to about 100 μm, or from about 100 μm to about 500 μm). The protrusions may constitute at most about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the formed 3D object. The protrusions may constitute at least about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the formed 3D object. The protrusions may constitute a percentage of an area of the formed 3D object that is between the afore-mentioned percentages of formed 3D object area (e.g., from about 0.05% to about 50%, from about 0.05% to about 0.5%, from about 0.05% to about 0.2%, from about 0.05% to about 10%, or from about 0.05% to about 50%). The protrusion may reside on any surface of the formed 3D object. For example, the protrusions may reside on an external surface of a 3D object (e.g., that includes a 3D plane). The protrusions may reside on an internal surface (e.g., a cavity) of a 3D object (e.g., that includes a 3D plane).

At times, the average size of the protrusions and/or holes may determine the resolution of the printed (e.g., formed) 3D object. The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 5 μm, 4 μm, 5 μm, 10 μm, 20 μm, 30 μm, 40 μm, 50 μm, 60 μm, 70 μm, 80 μm, 90 μm, 100 μm, or 200 μm. The resolution of the printed 3D object may be any value between the above mentioned resolution values (e.g., from about 1 μm to about 200 μm, from about 1 μm to about 100 nm, from about 2 μm to about 50 μm, from about 1 μm to about 20 μm, or from about 1 μm to about 60 μm). At times, the formed 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 80%, or 70%. At times, the formed 3D object may have a material density of at most about 99.5%, 99%, 98%, 96%, 95%, 94%, 93%, 92%, 91%, 90%, 80%, or 70%. At times, the formed 3D object may have a material density between the afore-mentioned material densities (e.g., from about 70% to about 99.9%, from about 90% to about 99.9%, from about 80% to about 90%, or from about 70% to about 80%). The 3D object may be porous. The 3D object may be dense.

The wire may comprise successive regions of hardened material indicative of additive manufacturing process. The regions may comprise (e.g., be) melt pools or grain structure. The formed 3D object may comprise regions of hardened (e.g., solidified) material indicative of at least one additive manufacturing process. For example, the wire may include successive regions of hardened material indicative of at least one additive manufacturing process. For example, the 3D plane may include rows of hardened (e.g., solidified) material indicative of at least one additive manufacturing process. The substantially repetitive microstructure may have an average FLS of at least about 0.5 μm, 1 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, or 1000 μm. The substantially repetitive microstructure may have an average FLS of at most about 1000 μm, 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The substantially repetitive microstructure may have an average FLS of any value between the aforementioned values (e.g., from about 0.5 μm to about 1000 μm, from about 15 μm to about 50 μm, from about 5 μm to about 150 μm, from about 20 μm to about 100 μm, or from about 10 μm to about 80 μm).

The microstructure of the hardened material may comprise dendrites and/or cells that are of an average length of at least about 20 μm, 25 μm, 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, or 500 μm. The hardened material may comprise dendrites and/or cells that are of an average length of at most about 20 μm, 25 μm, 30 μm, 35 μm, 40 μm, 50 μm, 60 μm, 70 μm, 80 μm, 90 μm, 100 μm, 120 μm, 150 μm, 170 μm, 200 μm, 220 μm, 250 μm, 270 μm, 300 μm, 400 μm, or 500 μm. The microstructure of the hardened material may comprise dendrites and/or cells that are of an average length of any value between the afore-mentioned average lengths (e.g., from about 20 μm to about 500 μm, from about 20 μm to about 50 μm, from about 20 μm to about 150 μm, from about 20 μm to about 100 μm, or from about 10 μm to about 80 μm). The microstructure of the hardened material may comprise dendrites and/or cells that are of an average width of at least about 0.25 μm, 0.5 μm, 0.75 μm, 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, or 50 μm. The hardened material may comprise dendrites and/or cells that are of an average length of at most about 0.25 μm, 0.5 μm, 0.75 μm 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, or 50 μm. The microstructure of the hardened material may comprise dendrites and/or cells that are of an average width of any value between the afore-mentioned average lengths (e.g., from about 0.25 μm to about 50 μm, from about 0.25 μm to about 20 μm, from about 5 μm to about 50 μm, from about 20 μm to about 50 μm, or from about 10 μm to about 40 μm). The dendrites and/or cells may be morphological structures (e.g., of a metal). The metal may be an elemental metal or metal alloy.

In some examples, the average FLS of the melt pools or grain structure is largest in the first layer, and shrinks as the number of layer increases. In some examples, the average FLS of the melt pools or grain structure is largest in the first layer (e.g., bottom skin), and is smaller in subsequent layers. The subsequent layers may be all subsequent layers. For example, the average FLS of the melt pools or grain structure in one layer may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than in a subsequent layer. The average FLS of the melt pools or grain structure in one layer may be at most about 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than in a subsequent layer. The ratio of the melt pools or grain structure in the one layer as compared to a subsequent layer may be any number between the afore-mentioned values. The one layer may be the first layer (e.g., bottom skin layer). The one layer may be the first, second, third, fourth, fifth, sixth, seventh, eighths, ninth, tenth or eleventh layer. The subsequent layer may be directly subsequent or non-directly subsequent. The subsequent layer may be the second layer. The subsequent layer may be the second, third, fourth, fifth, sixth, seventh, eighths, ninth, tenth, eleventh or twelfth layer. The number of the layer may refer to the number of deposited material that is transformed to form at least a part of the printed (e.g., 3D) object by at least one additive manufacturing process (e.g., selective laser sintering). The FLS may comprise the width or length.

At times, the surface comprises a single layer. At times the printed 3D object undergoes further treatment. The further treatment may comprise surface scraping, machining, polishing, or blasting (e.g., sand blasting). At times, the originally formed surface is scraped, machined, polished or blasted. When the printed 3D object undergoes further treatment, the bottom most surface layer of the treated object may be different than the original bottom most surface layer (e.g., the first layer, bottom skin layer).

The formed 3D object may comprise a surface of which the melt pool (or grain structure) is of a larger FLS than the FLS of the melt pool (or grain structure) in its interior. For example, the average FLS of the melt pools (or grain structure) in the surface of the printed (e.g., formed, or generated) 3D object may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than in the interior of the 3D object. The average FLS of the melt pools (or material grains) on the surface of the formed 3D object may be at most about 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than in the interior of the formed 3D object. The size of the melt pools (or grain structure) in the interior of the formed 3D object may be any number between the afore-mentioned values. The material grains may be the grain structure. The surface may comprise the first layer (e.g., bottom skin).

The surface may comprise the first, second, third, fourth, fifth, sixth, seventh, eighths, ninth, tenth, eleventh, or twelfth layer. The number of the layer refers to the number of the layer of pre-transformed material deposited and transformed in at least one additive manufacturing process. The interior may comprise a layer different than the surface layers. The interior may comprise a layer subsequent to the last surface layer.

The formed 3D object may comprise a surface in which the dendrites and/or cells are longer than the dendrites and/or cells in its interior respectively. The formed 3D object may comprise a surface in which the dendrites and/or cells are wider than the dendrites and/or cells in its interior respectively. In some examples, the average length and/or width of the dendrites and/or cells is largest at the surface, and shrinks as the number of layer increases towards the interior of the formed 3D object. Shrinking can be gradual. Shrining can be to a (e.g., substantially) constant value. For example, the average length and/or width of the dendrites and/or cells in the surface may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the average length and/or width of the dendrites and/or cells in the interior respectively. The average length and/or width of the dendrites and/or cells in the surface may be at most about 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the average length and/or width of the dendrites and/or cells in the interior of the formed 3D object respectively. The average length and/or width of the dendrites and/or cells in the surface relative to the average length and/or width of the dendrites and/or cells in the interior of the formed 3D object respectively may be any number between the afore-mentioned values (e.g., from about 1.1 times to about 70 times, from about 1.1 times to about 5 times, from about 5 times to about 20 times, or from about 20 times to about 70 times).

The formed 3D object may comprise a surface in which the crystals are longer than the crystals in its interior. The formed 3D object may comprise a surface in which the crystals are wider than the crystals in its interior. The crystals can be single crystals. In some examples, the average length and/or width of the crystals is largest in the first layer (or first two layers), and shrinks as the number of layer increases. Shrinking can be gradual. Shrinking can be to a (e.g., substantially) constant value. In some examples, the average length and/or width of the crystals is largest in the surface, and shrinks as the number of layer increases towards the interior of the formed 3D object. For example, the average length and/or average width of the crystals in the surface may be at least about 1.1, 1.2, 1.4, 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the average length and/or the average width of the crystals in the interior. The average length and/or width of the crystals in the surface may be at most about 1.5, 1.6, 1.7, 1.8, 1.9, 2, 2.5, 3, 3.5, 4, 4.5, 5, 5.5, 6, 6.5, 7, 7.5, 8, 8.5, 9, 10, 15, 20, 25, 30, 35, 40, 50, or 70 times larger than the average length and/or the average width of the crystals in the interior of the formed 3D object. The average length and/or width of the crystals in the surface relative to the average length and/or width of the crystals in the interior of the formed 3D object may be any number between the afore-mentioned values (e.g., from about 1.1 times to about 70 times, from about 1.1 times to about 5 times, from about 5 times to about 20 times, or from about 20 times to about 70 times).

The term “auxiliary supports,” as used herein, generally refers to features that are part of a printed 3D object, but are not part of the desired, intended, designed, ordered, or final object. One or more auxiliary supports may provide structural support during and/or subsequent to the formation of the object. The one or more auxiliary supports may enable the removal of energy from the object that is being formed (e.g., during its formation process). Examples of auxiliary support comprise fin (e.g., heat fin), anchor, handle, pillar, column, frame, footing, scaffold, platform, mold, or another stabilization feature. The platform may serve as an auxiliary support, for example, when the first layer of the object is anchored, attached, and/or connected to the platform. Auxiliary supports may form a dense structure supporting the object (e.g., during its formation). The auxiliary support may be porous or dense. The auxiliary support may have the same or different density characteristics than the desired 3D object to which the auxiliary support is attached.

At least during the formation process of the 3D object: The auxiliary support(s) of the printed 3D object, if present, may not connect to the enclosure (e.g., the platform). The auxiliary support(s) of the printed 3D object, if present may not be anchored to the enclosure. The auxiliary support(s) of the printed 3D object, may not contact the enclosure. The printed 3D object may be supported only by the pre-transformed material (e.g., powder) in the material bed. Any auxiliary support(s) of the printed 3D object, if present, may be suspended adjacent to (e.g., above) the platform. In some cases, auxiliary support(s) may adhere to the upper surface of the platform above which the printed 3D object is formed. In some examples, the auxiliary supports of the printed 3D object may touch the platform. Sometimes, the auxiliary support may adhere to the platform. In some embodiments, the auxiliary supports are an integral part of the platform. The auxiliary support may be the platform. Occasionally, the platform may have a pre-transformed material. Such pre-transformed material may provide support to the printed 3D object. At times, the platform (e.g., upper surface of the base) may provide adherence to the material pre-transformed material. Sometimes, the platform (e.g., upper surface of the base) may not provide adherence to the pre-transformed material.

The platform may comprise elemental metal, metal alloy, elemental carbon, or ceramic. The platform may comprise a composite material. The platform may comprise glass. The platform may comprise stone. The platform may comprise a zeolite. The platform may comprise a polymeric material. The polymeric material may include a hydrocarbon, or fluorocarbon. The platform may comprise Teflon. The platform may comprise compartments for printing small objects. The compartments may form a smaller compartment within the enclosure, which may accommodate the pre-transformed material. Small may be relative to the size of the enclosure. At times, a plurality of 3D object may be printed in one material bed (e.g., simultaneously).

The wire, 3D plane and/or broadened 3D plane may be devoid of auxiliary support. The formed 3D object may comprise spaced apart auxiliary supports. In some instances, the spaced apart value may be represented as a sphere that intersects the 3D objet forming an intersecting shape, which sphere has a radius. In some instances, an area at and within the intersecting shape is devoid of auxiliary support. FIG. 14 shows an example of a circle having a radius XY within represents the intersection shape, wherein the intersection rim and interior are devoid of auxiliary supports. The formed 3D object may comprise a reduced amount of auxiliary supports. The formed 3D object may comprise a single auxiliary support. FIG. 15B shows an example of ledges stemming from a single auxiliary support.

The distance between any two auxiliary supports can be at least about 1 millimeter, 1.3 millimeters (mm), 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 15 mm, or 20 mm. The distance between any two auxiliary supports can be at most about 1 mm, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 15 mm, or 20 mm. The distance between any two auxiliary supports can be any value in between the afore-mentioned distances (e.g., from about 1 mm to about 2 mm, from about 2 mm to about 5 mm, or from about 5 mm to about 20 mm). The distance may be the shortest distance between any two auxiliary supports. The distance between any two auxiliary support can be XY.

In some examples, the formed 3D object (e.g., wire and/or 3D plane) can be formed without auxiliary support. The formed 3D object can be devoid of auxiliary support. The formed 3D object may be suspended (e.g., float anchorlessly) in the material bed. The pre-transformed material (e.g., powder material) can offer support to the formed 3D object (or the object during its formation). The formed 3D object may include one or more auxiliary supports. The one or more auxiliary supports may be suspended (e.g., float anchorlessly) in the material bed. The one or more auxiliary supports can be suspended in the material bed (e.g., within a layer of pre-transformed material in which the object was formed). The one or more auxiliary supports can be suspended in the pre-transformed material within a layer other than the one in which the object has been formed (e.g., a previously deposited layer of pre-transformed material). The auxiliary support may touch the enclosure. The auxiliary support may be suspended in the material bed and not touch the enclosure (e.g., the platform).

The formed 3D object may be (e.g., substantially) planar. The formed 3D object may not curl substantially, or may curl to a small amount (e.g., on cooling and/or on hardening). Hardening may be solidifying. The formed 3D object may warp to a small amount, or may not warp substantially (e.g., on cooling and/or on hardening). The formed 3D object may roll to a small amount, or may not roll substantially (e.g., on cooling and/or on hardening). The formed 3D object may warp to a small amount, or may not warp substantially (e.g., on cooling and/or on hardening). A small amount may be an amount that is insignificant for its designed application. Roll, curl, and/or warp may be up, down, and/or sideways. The printed 3D object may be printed with minimal or diminished amount of internal material stress within the formed 3D object (e.g., on cooling and/or on hardening).

The wire and/or 3D plane may comprise a curvature. The curvature may have a radius of curvature. The radius of curvature, “r,” of a curve at a point can be a measure of the radius of the circular arc (e.g., FIG. 17, 1716) which best approximates the curve at that point. The radius of curvature can be the inverse of the curvature. In the case of a 3D curve (also herein a “space curve”), the radius of curvature may be the length of the curvature vector. The curvature vector can comprise of a curvature (e.g., the inverse of the radius of curvature) having a particular direction. For example, the particular direction can be the direction towards the platform (e.g., designated herein as negative curvature), or away from the platform (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line (e.g., a wire) that is not required to be straight. A straight line can be a special case of curved line wherein the curvature is substantially zero. A line of substantially zero curvature has a substantially infinite radius of curvature. A curve can be in two dimensions (e.g., vertical cross section of a 3D plane), or in three-dimension (e.g., curvature of a 3D plane). The curve may represent a cross section of a curved 3D plane. A straight line may represent a cross section of a flat (e.g., planar) 3D plane. The platform may be a building platform. The platform may comprise the substrate, base, or bottom of the enclosure. The material bed may be disposed adjacent (e.g., on) the platform.

The one or more layers within the printed 3D object (e.g., one or more layers of hardened material) may be (e.g., substantially) planar. Planar may be flat. The planarity of the one or more layers of hardened material may be (e.g., substantially) uniform. The height of the one or more layers of hardened material at a particular position may be compared to an average plane. The average plane may be defined by a least squares planar fit of the top-most part of the surface of the layer of hardened material. The average plane may be a plane calculated by averaging the material height at each point on the top surface of the one or more layers of hardened material. The deviation from any point at the surface of the planar one or more layers of hardened material may be at most 20% 15%, 10%, 5%, 3%, 1%, or 0.5% of the height (e.g., thickness) of the one or more layers of hardened material. The (e.g., substantially) planar one or more layers of hardened material may have a large radius of curvature. FIG. 17 shows an example of a vertical cross section of a 3D object 1712 comprising planar layers (layers numbers 1-4) and non-planar layers (e.g., layers numbers 5-6) that have a radius of curvature. FIGS. 17, 1716 and 1717 are super-positions of curved layer on a circle 1715 having a radius of curvature “r.” The one or more layers may have a radius of curvature equal to the radius of curvature of the layer surface. The radius of curvature may equal infinity (e.g., when the layer is flat). The radius of curvature of the one or more layers of hardened material (e.g., of all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 3 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the one or more layers of hardened material (e.g., all the layers of the 3D object) may have any value between any of the afore-mentioned values of the radius of curvature (e.g., from about 0.1 cm to about 100 m, from about 10 cm to about 90 m, from about 50 cm to about 10 m, from about 5 cm to about 1 m, from about 50 cm to about 5 m, from about 5 cm to infinity, from about 25 cm to 10 m, or from about 40 cm to about 50 m). In some embodiments, a layer with an infinite radius of curvature is a layer that is planar. In some examples, the one or more layers of hardened material may be included in a 3D plane. In some examples, the one or more layers of hardened material may be included in a planar section of the 3D object, and/or may be a planar 3D object (e.g., a flat plane). In some instances, a portion of at least one layer within the 3D object may have any of the radii of curvature mentioned herein, which will designate the radius of curvature of that layer portion. In some instances, the radius of curvature is of a portion of a layer of hardened material.

The one more layers of hardened material may have a deviation from a plane. The formed one more layers of hardened material may deviate from a plane by at most about 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, or 900 μm. The formed one more layers of hardened material may deviate from a plane by a value between any of the afore-mentioned plane deviation values (e.g., from about 5 μm to about 900 μm, from about 5 μm to about 100 μm, or from about 200 μm to about 900 μm).

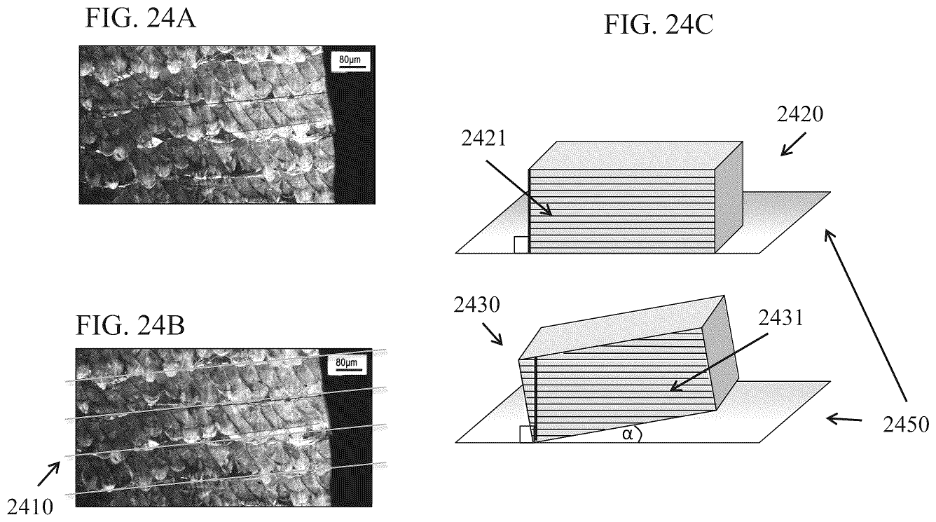

The regions of hardened material (e.g., arrangement thereof) may be indicative of horizontal formation of the printed 3D object. FIG. 24A shows an example of a 3D object comprising successively deposited melt pools that are arranged in layers. FIG. 24B shows an example of a layer 2410 comprising successively arranged melt pools. FIG. 24C shows a schematic example of a 3D object 2420 that is formed horizontally on a platform 2450 and is composed of horizontal layers (e.g., 2421) that correspond to its natural position. The regions of hardened material may be indicative of formation of the printed 3D object at an angle that is at least about 45°, 55°, or 60° from the direction of the field of gravity (or from a vector parallel to the field of gravity). The angle may be a tilting angle from the natural position of the object. The regions of hardened material may comprise layers and/or melt pool. The regions of hardened material may be indicative of formation of a wire at the angle beta. The regions of hardened material may be indicative of formation of the 3D plane or broadened 3D plane at the angle alpha. FIG. 24C shows a schematic example of a 3D object 2430 that is formed at an angle alpha relative to a platform 2450 and is composed of horizontal layers (e.g., 2431). The angle of the average plane of the layer of hardened material with respect to a surface of the 3D object may reveal the angle at which the object has been tilted (if any) with respect to its natural position.

The printed 3D object may be devoid of auxiliary support and/or support mark. The printed 3D object may comprise a single auxiliary support and/or support mark. The single auxiliary support may be a platform (e.g., base or substrate), or a mold (a.k.a., a mould). The single auxiliary support may be adhered to the platform, or mold. The printed 3D object may comprise two or more auxiliary supports and/or support marks. A cross section (e.g., vertical cross section) of the printed 3D object may reveal a microstructure or a structure indicative of a material transformation (e.g., fusion, bonding, or connection of material). The regions of hardened (e.g., solidified) material may comprise successive features that originated from a fused (e.g., sintered, or melted), bound or otherwise connected pre transformed material. The successive regions may be melt pools or grain structures. For example, the regions of solidified material may comprise successive features that originated from a fused (e.g., sintered, or melted), bound, or otherwise connected powder material. The microstructure or grain structure may arise due to the solidification of fused pre transformed (e.g., powder) material that is typical to and/or indicative of the 3D printing method (e.g., as described herein). For example, a cross section may reveal a microstructure resembling ripples or waves that are indicative of melt pools that may be formed during the 3D printing process. FIG. 24A shows an example of a cross section of a 3D object that reveals its microstructure. The microstructure (e.g., arranged in layers) may reveal the orientation (e.g., angle) in which the part is printed. The angle may be with respect to the platform and/or gravitational field. The orientation may be tilted or non-tilted with respect to its natural position. The cross section may reveal a substantially repetitive micro or grain structure that is arranged in layers. The microstructure or grain structure may comprise substantially repetitive variations in material composition, grain orientation, material density, degree of compound segregation or of element segregation to grain boundaries, material phase, metallurgical phase, crystal phase, crystal structure, material porosity, or any combination thereof. The microstructure or grain structure may comprise substantially repetitive solidification of melt pools. The substantially repetitive microstructure (e.g., grain structure) may have an average size of at least about 0.5 nm, 1 nm, 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 450 nm, or 500 nm. The substantially repetitive microstructure may have an average size of at most about 0.5 nm, 1 nm, 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 450 nm, or 500 nm. The substantially repetitive microstructure may have an average layer size of any value between the aforementioned microstructure average size values (e.g., from about 0.5 nm to about 500 nm, from about 0.5 nm to about 50 nm, from about 0.5 nm to about 100 nm, or from about 100 nm to about 500 nm). The printed 3D object may be devoid of marks arising from an auxiliary structure (including a base structure) that is removed (e.g., subsequent to the 3D printing process).

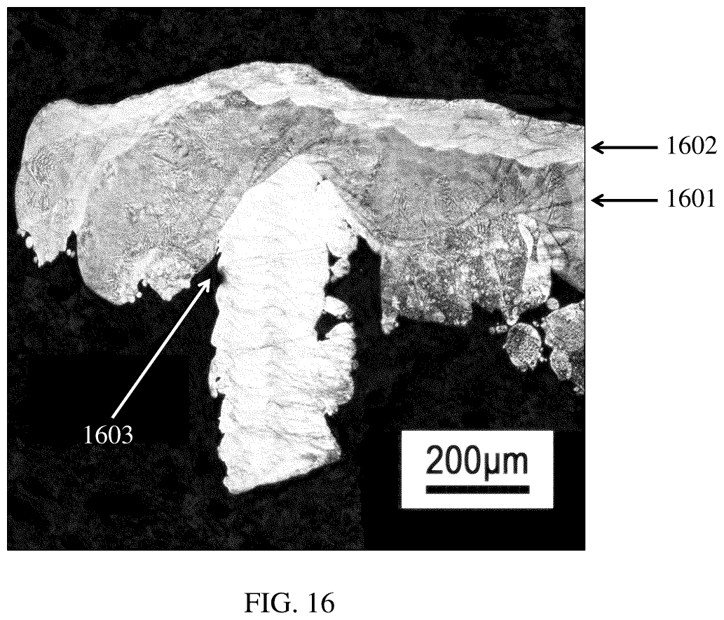

The printed 3D object may be devoid of auxiliary supports during and/or after its fabrication. The printed 3D object may be printed with auxiliary support; which auxiliary support is removed subsequent to the completion of the printing process. The term “auxiliary support” may refer to a single or a plurality of auxiliary supports. In some instances, the printed 3D object may comprise a mark belonging to an auxiliary structure that was previously part of (or attached to) the printed 3D object (e.g., during its printing). The printed 3D object may comprise two or more marks belonging to previously present auxiliary features. The printed 3D object may be devoid of a mark (e.g., any mark) pertaining to a previously present (e.g., during printing of the 3D object) auxiliary support. The mark may comprise variation in grain orientation, variation in material density, variation in the degree of compound segregation to grain boundaries, variation in material porosity, variation in the degree of element segregation to grain boundaries, variation in material phase, variation in metallurgical phase, variation in crystal phase, or variation in crystal structure; where the variation may not have been created by the geometry of the printed 3D object alone, and may thus be indicative of a prior existing auxiliary support (e.g., that is removed). FIG. 16 shows an example of a 3D object printed using an added manufacturing method, which 3D object includes an auxiliary support 1603. FIG. 16 shows deformation of the printed layers 1601 and 1602 due to the presence of the auxiliary support 1603. A mark may be a point of discontinuity that is not explained by the geometry of a printed 3D object that does not include any auxiliary supports. The point of discontinuity may arise during a breakage of the auxiliary support. Breakage may be the result of cutting, shaving, chipping, sawing, or any combination thereof. The variation in the microstructure of the 3D object may be forced by the geometry of the support. In some instances, the 3D structure (e.g., shape) of the printed 3D object may be forced by the auxiliary support (e.g., by a mold). The two or more auxiliary supports and/or support marks may be spaced apart by the spacing-distance. The microstructure of a formed layer of hardened material may be unaltered during the printing process. In some examples, the microstructure of a formed layer of hardened material may be changed during the printing process. For example, the hardened material may be transformed (e.g., molten) during the 3D printing process. The transformation (e.g., and subsequent hardening) may form larger or smaller microstructures as compared to the previously formed microstructures that constituted the hardened material. For example, the transformation (e.g., and subsequent hardening) may form larger microstructures as compared to the previously formed microstructures that constituted the hardened material. The formed 3D object may be annealed during the 3D printing process and/or after the 3D printing process.

The printed 3D object may comprise a point X, which resides on its surface, and a point Y, which is the closest auxiliary support or support mark to X. In some embodiments, Y is spaced apart from X by the spacing-distance. The straight line XY can form an angle beta relative to the direction of the field of gravity. The line XY may form an angle beta relative to the normal to a plane parallel to the average top surface of the layer of material. The line XY may form an angle beta relative to the normal to a plane parallel to the average top leveled surface of the layer of pre-transformed material (e.g., powder material). The line XY may form an angle beta relative to the normal to a plane parallel to the average plane of the top surface of the platform or the bottom of the enclosure facing the deposited pre-transformed material.

In some embodiments, Y is spaced apart from X by at least about 10 millimeters or more. In some embodiments, Y is spaced apart from X (the line XY) by the spacing-distance. The printed 3D object can be made of a single material or multiple materials. Sometimes one part of the 3D plane may comprise one material, and another part may comprise a second material different from the first material. The pre-transformed material (e.g., powder) may be a single material (e.g., a single alloy or a single elemental metal). The pre-transformed material may comprise one or more materials. For example, the pre-transformed material may comprise two alloys, an alloy and an elemental metal, an alloy and a ceramic, or an alloy and an elemental carbon. The pre-transformed material may comprise an alloy and alloying elements (e.g., for inoculation).

The printed 3D object may comprise points X and Y, which reside on the surface of the printed 3D object, wherein X is spaced apart from Y by at least about 2 millimeters or more. In some embodiments, X is spaced apart from Y by the spacing-distance. A circle of radius XY that is centered at X may lack auxiliary support marks (e.g., FIG. 14). An acute angle between the straight line XY and the direction of the field of gravity may be from about 45°, 55°, or 60° to about 90°. The acute angle between the straight line XY and the direction of the field of gravity may be beta. When the angle between the straight line XY and the direction of the field of gravity is greater than 90°, one can consider the complementary acute angle.

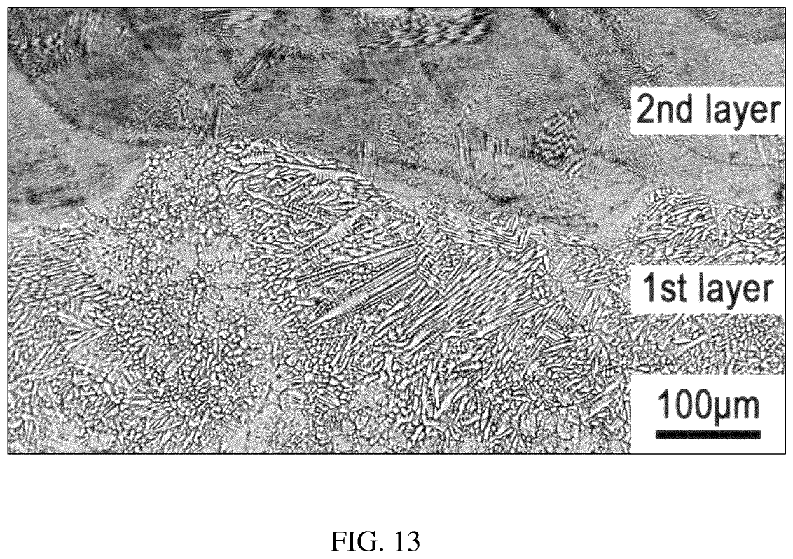

Another aspect of the present disclosure provides a method for forming a 3D plane comprising depositing a first layer of pre-transformed material (e.g., powder) in an enclosure (e.g., container) to form a material bed; transforming at least a portion of the material bed to form a 3D plane comprising a first layer of transformed (e.g., hardened) material; depositing a second layer of pre-transformed material; and transforming at least a portion of the pre-transformed material in the second layer to connect to at least a part of the 3D plane, thus forming an enlarged 3D plane comprising a second layer of transformed (e.g., hardened) material. The pre-transformed material can comprise a powder material. The pre-transformed material may comprise elemental metal, metal alloy, ceramic, or elemental carbon. Transforming may include fusing, connecting or bonding the material. Fusing may include sintering or melting. The transformed material may comprise a grain structure or melt pool. The grain structure may be fine or coarse. An example of a coarse structure is illustrated in FIG. 13, 1^{st} layer. An example for a fine structure is illustrated in FIG. 13, 2^{nd} layer. In some instances, the grains or the melt pools that are formed in first layer of the transformed material may be larger than those that are formed in the second layer of transformed material. The grains or melt pools may be formed upon cooling (e.g., and hardening) of the transformed material. The microstructure of the printed 3D object may include a microstructure comprising a planar structure, cellular structure, columnar dendritic structure, or equaled dendritic structure. The microstructure may comprise various morphologies and/or various crystal structures. The grain structure or melt pool in the first layer of transformed material may have a FLS. The average FLS of the grain structure or melt pool of the first layer of transformed material can be at least about 1000 μm, 900 μm, 800 μm, 700 μm, 600 μm, 500 μm, 400 μm, 300 μm, 200 μm, 100 μm, 50 μm, 40 μm, 30 μm, 20 μm, 10 μm, or 1 μm. The average FLS of the grain structure or melt pools in the first layer of transformed material can be at most about 1000 μm, 900 μm, 800 μm, 700 μm, 600 μm, 500 μm, 400 μm, 300 μm, 200 μm, 100 μm, 50 μm, 40 μm, 30 μm, 20 μm, 10 μm, or 1 μm. The average FLS of the grain structure or melt pools in the first layer of transformed material can be any value between the afore mentioned values (e.g., from about 1 μm to about 1000 μm, from about 1 μm to about 50 μm, from about 50 μm to about 400 μm, or from about 400 μm to about 1000 μm). The average FLS of the grain structure or melt pools in the second layer of transformed material can be at least about 500 μm, 400 μm, 300 μm, 200 μm, 100 μm, 50 μm, 40 μm, 30 μm, 20 μm, 10 μm, 1 μm, 500 nm, 400 nm, 300 nm, 200 nm, 100 nm, 50 nm, 40 nm, 30 nm, 20 nm, 10 nm, or 5 nm. The average FLS of the grain structure or melt pools in the second layer of transformed material can be at most about 500 μm, 400 μm, 300 μm, 200 μm, 100 μm, 50 μm, 40 μm, 30 μm, 20 μm, 10 μm, 1 micron, 500 nm, 400 nm, 300 nm, 200 nm, 100 nm, 50 nm, 40 nm, 30 nm, 20 nm, 10 nm, or 5 nm. The average FLS of the grain structure or melt pools in the second layer of transformed material can be any value between the afore mentioned values (e.g., from about 5 nm to about 500 μm, from about 1 μm to about 500 μm, or from about 50 nm to about 1 μm). The average FLS of the grain structure or melt pools in the first layer of transformed material can be at least 1.5, 2, 3, 4, 5, 6, 7, 8, 9, 10, 15, 20, 30, 40, 50, 60, 70, 80, 90, or 100 times larger than the FLS of the grain structure or melt pools in the second layer of transformed material. Melt pools in the first and second layer are shown in FIG. 13 as an example. Grain structure can refer to the structure of material grains. The second layer may be formed from a second layer of pre-transformed material in the material bed. The second layer may be the second identifiable layer in the 3D object. The second layer may be different from the bottom skin layer. The second layer may be formed above (e.g., on) the bottom skin layer.

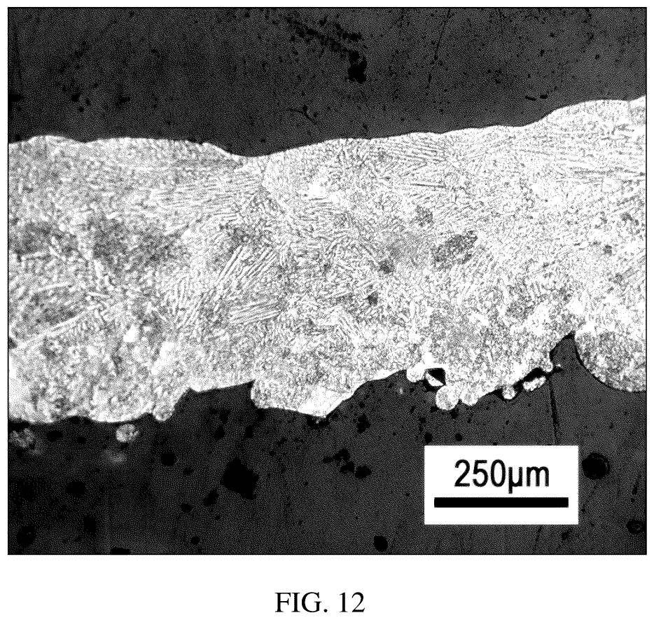

The top surface of the second layer of transformed material may be smoother than the bottom surface of the first layer. An example of a smooth upper surface of a 3D plane can be seen in the top surface of FIG. 11B, 1101. The bottom surface of the second layer of transformed material may be rougher than the bottom surface of the first layer. An example of a rougher bottom surface of a 3D plane can be seen in the top surface of FIG. 11B, 1102. The Ra value of the bottom of the first layer of transformed material may be at least 1.5, 2, 3, 4, 5, 6, 7, 8, 9, 10, 15, 20, 30, 40, 50, 60, 70, 80, 90, or 100 times larger than the Ra value of the top surface of the second layer of transformed material. The transformed material may comprise dendritic and/or cellular structure. FIG. 12 and in FIG. 13 show examples of dendritic structures. The dendritic structure may include single crystals. The first layer of transformed material may comprise a dendritic structure. In some instances, the dendritic structure is not confined to the first layer of transformed material. The dendritic structure may originate in the first layer of transformed material and penetrate or continue to the second layer of transformed material. In some instances, the dendritic structure is confined to the first layer of transformed material. The transformed material may be allowed to cool prior to, during, or subsequent to the deposition of the second layer of pre-transformed material. The transformed material may be allowed to cool prior to, during, or subsequent to the transformation of at least a portion of the second layer of pre-transformed material. The material before, during, or after its transformation may be cooled. The cooling of the material may comprise using a cooling member (e.g., heat sink), or cooled gas. The cooling member may be cooling member disclosed in patent application No. 62/252,330 that was filed on Nov. 6, 2015, titled “APPARATUSES, SYSTEMS AND METHODS FOR THREE-DIMENSIONAL PRINTING”, which is incorporated herein by reference in its entirety; or patent application number PCT/US15/36802, titled “APPARATUSES, SYSTEMS AND METHODS FOR THREE-DIMENSIONAL PRINTING” that was filed on Jun. 19, 2015, both of which are incorporated herein by reference in their entirety. The cooled gas may be conducted across the layer of material before, during, or after transforming at least a portion of the material bed. The first transformed layer can be allowed to cool slower than the second transformed layer. The first transformed layer can be allowed to cool quicker than the second transformed layer. The first and second transformed layers can be allowed to cool at (e.g., substantially) the same rate. The first layer of transformed (e.g., hardened) material can be allowed to cool over a longer time than the second layer of transformed (e.g., hardened) material. The first layer of transformed (e.g., hardened) material can be allowed to cool over a shorter time than the cooling period allowed for the second layer of transformed (e.g., hardened) material. The first layer of transformed (e.g., hardened) material can be allowed to cool over a substantially equal time to the cooling time allowed for the second layer of transformed (e.g., hardened) material. The grain structure or melt pools (e.g., weld pools) may be formed upon cooling and/or hardening of the transformed material. The microstructure (e.g., melt pool or grain structure) may comprise columnar grains or axial grains. The dendrites may be epitaxial dendrites. The dendrites may be non-epitaxial dendrites. The dendritic structures can grow by a process that comprises nucleation. The dendritic structures can growth by a process that comprises growth mechanism. The dendritic structures can growth by a process that comprises nucleation and growth mechanism.

The systems and/or the apparatus described herein can further comprise a cooling member (e.g., heat sink) configured to regulate the temperature of the material in the container. The cooling member may cool, heat or stabilize the temperature of the material in the enclosure. The cooling member can regulate the temperature of at least a portion of the transformed material and/or at least a portion of the remainder of the material that did not transform to form the 3D object. The cooling member may comprise a solid, liquid or gas. The cooling member may be a heat exchange mechanism.

In some instances, the methods and systems disclosed herein may comprise an enclosure (e.g., chamber). The pressure in the enclosure can be controlled (e.g., by a control system). The methods described herein can be performed in the enclosure having ambient pressure (e.g., 1 atmosphere), vacuum, or in a pressurized chamber. The vacuum may have a pressure below 1 bar. The pressurized environment may have a pressure above 1 bar. The pressure in the chamber can be at least 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The pressure in the chamber can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at most about 10⁻⁷ Torr, 10⁻⁶ Torr, 10⁻⁵ Torr, or 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at a range between any of the aforementioned pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). The pressure can be measured by a pressure gauge. The pressure can be measured at ambient temperature (e.g., R.T.), or at 20° C.

The methods and systems disclosed herein may comprise a chamber having an atmosphere. The atmosphere can be controlled (e.g., by a control system). The chamber may comprise an inert atmosphere. The atmosphere in the chamber may be substantially depleted by one or more gases. For example, the atmosphere may be depleted of water, oxygen, nitrogen, carbon dioxide, or of hydrogen sulfide. The atmosphere in the chamber may comprise a reduced amount of one or more gases. For example, the atmosphere may comprise a reduced amount of water, oxygen, nitrogen, carbon dioxide or hydrogen sulfide. The level of the deplete gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v) of the depleted gas. The level of the depleted gas may be at least about 1 ppm, 10 ppm, 50 ppm, 100 ppm, 500 ppm, 1000 ppm, 5000 ppm, 10000 ppm, 25000 ppm, 50000 ppm, or 70000 ppm (v/v) of the depleted gas. The level of the reduced gas may between any of the afore-mentioned ppm levels of reduced gas. For example, the level of the oxygen gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v) of oxygen gas. For example, the level of the water vapor may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v) of water vapor. The atmosphere may be an ambient atmosphere. The atmosphere may comprise air. The atmosphere may be inert. The atmosphere may be non-reactive. The atmosphere may be non-reactive with the pre-transformed, transformed, and/or hardened material. The atmosphere may prevent oxidation of the formed 3D object. The atmosphere may prevent oxidation of the material (e.g., powder material) before its transformation, during its transformation and/or after its transformation. The atmosphere may comprise argon, or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a volume by volume (v/v) percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5% at ambient temperature and pressure. The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5% at ambient pressure (e.g., and ambient temperature). The atmosphere may comprise any percent of hydrogen between the afore-mentioned percentages of hydrogen. The atmosphere may comprise a v/v hydrogen gas percent that is at least able to react with the pre-transformed, transformed, and/or hardened material (e.g., at ambient temperature), and at most adhere to the prevalent work-safety standards in the jurisdiction (e.g., hydrogen codes and standards). The atmosphere may comprise a v/v hydrogen gas percent that is not able to react with the pre-transformed, transformed, and/or hardened material (e.g., at ambient temperature), and at most adhere to the prevalent work-safety standards in the jurisdiction (e.g., hydrogen codes and standards).

When the energy source is in operation (e.g., 3D printing), the material bed can have a certain temperature. The average temperature of the material bed can be an ambient temperature (e.g., temperature of the surrounding room, or environment). The average temperature of the material bed can be an average temperature during the operation of the energy source(s) (e.g., during the 3D printing). The average temperature of the material bed can be an average temperature during the formation of the wire and/or during the broadening of the wire, during the formation of the 3D plane, or during the broadening of the 3D plane. The average temperature can be ambient. The average temperature can be room temperature. The average temperature can be below (e.g., just below) the melting temperature of the pre-transformed material. The average temperature can be below (e.g., just below) the sintering temperature of the pre-transformed material. The average temperature can be below (e.g., just below) the temperature required for bonding the pre-transformed material. The average temperature can be below (e.g., just below) the temperature required for transforming the pre-transformed material. Just below can refer to a temperature that is at most about 1° C., 2° C., 3° C., 4° C., 5° C., 6° C., 7° C., 8° C., 9° C., 10° C., 15° C., or 20° C., below the critical temperature. The critical temperature can be the melting, sintering, bonding, connecting or otherwise transforming temperature of the pre-transformed material. The material can be at a cryogenic temperature. The average temperature can be at most about 0° C., −5° C., −10° C., −30° C., −50° C., −100° C., −150° C., −200° C., −250° C., or −300° C. The average temperature can from about −150° C. to about −50° C. The average temperature can from about −150° C. to about −100° C. The average temperature can be at most about 196° K, 123° K (degrees Kelvin), 78° K or less. The average temperature can be from about 196° K to about 77° K. The average temperature of the material bed can be at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500 C, 600° C., 700° C., 800° C., 900° C., 1000° C., 1200° C., 1400° C., 1600° C., 1800° C., 2000° C., or more. The average temperature of the material bed can be any temperature between the afore-mentioned material average temperatures (e.g., from about 20° C. to about 500° C., from about 0° C. to about 100° C., from about 20° C. to about 2000° C., or from about 500° C. to about 2000° C.). The material bed (or a portion thereof) can be heated or cooled before, during or after forming the 3D object. The material bed temperature can be (e.g., substantially) maintained at a predetermined value. The temperature of the material bed can be monitored (e.g., during the formation of the 3D object). The material temperature can be controlled (e.g., during the formation of the 3D object).

The material bed (e.g., powder bed) can be heated by a first energy source such that the heating will transform at least a portion of the material bed. The remainder of the material bed that did not transform to form the formed 3D object (herein referred to as the “remainder” of the material bed) can be heated by a second energy source (herein also referred to as the complementary energy source), or not heated by the second energy source. The remainder of the material can be at an average temperature that is less than the liquefying temperature of the material. The maximum temperature of the transformed portion of the material bed and the average temperature of the remainder of the material bed can be different. The solidus temperature of the material can be a temperature wherein the material is in a solid state at a given pressure (e.g., ambient pressure). After the portion of the material is heated to the temperature that is at least a liquefying temperature of the material (e.g., by the first energy source), the portion of the material may be cooled to allow the transformed (e.g., liquefied) material portion to harden. In some cases, the liquefying temperature can be at least about 100° C., 200° C., 300° C., 400° C., 500° C., 600° C., 700° C., 800° C., or 900° C. and the solidus temperature can be at most about 800° C., 700° C., 600° C., 500° C., 400° C., 300° C., 200° C., or 100° C. For example, the liquefying temperature is at least about 300° C. and the solidus temperature is less than about 300° C. In another example, the liquefying temperature is at least about 400° C. and the solidus temperature is less than about 400° C. The liquefying temperature may be different from the solidus temperature. In some instances, the temperature of the pre-transformed material (e.g., powder) is maintained above the solidus temperature of the material and below its liquefying temperature. In some examples, the material type from which the pre-transformed material is made of has a super cooling temperature (or super cooling temperature regime). As the first energy source heats up the material to cause at least part of the material to transform, the melted material may remain melted as the material bed is held at or above the super cooling temperature of the material, but below its melting point. In some instances, two or more materials make up the material layer at a specific ratio, and the materials may form a layered material on transformation of the material, in which the layers have a layered pattern of material composition (e.g., eutectic alloy). At times, two or more materials make up the material layer at a specific ratio, and the materials may form a eutectic material on transformation of the material. The liquefying temperature of the formed eutectic material may be the temperature at the eutectic point, close to the eutectic point, or far from the eutectic point. Close to the eutectic point may designate a temperature that is different from the eutectic temperature (i.e., temperature at the eutectic point) by at most about 0.1° C., 0.5° C., 1° C., 2° C., 4° C., 5° C., 6° C., 8° C., 10° C., or 15° C. A temperature that is farther from the eutectic point than the temperature close to the eutectic point is designated herein as a temperature far from the eutectic Point. The process of liquefying and solidifying a portion of the material bed can be repeated until the entire object is formed. At the completion of the formed 3D object, it can be removed from the remainder of the material bed in the enclosure. The remainder can be separated from the portion of the formed 3D object. The formed 3D object can be hardened and/or removed from the container (e.g., from the platform). Hardened may comprise solidified. Hardened may be solidified.

The systems and/or the apparatus described herein may further comprise a control system (e.g., controller). The control system can be in communication with the one or more energy beams and/or with the platform. For example, the control system may be in communication with the first energy beam and with the second energy beam. The control system may control the optical components. The control system may control (e.g., regulate, direct and/or monitor) the one or more energy beams and/or the platform (e.g. the vertical and/or horizontal position of the platform). The control system may control the energy supplied by the one or more energy beams. For example, the control system may control the energy supplied by the first energy beam and by the second energy beam, to the material bed. The control system may control the position of the one or more energy beams relative to the platform. For example, the control system may control the position of the first energy beam and the position of the second energy beam relative to the platform.

One or more sensors (at least one sensor) can monitor the amount of pre-transformed material in the enclosure and/or in the material bed. The at least one sensor can be operatively coupled to a control system (e.g., computer control system). The term “operatively coupled” or “operatively connected” refers to a first mechanism that is coupled (or connected) to a second mechanism to allow the intended operation of the second and/or first mechanism. The at least one sensor can be operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may comprise temperature sensor, weight sensor, material (e.g., powder) level sensor, metrology sensor, gas sensor, or humidity sensor. The metrology sensor may comprise a measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, and/or electromagnetic signal. The electromagnetic signal may comprise a visible, infrared, ultraviolet, ultrasound, radio wave, or microwave signal. The metrology sensor may measure a vertical, horizontal, and/or angular position of at least a portion of the target surface. The metrology sensor may measure a gap. The metrology sensor may measure at least a portion of the layer of material. The layer of material may be a pre-transformed material (e.g., powder), transformed material, or hardened material. The metrology sensor may measure at least a portion of the 3D object. The gas sensor may sense any of the gas. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may be coupled to a processor that can perform image processing by using at least one sensor generated signal. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors. The weight sensor(s) may be disposed in, and/or adjacent to the material bed. A weight sensor disposed in the material bed can be disposed at the bottom of the material bed (e.g. adjacent to the platform). The weight sensor can be between the bottom of the enclosure (e.g., FIG. 2, 211) and the substrate (e.g., FIG. 2, 209) on which the base (e.g., FIG. 2, 202) or the material bed (e.g., FIG. 2, 204) may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. The weight sensor can comprise a button load cell. The button load cell can sense pressure from pre-transformed material (e.g., powder) adjacent to the load cell. In an example, one or more sensors (e.g., optical sensors or optical level sensors) can be provided adjacent to the material bed such as above, below, or to the side of the material bed. In some examples, the one or more sensors can sense the level (e.g., height and/or amount) of pre-transformed material in the material bed. The pre-transformed material (e.g., powder) level sensor can be in communication with a layer dispensing mechanism (e.g., powder dispenser). Alternatively, or additionally a sensor can be configured to monitor the weight of the material bed by monitoring a weight of a structure that contains the material bed. One or more position sensors (e.g., height sensors) can measure the height of the material bed relative to the platform. The position sensors can be optical sensors. The position sensors can determine a distance between one or more energy beams (e.g., a laser or an electron beam.) and the exposed surface of the material (e.g., powder) bed. The one or more sensors may be connected to a control system (e.g., to a processor and/or to a computer).

The systems and/or apparatuses disclosed herein may comprise one or more motors. The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators. The systems and/or apparatuses disclosed herein may comprise one or more pistons.

In some examples, a pressure system is in fluid communication with the enclosure. The pressure system can be configured to regulate the pressure in the enclosure. In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump.

In some examples, the pressure system includes one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves; such as throttle valves. The pressure system can include a pressure sensor for measuring the pressure of the chamber and relaying the pressure to the controller, which can regulate the pressure with the aid of one or more vacuum pumps of the pressure system. The pressure sensor can be coupled to a control system (e.g., controller). The pressure can be electronically or manually controlled.

The systems and/or the apparatus disclosed herein may comprise a valve. The valve may be shut or opened according to an input from the at least one sensor. The degree of valve opening or shutting may be controlled (e.g., regulated) by the control system. The control may be according to at least one input from at least one sensor. The systems and/or the apparatus described herein may comprise a pump. The pump may be controlled according to at least one input from at least one sensor. The systems and/or the apparatus described herein may comprise a motor. The motor may connect to a system dispensing the pre-transformed material to the enclosure. The motor may be controlled by the control system. The motor may control (e.g., the position) of the platform and/or its components (e.g., substrate and/or to the base). The motor may control (e.g., the opening) of the enclosure. The motor may control the material dispensing mechanism that dispenses pre-transformed material to form the material bed. The system and/or apparatus of the present invention may comprise a material reservoir comprising the pre-transformed material. The pre-transformed material may travel from the reservoir to the material dispensing mechanism. The motor may control a mechanism that levels the exposed surface of the material bed (e.g., a leveling mechanism). The system and/or apparatus of the present invention may comprise a layer dispensing mechanism, such as the layer dispensing mechanism or any of its components disclosed in patent application number PCT/US15/36802 that is incorporated by reference herein in its entirety.

The printing system may further comprise an optical system. The optical system may be configured to direct at least one energy beam from the at least one energy source to a position on the material within the container (e.g., a predetermined position). A scanner can be included in the optical system. The printing system may comprise a processor (e.g., a central processing unit). The processor can be programmed to control a trajectory of the at least one energy beam and/or energy source with the aid of the optical system. The systems and/or the apparatus described herein can further comprise a control system in communication with the at least one energy source and/or energy beam. The control system can be any control system disclosed in provisional patent application Ser. No. 62/325,402 that was filed on Apr. 20, 2016, titled “METHODS, SYSTEMS, APPARATUSES, AND SOFTWARE FOR ACCURATE THREE-DIMENSIONAL PRINTING” that is incorporated herein by reference in its entirety. The control system can control a supply of energy from the at least one energy source to the material in the container. The control system may control the optical system. The control system may control the various components of the optical system. The various components of the optical system may include optical components comprising a mirror, a lens, a fiber, a beam guide, a rotating polygon or a prism. The optical components may be tiltable or rotatable. The mirror may be a deflection mirror. The optical components may comprise an aperture. The aperture may be mechanical. The optical system may comprise a diffractive optical element, lens, deflector, aperture, or beam splitter.

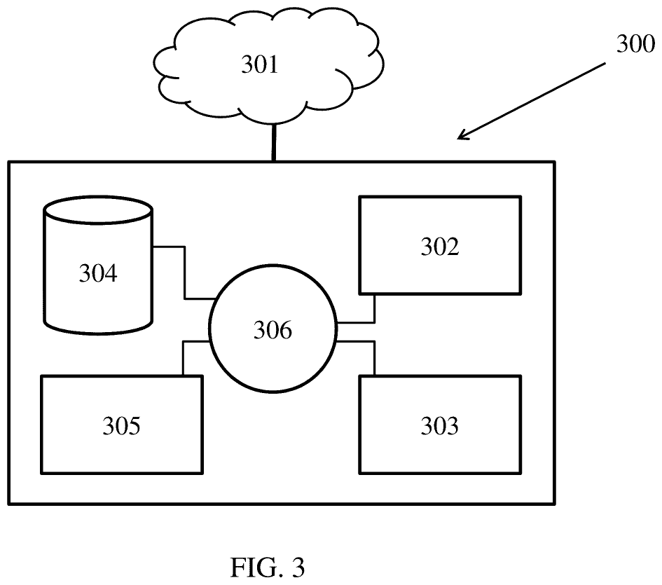

The systems and/or the apparatus described herein may comprise a processor (e.g., a computer). The present disclosure provides computer control systems that are programmed to implement methods of the disclosure. FIG. 3 depicts a computer system 300 that is programmed or otherwise configured to facilitate the creation of a formed 3D object. The computer system 300 can control various features of printing methods, systems, and/or apparatuses of the present disclosure, such as, for example, regulating heating, cooling and/or maintaining the temperature of the material within the container, process parameters (e.g., chamber pressure), the scanning route of the energy source, and/or the application of the amount of energy emitted to a selected location of a material by the energy source. Control may comprise regulate, manipulate, restrict, direct, monitor, adjust, or manage. The computer system 300 can be part of, or be in communication with, a printing system (e.g., 3D printing system). The computer may be coupled to one or more sensors connected to various parts of the printing system, such as any of the sensors mentioned herein.

The computer system 300 includes a central processing unit (CPU, also “processor,” “computer” and “computer processor” used herein) 306, which can be a single core or multi core processor, or a plurality of processors for parallel processing. The processing unit may be any processing unit disclosed in patent application No. 62/252,330, which is incorporated by reference in its entirety. The computer system 300 also includes memory or memory location 305 (e.g., random-access memory, read-only memory, flash memory), electronic storage unit 304 (e.g., hard disk), communication interface 302 (e.g., network adapter) for communicating with one or more other systems, and peripheral devices 303, such as cache, other memory, data storage and/or electronic display adapters. The memory 305, storage unit 304, interface 302 and peripheral devices 303 are in communication with the CPU 306 through a communication bus (solid lines), such as a motherboard. The storage unit 304 can be a data storage unit (or data repository) for storing data. The computer system 300 can be operatively coupled to a computer network (“network”) 301 with the aid of the communication interface 302. The network 301 can be the Internet, an Internet and/or extranet, or an intranet and/or extranet that is in communication with the Internet. The network 301 in some cases is a telecommunication and/or data network. The network 301 can include one or more computer servers, which can enable distributed computing, such as cloud computing. The network 301, in some cases with the aid of the computer system 300, can implement a peer-to-peer network, which may enable devices coupled to the computer system 300 to behave as a client or a server.

The processing unit may include one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at most 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The multiplicity of cores can be parallel cores. The multiplicity of cores can function in parallel. The multiplicity of cores may include at least 2, 10, 40, 100, 400, 1000, 2000, 3000, 4000, 5000, 6000, 7000, 8000, 9000, or 10000 cores. The multiplicity of cores may include cores of any number between the afore-mentioned numbers (e.g., from 2 to 40000, from 2 to 400, from 400 to 4000, from 2000 to 4000, or from 4000 to 10000 cores). The cores may communicate with each other via on chip communication networks; and/or control, data and communication channels. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two point latency). One point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, or 30 T-FLOPS. The number of FLOPS may be any value between the afore-mentioned values (e.g., from about 1 T-FLOP to about 30 T-FLOP, from about 4 T-FLOPS to about 10 T-FLOPS, from about 1 T-FLOPS to about 10 T-FLOPS, or from about 10 T-FLOPS to about 30 T-FLOPS. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), RandomAccess, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK refers to a software library for performing numerical linear algebra on a digital computer. DGEMM refers to double precision general matrix multiplication. STREAM convention may sum the amount of data that an application code explicitly reads and the amount of data that the application code explicitly writes. PTRANS may measure the rate at which the system can transpose a large array (e.g., matrix). MPI refers to Message Passing Interface.

The CPU 306 can execute a sequence of machine-readable instructions, which can be embodied in a program or software. The instructions may be stored in a memory location, such as the memory 305. The instructions can be directed to the CPU 306, which can subsequently program or otherwise configure the CPU 306 to implement methods of the present disclosure. Examples of operations performed by the CPU 306 can include fetch, decode, execute, and write back.

The CPU 306 can be part of a circuit, such as an integrated circuit. One or more other components of the system 300 can be included in the circuit. In some cases, the circuit is an application specific integrated circuit (ASIC).

The storage unit 304 can store files, such as drivers, libraries and saved programs. The storage unit 304 can store user data, e.g., user preferences and user programs. The computer system 300 in some cases can include one or more additional data storage units that are external to the computer system 300, such as located on a remote server that is in communication with the computer system 300 through an intranet or the Internet.

The computer system 300 can communicate with one or more remote computer systems through the network 301. For instance, the computer system 300 can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 300 via the network 301.

Methods as described herein can be implemented by way of machine (e.g., computer processor) executable code stored on an electronic storage location of the computer system 300, such as, for example, on the memory 305 or electronic storage unit 304. The machine executable or machine-readable code can be provided in the form of software. During use, the processor 306 can execute the code. In some cases, the code can be retrieved from the storage unit 304 and stored on the memory 305 for ready access by the processor 306. In some situations, the electronic storage unit 304 can be precluded, and machine-executable instructions are stored on memory 305.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems, apparatus and/or methods provided herein, such as the computer system 300, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier waves medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; wire (e.g., copper wire) and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 300 can include or be in communication with an electronic display that comprises a user interface (UI) for providing, for example, a model design or graphical representation of an object to be printed (object to be formed). Examples of UI's include, without limitation, a graphical user interface (GUI) and web-based user interface. The computer system can monitor and/or control various aspects of the printing system. The control may be manual or programmed. The control may rely on feedback mechanisms that have been pre-programmed. The feedback mechanisms may rely on input from sensors (described herein) that are connected to the control unit (i.e. control system or control mechanism e.g., computer). The computer system may store historical data concerning various aspects of the operation of the printing system. The historical data may be retrieved at predetermined times, or at a whim. The historical data may be accessed by an operator or by a user. The historical and/or operative data may be displayed on a display unit. The display unit (e.g., monitor) may display various parameters of the printing system (as described herein) in real time or in a delayed time. The display unit may display the currently printed 3D object (e.g., in real time), the ordered printed 3D object, the actually printed 3D object or any combination thereof. The display unit may display the printing progress of the printed 3D object, or various aspects thereof. The display unit may display at least one of the total time, time remaining and time expanded on printing the formed 3D object. The display unit may display the status of sensors, their reading and/or time for their calibration or maintenance. The display unit may display the type or types of material used and various characteristics of the material or materials such as temperature and flowability of the pre-transformed material (e.g., powder material). The display unit may display the pressure and/or type of gas in the enclosure (e.g., chamber). The gas may comprise oxygen, hydrogen, water vapor, or any of the afore-mentioned gasses. The display unit may display the pressure in the printing chamber (i.e. the chamber where the object is being formed). The computer may generate a report comprising various parameters of the printing system and/or printing process. The report may be generated at predetermined time(s), on a request (e.g., from an operator) or at a whim.

Methods and systems of the present disclosure can be implemented by way of one or more algorithms. An algorithm can be implemented by way of software upon execution by one or more computer processors.

Methods and systems of the present disclosure can be used to form the object for various uses and applications. Such uses and applications include, without limitation, electronics, components of electronics (e.g., casings), machines, parts of machines and tools, implants, prosthetics, fashion items, clothing, shoes, jewelry, or any combination thereof. The implants may be to a hard or soft tissue. The implants may form adhesion with hard or soft tissue. The machines may include motor or motor parts. The machines may include a vehicle. The machines may comprise aerospace related machines. The machines may comprise airborne machines. The machines may include airplanes, drones, cars, trains, bicycles, boats, or satellites.

The processor can be in network communication with a remote computer system that supplies instructions to the computer system to generate the formed 3D object. The processor can be in network communication with the remote computer through a wired or through a wireless connection. The remote computer can be a laptop, desktop, smartphone, tablet, or other computer device. The remote computer can comprise a user interface through which a user can input design instructions and parameters for the formed 3D object. The instructions can be a set of values or parameters that describe the shape and dimensions of the 3D object. The instructions can be provided through a file having a Standard Tessellation Language file format. In an example, the instructions can come from a 3D modeling program (e.g., AutoCAD, SolidWorks, Google SketchUp, or SolidEdge). In some cases, the model can be generated from a provided sketch, image, or 3D object. The remote computer system can supply design instruction to the processor. The processor can direct the at least one energy source in response to the instructions received from the remote computer. The processor can be further programmed to optimize a trajectory of path of the energy applied from the at least one energy source to a portion of the pre-transformed material to be transformed, or to a remainder of the pre-transformed material that should not be transformed, respectively. Optimizing the trajectory of energy application can comprise minimizing time needed to heat the pre-transformed material, minimizing time needed to cool the material bed, minimizing the time needed to scan the area that needs to receive energy or minimizing the energy emitted by the at least one energy source.

In some cases, the computer processor can be programmed to calculate the power per unit area emitted by the energy source that should be provided to the material (e.g., pre-transformed and/or transformed material) in order to achieve the desired result. The processor can be programmed to determine the time that an energy source should be incident on or projected to an area of a determined size in order to provide the necessary power density. In some instances, the computer controls the rate at which the energy beam travels relative to the material bed. In some cases, the desired result can be to provide uniform energy per unit area within the material bed. The desired result can be to transform a portion of the pre-transformed material to be transformed with an energy source at a certain power per unit area. The desired result can be to not transform the remainder of the pre-transformed material that should not be transformed (e.g., only to heat it) with an energy beam at a certain power per unit area. The desired result can be to transform a portion of the material bed to be transformed with a first energy source at the first power per unit area (P1) and to not transform the remainder of the material bed that should not be transformed with a complementary energy source at the second power per unit area (P2). The computer processor can be programmed to optimize the application of energy from the various energy sources. Optimizing the energy application can comprise minimizing time needed to heat the pre-transformed material, minimizing time needed to cool the pre-transformed material, or minimizing the energy emitted by the energy source(s). In some instances, P1 is greater than P2. In some instances, P2 is greater than P1. In some instances, P1 is substantially similar to P2. In some instances, the computer controls the amount of time the energy beam transmits energy to an area or point at the material bed.

The printed 3D object may not require further processing following its generation (e.g., by 3D printing). Without further processing: The printed 3D object may deviate from a model thereof by at most about 100 μm, 50 μm, 25 μm, 15 μm, 10 μm, 5 μm, or 1 μm. The printed 3D object may deviate from a model thereof by any value between the aforementioned values (e.g., from about 100 μm to about 1 μm, from about 100 μm to about 10 μm, from about 100 μm to about 50 μm, from about 50 μm to about 15 μm, or from about 15 μm to about 1 μm). The 3D object may deviate from the model thereof by at most the sum of 25 micrometers and 1/1000 of a FLS of the 3D object. The generated 3D object may deviate from the desired (e.g., requested) 3D object by at most about the sum of 25 micrometers and 1/2500 times the FLS of the desired 3D object.

In some instances, the printed 3D object may require reduced amount of processing after its formation is complete. For example, the printed 3D object may not require removal of auxiliary supports. The printed 3D object may not require smoothing, polishing, and/or leveling. The printed 3D object may not require further machining. The printed 3D object may be used for the construction of a 3D object (e.g., as a platform). The printed 3D object may be a portion of a desired 3D object. In some examples, the printed 3D object may require one or more treatment operations following its formation. The further treatment operation(s) may comprise surface scraping, machining, polishing, grinding, blasting (e.g., sand blasting), annealing, chemical treatment, or any combination thereof. In some examples, the printed 3D object may require a single operation (e.g., of sand blasting) following its formation. The printed 3D object may require an operation of sand blasting following its formation. Polishing may comprise electro polishing (e.g., electrochemical polishing or electrolytic polishing). The further treatment may comprise the use of abrasives. The blasting may comprise sand blasting or soda blasting. The chemical treatment may comprise an acid, a base, or an organic compound.

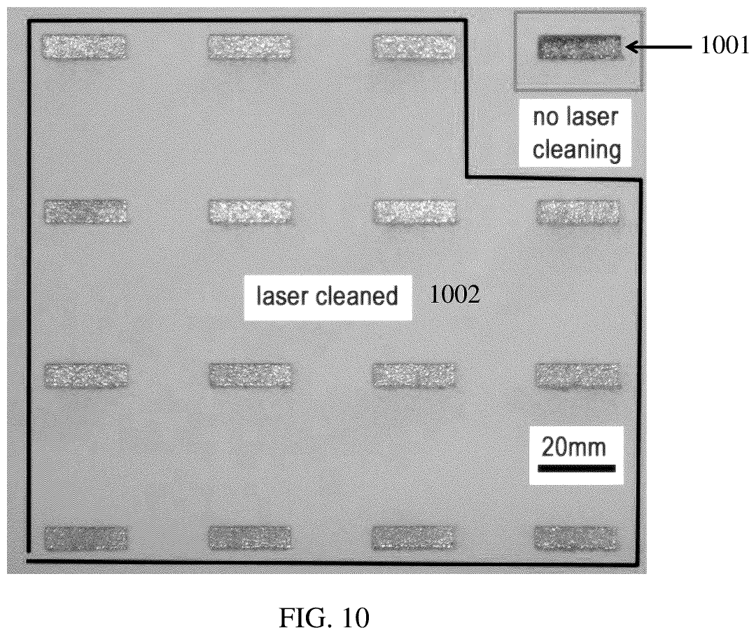

In another aspect is a method for cleaning the surface of the printed 3D object. The methods described herein may comprise directing an energy beam to a part of an object printed by 3D printing (e.g., added manufacturing); wherein the object comprises a material; and breaking down or evaporating a substance on the surface of the object that is different (e.g., chemically different) from the material. The method may comprise directing a cleaning energy beam to the surface of the object. The breaking down of a substance on the surface of the object that is different from the material may comprises breaking of chemical bonds. The chemical bonds may comprise covalent, metallic, or ionic bonds. For example, FIG. 10 shows an example of various 3D planes cleaned using the method for cleaning the surface disclosed herein. The material may comprise an elemental metal, metal alloy, ceramic, or elemental carbon. For example, the material can include a metal alloy. The substance that may be cleaned by the methods described herein may comprise an oxide, a sulfide, a nitride, or a carbide of the material. For example, the material can comprise an alloy of iron, titanium, nickel, or aluminum. In some examples, the material comprises stainless steel.

The cleaning energy beam may derive from an energy source. The energy source may comprise a laser source or an electron gun. The cleaning energy beam may be any energy beam disclosed herein. The cleaning energy beam may have an energy per unit area that is insufficient to transform the material. For example, the cleaning energy beam may be insufficient to fuse (e.g., sinter or melt), bond, or connect the material. The material may be a powder material. The cleaning energy beam may have an energy per unit area of at least about 0.1 Joule per millimeter square (J/mm²), 0.2 J/mm², 0.3 J/mm², 0.4 J/mm², 0.5 J/mm², 0.6 J/mm², 0.7 J/mm², 0.8 J/mm², 0.9 J/mm², 1.0 J/mm², 1.1 J/mm², 1.2 J/mm², 1.3 J/mm², 1.4 J/mm², 1.5 J/mm², 1.6 J/mm², 1.7 J/mm², 1.8 J/mm², 1.9 J/mm², 2.0 J/mm², 2.1 J/mm², 2.2 J/mm², 2.3 J/mm², 2.4 J/mm², 2.5 J/mm², 2.6 J/mm², 2.7 J/mm², or 2.8 J/mm². The cleaning energy beam may have an energy per unit area of at most about 0.1 J/mm², 0.2 J/mm², 0.3 J/mm², 0.4 J/mm², 0.5 J/mm², 0.6 J/mm², 0.7 J/mm², 0.8 J/mm², 0.9 J/mm², 1.0 J/mm², 1.1 J/mm², 1.2 J/mm², 1.3 J/mm², 1.4 J/mm², 1.5 J/mm², 1.6 J/mm², 1.7 J/mm², 1.8 J/mm², 1.9 J/mm², 2.0 J/mm², 2.1 J/mm², 2.2 J/mm², 2.3 J/mm², 2.4 J/mm², 2.5 J/mm², 2.6 J/mm², 2.7 J/mm², or 2.8 J/mm². The cleaning energy beam may have energy per unit area value that is any value between the afore-mentioned energy per unit area values (e.g., from about 0.1 J/mm² to about 2.8 J/mm², from about 0.1 J/mm² to about 1.4 J/mm², or from about 1.4 J/mm² to about 2.8 J/mm²).

The cleaning method may be performed in an enclosure (e.g., chamber). The chamber may comprise an atmosphere. The atmosphere may be controlled by a controller and/or manually. The atmosphere may be a predetermined atmosphere. The control may be automatic and/or manual. The atmosphere may be depleted of at least one gas. The atmosphere may have a diminished concentration of at least one gas. The gas may comprise oxygen, water, nitrogen, carbon dioxide, carbon monoxide, hydrogen sulfide, sulfur oxides, selenium oxides, tellurium oxides, nitrogen oxides, ozone, phosphine, phosphoric acid, or ammonia. Nitrogen oxides may comprise nitric oxide, nitrogen dioxide, nitrous oxide, dinitrogen trioxide, dinitrogen tetraoxide, dinitrogen pentaoxide, trinitramide, or nitrosylazide. Sulfur oxides comprise sulfur monoxide, sulfur dioxide, sulfur trioxide, or sulfuric acid. Selenium oxides comprise selenium dioxide. Tellurium oxides comprise tellurium dioxide.

The chamber may comprise an agent (e.g., an element or compound) that loses at least one electron to another species (e.g., chemical) in a chemical reaction (e.g., redox reaction). The chamber may comprise a reducing agent. The chamber may comprise a reducing gas. The chamber may comprise hydrogen gas. The chamber may comprise carbon monoxide gas. The chamber may comprise an inert gas. The chamber may comprise a Nobel gas. The chamber may comprise helium, argon, or nitrogen. The chamber may comprise at least about 1%, 2%, 5%, 10%, 15%, 20%, 30%, 40%, 50%, 60%, 70%, 80%, 90%, or 95% (v/v) of the inert gas (e.g., Nobel gas). The chamber may comprise any percentage between the afore-mentioned percentages of inert gas. The chamber may comprise a safe amount of hydrogen gas. The atmosphere may comprise a volume by volume (v/v) percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5% at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5% at ambient pressure (e.g., and ambient temperature). The atmosphere may comprise any percent of hydrogen between the afore-mentioned percentages of hydrogen. The atmosphere may comprise a v/v hydrogen gas percent that is at least able to react with the substance. The atmosphere may comprise a v/v hydrogen gas percent that at most adheres to the prevalent work-safety standards in the jurisdiction (e.g., hydrogen codes and standards). The atmosphere may comprise a v/v hydrogen gas percent that is at least able to react with the substance and at most adheres to the prevalent work-safety standards in the jurisdiction (e.g., hydrogen codes and standards).

The methods described herein may further comprise controlling (e.g., stabilizing) the temperature of the enclosure, atmosphere, material bed, printed 3D object, or any combination thereof. Stabilization of the temperature may be to a predetermined temperature value. The methods described herein may further comprise altering the temperature of the enclosure, atmosphere, material bed, printed 3D object, or any combination thereof. Alteration of the temperature may be to a predetermined temperature. Alteration of the temperature may comprise heating and/or cooling the temperature. Heating the temperature may be to a temperature below the temperature at which the material fuses (e.g., melts or sinters), connects, or bonds.

Described herein is a system for cleaning the printed 3D object (e.g., formed 3D object) comprising a container comprising a 3D object printed by 3D printing (e.g., added manufacturing), a cleaning energy beam capable of breakdown, or capable of evaporation of a substance disposed on the surface of the 3D object. The container may reside in an enclosure (e.g., chamber). The chamber (and thus the container) may have an atmosphere as described herein. The systems and/or the apparatus described herein can include a control system that can be in communication with the cleaning energy beam.

The control system can regulate the energy supplied from the cleaning energy beam to the printed 3D object (e.g., object to be cleaned). The control system may (e.g., operatively) connect to at least one sensor. The control system may react to at least one input from the at least one sensor. The at least one sensor may comprise an optical sensor, a temperature sensor, a weight sensor, a pressure sensor, a chemical sensor (e.g., a gas sensor), a position sensor, or any other sensor mentioned herein. The temperature sensor may be a contact temperature sensor or a non-contact temperature sensor. The temperature sensor comprises an optical sensor. The temperature sensor may comprise an infrared sensor.

The gas sensor can sense oxygen, nitrogen, carbon dioxide, water, argon, hydrogen, or any combination thereof. The gas sensor can sense the level of the gas in the enclosure. The chemical sensor can sense oxygen, sulfur, nitrogen, carbon, or any combination thereof. The chemical sensor can sense a level of the chemical. The chemical sensor can sense breakdown components of compounds selected from the group consisting of oxide, a sulfide, a nitride, and carbide of the material (e.g., hardened material). The chemical sensor can sense evaporation components of compounds selected from the group consisting of oxide, a sulfide, a nitride, and carbide of the material (e.g., hardened material).

The systems and/or the apparatus described herein may be able to control (e.g., regulate) the energy per unit area supplied by the cleaning energy beam. The control may be according to at least one input from the at least one sensor. The systems and/or the apparatus described herein may be able to regulate the position of the cleaning energy beam according to at least one input from at least one sensor. The systems and/or the apparatus described herein may be able to control (e.g., regulate) the temperature of the enclosure, atmosphere, material bed, and/or printed 3D object. The control may be based on an input from the at least one sensor. The control may be automatic, manual, or any combination thereof. The control may be according to a predetermined scheme. The control may rely on historic data (e.g., sensor data). The control may be at a whim. The control may require human intervention. The control may not require human intervention. The cleaning energy beam and/or source may be (e.g., operatively) coupled to a scanner. The cleaning energy beam and/or source may be (e.g., operatively) coupled to an optical system.

The cleaning system may comprise an optical system. The optical system may be configured to direct at least one cleaning energy beam from the at least one cleaning energy source to a position on the 3D object to be cleaned (e.g., a predetermined position). The cleaning energy source may be any energy source disclosed herein. A scanner can be included in the optical system and/or apparatus. The cleaning system and/or apparatus may comprise a processor. The processor can be programmed to control a trajectory of the at least one energy beam (e.g., cleaning energy beam) and/or energy source with the aid of the optical system. The systems and/or the apparatus described herein can comprise a control system in communication with the at least one energy source and/or energy beam. The control system can regulate a supply of energy (e.g., cleaning energy beam) from the energy source to the object in the container (e.g., to be cleaned). The control system may control the optical system. The control system may control various components of the optical system. The various components of the optical system may comprise a mirror, a lens, a fiber, a beam guide, a rotating polygon or a prism.

The control system may comprise a processor. The processor may be programmed or otherwise configured to facilitate the cleaning (e.g., surface cleaning) of the formed (printed) object. The computer system can control (e.g., regulate) various features of the cleaning method, system, and/or apparatus. The various features may comprise control the heating, cooling and/or maintaining the temperature within the container; process parameters; scanning route of the energy beam; application of the amount of energy emitted to a selected location of the printed 3D object by the energy source; or any combination thereof. The computer system can be part of, or be in communication with, a cleaning system. The computer may be coupled to one or more sensors connected to various parts of the cleaning system, such as any of the sensors disclosed herein. The computer system may include a central processing unit (CPU). The processor may comprise a central processing unit having characteristics of the CPU described above in the system for forming a 3D object. The communication of the computer system with a remote computer is essentially similar to the communication system described above for the system for forming a line or a 3D plane.

The computer system can include or be in communication with an electronic display that comprises a user interface (UI) for providing, for example, a model design or graphical representation of an object to be printed (object to be formed). Examples of UI's include, without limitation, a graphical user interface (GUI) and web-based user interface. The computer system can monitor and/or control various aspects of the cleaning system and/or cleaning process. The control may be manual or programmed. The control may rely on feedback mechanisms that have been pre-programmed. The feedback mechanisms may rely on input from sensors (described herein) that are connected to the control unit (i.e. control system or control mechanism e.g., computer). The computer system may store historical data concerning various aspects of the operation of the cleaning system. The historical data may be retrieved at predetermined times or at a whim. The historical data may be accessed by an operator or by a user. The historical and/or operative data may be displayed on a display unit. The display unit (e.g., monitor) may display various parameters of the printing system (as described herein) in real time and/or in a delayed time. The display unit may display the currently cleaned object (e.g., in real time), the desired printed 3D object (e.g., according to a model), the object to be cleaned, the printed 3D object, or any combination thereof. The display unit may display the progress of cleaning the object, or various aspects thereof. The display unit may display at least one of the total time, time remaining, and time expanded on the cleaned object during the cleaning process. The display unit may display the status of sensors, their reading and/or time for their calibration or maintenance. The display unit may display the type (or types) of pre-transformed material used and various characteristics of the pre-transformed material (or materials) such as temperature and flowability of the pre-transformed material (e.g., powder material). The display unit may display the amount of gas in the chamber. The gas may comprise oxygen, hydrogen, water vapor, or any of the gasses mentioned herein. The display unit may display the pressure in the chamber (i.e. the chamber where the object is being cleaned). The computer may generate a report comprising various parameters of the cleaning system and/or cleaning process. The report may be generated at predetermined time(s), on a request (e.g., from an operator) or at a whim.

Methods and systems of the present disclosure can be implemented by way of one or more algorithms. An algorithm can be implemented by way of software upon execution by one or more computer processors.

In some cases, the processor can be programmed to calculate the power per unit area emitted by the cleaning energy beam that should be provided to the 3D object in order to achieve the desired result. The processor can be programmed to determine the time that a cleaning energy source should be incident on or projected to an area of a determined size in order to provide the necessary power density of the cleaning energy beam. In some instances, the computer controls the rate at which the cleaning energy beam travels on the surface to be cleaned. In some cases, the desired result can be to provide uniform energy per unit area to the entire formed 3D object. The desired result can be to clean a portion of the surface to be cleaned with a cleaning energy source at a certain power per unit area. The computer processor can be programmed to optimize the application of energy from one or more energy sources. Optimizing the energy application can comprise minimizing time needed to heat the object, minimizing time needed to cool the object, or minimizing the energy emitted by the energy source(s). In some instances, the computer controls the amount of time the cleaning energy beam transmits energy to an area or to a point of the surface of the object.

The following are non-limiting examples of methods applied according the present disclosure. It will be obvious to those skilled in the art that such examples are provided by way of illustration only. It is not intended that the invention be limited by the specific examples provided herein.

### Example 1

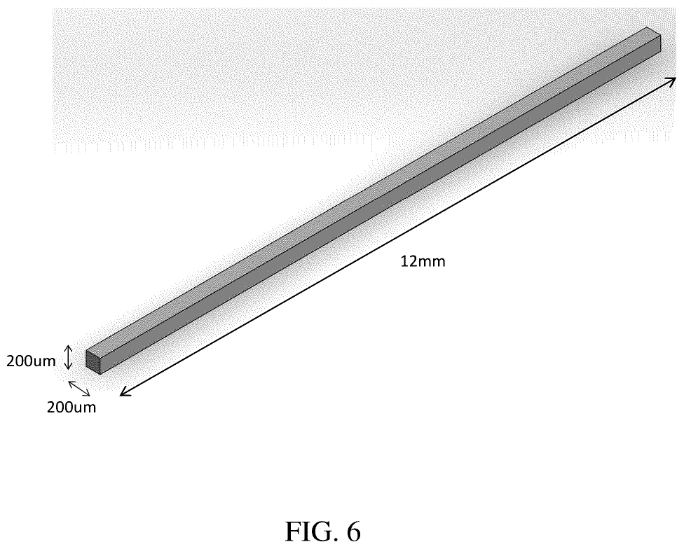

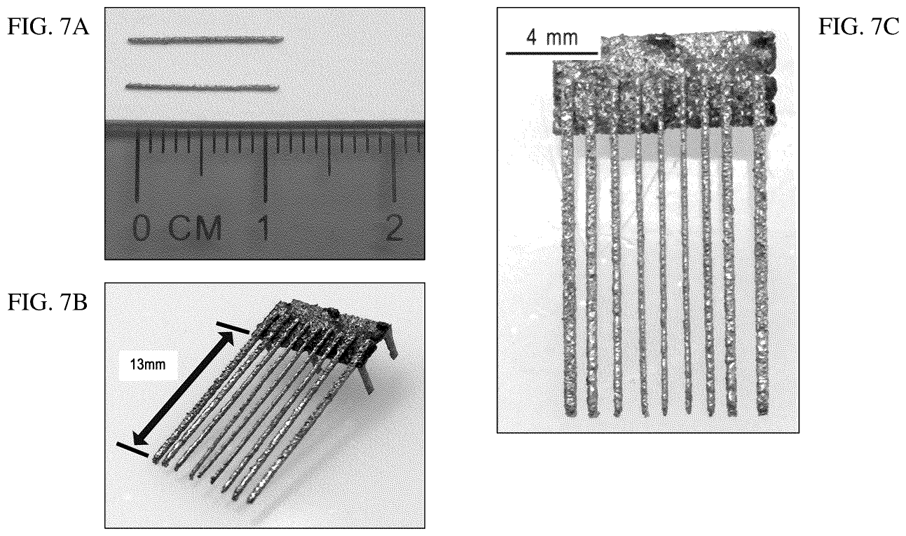

In a 25 cm by 25 cm by 30 cm container at ambient temperature and pressure, 1.56 kg Stainless Steel 316L powder of average particle size 35 μm is placed. The container is situated in an enclosure. The enclosure is purged with Argon gas for 5 min. The top surface of the powder is leveled. A 200 W fiber 1060 nm laser beam is directed to a point in on the surface of the powder for 110 milliseconds. The laser beam traveled across the powder in a predetermined line path. A line is subsequently formed. The line is a continuous line of average dimensions 200 μm by 200 μm by 12 mm, as can be schematically illustrated in the example of FIG. 6, and demonstrated in the example of FIG. 7A. FIG. 7A shows examples of wires that are printed as suspended wires devoid of auxiliary supports, and FIGS. 7B and 7C show examples of wires that are printed having a single supporting structure.

### Example 2

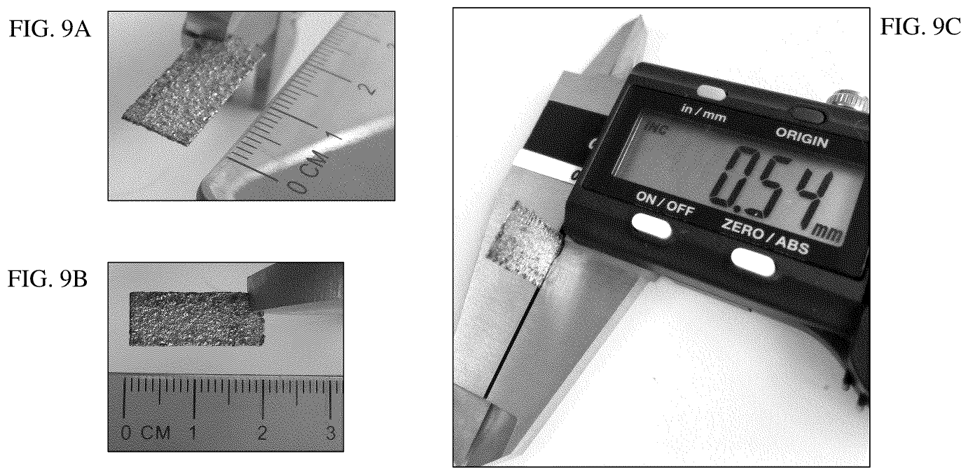

In a 25 cm by 25 cm by 30 cm container at ambient temperature and pressure, 1.56 kg Stainless Steel 316L powder of average particle size 35 μm is placed. The container is situated in an enclosure. The enclosure is purged with Argon gas for 5 min. The top surface of the powder is leveled. A 200 W fiber 1060 nm laser beam is directed to a point in on the surface of the powder for 265 milliseconds. The laser beam traveled across the powder in a predetermined path. A 3D plane is subsequently formed. The 3D plane had average dimensions 8 mm by 20 mm by 400 μm, as can be schematically illustrated in the example of FIG. 8, and demonstrated in the examples of FIGS. 9A and 9B. FIGS. 9A-9C show examples of 3D planes that are printed as suspended 3D planes devoid of auxiliary supports.

### Example 3

In a 25 cm by 25 cm by 30 cm container at ambient temperature and pressure, a 3D plane prepared according to Example 2 is placed. An example of such a 3D plane is depicted in FIG. 10, 1001. The container is situated in an enclosure. The enclosure is purged with Argon gas for 5 min. A 200 W fiber 1060 nm laser beam is directed to a point in on the surface of the plane for 75 milliseconds. The laser beam traveled across the plane in a predetermined path. The plane is subsequently cleaned from any oxides present by the reversion of the surface appearance from a dark oxidized surface to that of a shiny metallic surface, as demonstrated by the examples of fifteen 3D planes of FIG. 10 that are situated in the region 1002.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. An apparatus for printing a three-dimensional object, the apparatus comprising at least one controller configured to:
(a) operatively couple with at least one energy beam; and
(b) direct the printing of the three-dimensional object at least in part by being configured to direct the at least one energy beam to transform a powder material disposed in a powder bed to generate a transformed material as part of the three-dimensional object, the three-dimensional object comprising (a) successively stacked layers, a layer of the successively stacked layers having an average layering plane and (b) a first portion coupled on one of its sides to a second portion, the first portion having an aspect ratio of a width to a length of at least about 1:2 or an aspect ratio of the width to a longer length, with X and Y being points on a surface of the first portion, (i) the surface intersecting a sphere of radius XY at positions X and Y the surface intersecting the sphere being devoid of an auxiliary support feature and (ii) an acute angle between a straight line XY and the average layering plane is at most about 30 degrees.

2. (canceled)

3. (canceled)

4. (canceled)

5. (canceled)

6. (canceled)

7. (canceled)

8. (canceled)

9. (canceled)

10. (canceled)

11. (canceled)

12. The apparatus of claim 1, wherein the at least one controller is configured to direct the at least one energy beam to translate along a path to (a) irradiate a first section of the powder bed to generate a first section of the transformed material at a first position along the path, (b) translate along the path to a second position, and (c) irradiate a second section of the powder bed to generate a second portion of the transformed material at the second position, wherein the first transformed material contacts the second transformed material.

13. The apparatus of claim 12, wherein the at least one controller is configured to direct the printing such that the second transformed material at least partially overlaps the first transformed material.

14. The apparatus of claim 12, wherein the at least one controller is configured to direct the printing such that the first section of the transformed material and the second section of the transformed material are comprised in a three-dimensional plane of the three-dimensional object, the first portion comprising the three-dimensional plane.

15. The apparatus of claim 1, wherein the at least one controller is configured to direct the printing such that X and Y are spaced apart by at least about 1.5 millimeters.

16. The apparatus of claim 12, wherein the at least one controller is configured to direct the printing such that a radius of curvature of the layer is at least about 5 centimeters, or greater.

17. The apparatus of claim 1, wherein the at least one controller is configured to direct the printing such that the successively stacked layers contain at least about 60 percent (%) material relative to a total volume of the successively stacked layers.

18. The apparatus of claim 1, wherein the at least one controller is configured to direct the printing such that the three-dimensional object deviates from a requested three-dimensional object by at most a sum of twenty-five (25) micrometers and one thousandth ( 1/1000) of a fundamental length scale of the three-dimensional object.

19. The apparatus of claim 1, wherein the at least one controller is configured to direct the printing such that during the printing the three-dimensional object is anchorlessly suspended in the powder bed.

20. The apparatus of claim 1, wherein the at least one controller is configured to direct the printing to be performed under a pressurized environment in an enclosure as compared to an ambient atmosphere external to the enclosure.

21. The apparatus of claim 1, wherein the power bed comprises powder that is flowable during the printing.

22. (canceled)

23. (canceled)

24. The apparatus of claim 1, wherein the at least one controller is configured to direct the printing such that the first portion is coupled on one of its sides to the second portion, the first portion being otherwise suspended anchorlessly in the powder bed during the printing.

25. The apparatus of claim 1, wherein the at least one controller is configured to direct the printing such that the first portion forming a closed geometric structure comprising an internal cavity.

26. The apparatus of claim 1, wherein at least one controller is configured to direct the printing such that the first portion comprises a reef, a shelf or a ledge.

27. The apparatus of claim 1, wherein the at least one controller is configured to direct the printing such that the first portion includes a first wire and feature, the feature comprising a second wire or a second plane, the first portion being closely situated by at most about one (1) millimeter to the feature.

28. The apparatus of claim 1, wherein the at least one controller is configured to direct the printing such that the first portion includes a first plane and feature, the feature comprising a second wire or a second plane, the first portion being closely situated by at most about one (1) millimeter to the feature.

29. The apparatus of claim 1, wherein the at least one controller is configured to direct the at least one energy beam to irradiate to generate a path of successively deposited droplets, the first portion of transformed material being a first droplet of the droplets, the second portion of transformed material being a second droplet of the droplets.

30. A three-dimensional object, the three-dimensional object comprising: one or more material signatures indicative of the printing directed by the apparatus of claim 1, the three-dimensional object comprising the feature.

31. Non-transitory computer readable program instructions, the program instructions, when read by one or more processors operatively coupled with the apparatus of claim 1, instruct the one or more processors to perform, or direct performance of, one or more operations associated with the apparatus for printing the three-dimensional object, the program instructions being inscribed on at least one non-transitory computer readable medium.

32. A method for three-dimensional printing, the method comprising: (a) providing the apparatus of claim 1; and (b) performing one or more operations associated with the apparatus for printing the three-dimensional object.
